(19) United States
(12) Patent Application Publication
(10) Pub. No.: US 2009/0075048 A1
(43) Pub. Date: Mar. 19, 2009

(54) Cellulose-mixed ester film and method for producing same

(76) Inventor: Yasuo Mukunoki, Kanagawa (JP)

Correspondence Address: BUCHANAN, INGERSOLL & ROONEY PC, POST OFFICE BOX 1404, ALEXANDRIA, VA, 22313-1404, US

(21) Appl. No.: 11/920,546

(22) PCT Filed: May 17, 2006
(86) PCT No.: PCT/JP2006/309848

§ 371 Date: Nov. 16, 2007

(30) Foreign Application Priority Data
May 17, 2005 (JP) 2005-143844
May 24, 2005 (JP) 2005-151632

(51) Int. Cl. B32B 27/36; B29D 11/00

(52) U.S. Cl. 428/220; 264/1.6

(57) ABSTRACT

A cellulose mixed ester film is produced by melting a mixture of a cellulose mixed ester having a substitution degree of a certain range, fine particles having a mean primary particle size of from 0.005 μm to 2 μm and a UV absorbent in a certain ratio, extruding the mixture and forming the film through melt casting film formation. When the produced cellulose mixed ester film is built in a liquid crystal display device, display fluctuation and moisture-dependent visibility change are suppressed.

### TECHNICAL FIELD

The present invention relates to a method for producing a cellulose mixed ester film in a mode of melt casting film formation. The invention also relates to a cellulose mixed ester film having excellent optical characteristics.

### BACKGROUND ART

Heretofore, in producing cellulose mixed ester films for use in liquid crystal image display devices, a solution casting film formation method has been principally carried out, which comprises dissolving a cellulose mixed ester in a chlorine-containing organic solvent such as dichloromethane, casting it on a substrate, and drying it to form a film. Of chlorine-containing organic solvents, dichloromethane is favorably used since it is a good solvent for cellulose acylate and since it has advantages in that its boiling point is low (about 40° C.) and it may be readily vaporized in the film-forming and drying step in its production process.

On the other hand, recently, from the viewpoint of environmental protection, it has become strongly required to retard release of organic solvents such as typically chlorine-containing organic solvents. Accordingly, various measures are now taken for almost completely preventing release of organic solvents in outdoor air. For example, employed is a method of preventing organic solvent leakage through a tighter closed system, and even if an organic solvent leaks out by any chance in a process of film formation, employed is a method of installing a gas absorption tower to adsorb and treat it before it is released in outdoor air. Further, before discharged, an organic solvent is burnt with flames or is decomposed with electron beams, whereby the organic solvent is not almost discharged out. However, it is still impossible to completely prevent the release of organic solvents, and further improvements are required.

A melt casting film formation method of producing a cellulose mixed ester has been developed as a film formation method not using an organic method (for example, see JP-T-6-501040, JP-A-2000-352620). In this method, the carbon chain of the ester group of the cellulose ester is prolonged so as to lower the melting point of the polymer, thereby facilitating melt casting film formation. Concretely, cellulose acetate that has been used conventionally is changed into cellulose propionate, or cellulose butyrate, etc., thereby enabling melt casting film formation. In addition, another advantage is that, when a retardation film is produced using a conventional cellulose ester film as a substrate, then the visual field characteristics hardly fluctuate with humidity change.

However, in case where the films produced through melt casting film formation according to such methods and when they are processed according to Examples, then it has been found that they could not satisfy all the requirements of preventing coloration of cellulose mixed ester films, improving the conveyability of the films, improving the scratch resistance of the films and preventing the deposition of UV absorbent on the film surface.

Specifically, the above-mentioned patent references describe addition of fine particles and UV absorbent to control the slidability of films and to impart weather resistance to films; however, the present inventors have clarified that it is difficult to satisfy these properties along with other properties of films. In particular, the films produced according to the examples in JP-A-2000-352620 may have problems of scratching, coloration, weather resistance deterioration with time, and bleeding out of UV absorbent on the surface to worsen the surface profile of films, and it is a pressing need to improve the films.

Concretely, when the cellulose mixed ester described in the above patent references is used to produce a polarizing plate and when it is built in a liquid crystal display device, then there occur some problems in that many scratches in the polarizing plate cause impurity unevenness, that the coloration and the haze increase causes the reduction in brightness, and that the UV absorbent deposits on the film surface with time under severe conditions; and the ester is on the level that it must be improved in those points. The trouble is especially noticeable when the polarizing plate is built in a large-size liquid crystal display panel of 15 inches or more, and this is a serious problem. It may be presumed that one cause of these problems is that, in a process of extruding a melt from a melt kneader onto a casting drum through a die (slit), then cooling and solidifying it to form a film, and winding it up and further processing it, the conveyability of the cellulose mixed ester film is poor and therefore the cellulose mixed ester film surfaces may scratch each other, and another is that, owing to the high temperature in melt casting film formation, UV absorbent may be localized to cause a trouble.

### DISCLOSURE OF THE INVENTION

### Problems to be Solved by the Invention

In consideration of these prior-art problems, the present invention is to provide a cellulose mixed ester which is useful as a protective film for polarizer or a retardation film, which has good handlability especially in its production process, which has excellent UV resistance and which is improved in that the fine particles used therein is prevented from powdering off. In addition, the invention is also to provide a cellulose mixed ester improved in its blocking resistance during storage with time. Further, the invention is also to provide a method for producing a cellulose mixed ester film which, when built in a liquid crystal display device, can solve a problem of impurity trouble on display panel and a problem of visibility change with time; and to provide a cellulose mixed ester film produced according to the production method.

### Means for Solving the Problems

The above-mentioned objects of the invention have been attained by the following constitutions.

### Embodiment 1

A method for producing a cellulose mixed ester film having a thickness of from 20 μm to 200 μm through melt casting film formation of a cellulose mixed ester, wherein:

the cellulose mixed ester satisfies the formulae (S-1) to (S-3) below, and contains fine particles having a mean primary particle size of from 0.005 μm to 2 μm in an amount of from 0.005 to 1.0% by mass relative to the cellulose mixed ester, and contains a UV absorbent in an amount of from 0.2 to 3% by mass relative to the cellulose mixed ester,

and the method comprises melting the cellulose mixed ester at 180 to 230° C., extruding it through a die and forming a cellulose mixed ester film through melt casting film formation (melt casting film formation step):

2.5≦A+B≦3.0, (S-1)

0≦A≦2.2, (S-2)

0.8≦B≦3.0, (S-3)

wherein A means a substitution degree of the hydroxyl group of cellulose with an acetyl group, and B means a substitution degree of the hydroxyl group of cellulose with an acyl group having from 3 to 22 carbon atoms.

### Embodiment 2

The method for producing a cellulose mixed ester film of Embodiment 1, wherein the acyl groups having from 3 to 22 carbon atoms that substitutes for the hydroxyl group of cellulose in the cellulose mixed ester are at least two acyl groups selected from the group consisting of an acetyl group, a propionyl group and a butyryl group.

### Embodiment 3

The method for producing a cellulose mixed ester film of Embodiment 1 or Embodiment 2, wherein the UV absorbent is at least one UV absorbent selected from benzotriazole compounds, benzophenone compounds, oxalic acid anilide compounds, formamidine compounds and compounds having triazine ring.

### Embodiment 4

The method for producing a cellulose mixed ester film of any one of Embodiment 1 to Embodiment 3, wherein the fine particles are selected from at least one type of SiO₂, ZnO, TiO₂, SnO₂, Al₂O₃, ZrO₂, In₂O₃, MgO, BaO, MoO₂ and V₂O₅.

### Embodiment 5

The method for producing a cellulose mixed ester film of any one of Embodiment 1 to Embodiment 4, which further comprises stretching the film formed through melt casting film formation in the melt casting film formation step by from −10% to 50% in at least one direction (stretching step).

### Embodiment 6

A cellulose mixed ester film formed through melt casting film formation of a cellulose mixed ester and having a thickness of from 20 μm to 200 μm, wherein:

the cellulose mixed ester satisfies the formulae (S-1) to (S-3) below, and contains fine particles having a mean primary particle size of from 0.005 μm to 2 μm in an amount of from 0.005 to 1.0% by mass relative to the cellulose mixed ester,

the cellulose mixed ester film is formed by melting the cellulose mixed ester at 180 to 230° C., extruding it through a die and forming the film through melt casting film formation, and its dynamic and static friction value is both from 0.2 to 1.5, and the mean secondary particle size of the fine particles in the film is from 0.01 μm to 5 μm,

and the cellulose mixed ester contains a UV absorbent in an amount of from 0.2 to 3% by mass relative to the cellulose mixed ester, or the arithmetical mean roughness (Ra) of the surface of the cellulose mixed ester film is from 3 nm to 200 nm:

2.5≦A+B≦3.0, (S-1)

0≦A≦2.2, (S-2)

0.8≦B≦3.0, (S-3)

wherein A means a substitution degree of the hydroxyl group of cellulose with an acetyl group, and B means a substitution degree of the hydroxyl group of cellulose with an acyl group having from 3 to 22 carbon atoms.

### Embodiment 7

The cellulose mixed ester film of Embodiment 6, which has an in-plane retardation (Re) of from 0 to 10 nm, and an absolute value of a thickness-direction retardation (Rth) of from 0 to 60 nm.

### Embodiment 8

The cellulose mixed ester film of Embodiment 6 or Embodiment 7, which has a haze of from 0.1 to 1.2% and a visible light transmittance of at least 91%, and has, at a wavelength of 590 nm in an environment at 25° C. and a relative humidity of 60%, an intrinsic birefringence in the in-plane direction of from 0 to 0.001 and an absolute value of an intrinsic birefringence in the thickness direction of from 0 to 0.003.

### Embodiment 9

The cellulose mixed ester film of any one of Embodiment 6 to Embodiment 8, wherein the in-plane retardation (Re) and the thickness-direction retardation (Rth) of the film at a wavelength of 400 nm and 700 nm satisfy the following formulae (A-1) and (A-2):

0≦|Re(700)−Re(400)|≦15 nm, (A-1)

0≦|Rth(700)−Rth(400)|≦35 nm, (A-2)

wherein Re(400) and Re(700) mean the in-plane retardation (Re) at a wavelength of 400 nm and 700 nm, respectively; Rth(400) and Rth(700) mean the thickness-direction retardation (Rth) at a wavelength of 400 nm and 700 nm, respectively.

### Embodiment 10

The method for producing a cellulose mixed ester film of Embodiments 1 to 5, wherein, in the melt casting film formation step, the melt of the melt-extruded cellulose mixed ester and the fine particles is solidified on a casting drum, and then the cellulose mixed ester film formed on the casting drum is peeled, cut under tension with a nip roll, and wound up under tension whereupon the tension in winding up the film is from 0.01 kg/cm² to 10 kg/cm².

### Embodiment 11

The method for producing a cellulose mixed ester film of Embodiments 1 to 5 or 10, wherein, when the melt is solidified on a casting drum in the melt casting film formation step, it is cooled at a temperature falling between (Tg+30° C.) and Tg, wherein Tg indicates the glass transition temperature of the cellulose mixed ester film, at a rate (cooling speed) of from 10° C./sec to 100° C./sec.

### Embodiment 12

The method for producing a cellulose mixed ester film described in 1 to 5, 10 or 11, wherein, in the melt casting film formation step, the melt of the cellulose mixed ester and the fine particles is melted at 180° C. to 230° C., using a screw having a compression ratio of from 2 to 15, and then extruded out through a T-die onto a casting drum.

### Embodiment 13

The method for producing a cellulose mixed ester film of Embodiment 12, wherein, in the melt casting film formation step, after the cellulose mixed ester is extruded out through the T-die, it is cooled at a temperature falling between Tg and (Tg−20° C.) at a rate of from 0.1° C./sec to 20° C./sec.

### Embodiment 14

A cellulose mixed ester film produced according to the method for producing cellulose mixed ester film of any of Embodiments 10 to 13.

### Embodiment 15

The cellulose mixed ester film of Embodiment 14, which has a thickness fluctuation of from 0 to 5 μm.

### Embodiment 16

The cellulose mixed ester film of any of Embodiments 6 to 9, 14 or 15, wherein the film surface has a contact angle with water (25° C./relative humidity 60%) of at most 45°.

### Embodiment 17

The cellulose mixed ester film of any of Embodiments 14 to 16, wherein the cellulose mixed ester satisfies the following formulae (S-4) to (S-6):

2.6≦A+B′≦3.0, (S-4)

0≦A≦1.8, (S-5)

1.0≦B′≦3.0, (S-6)

wherein A means a substitution degree of the hydroxyl group of cellulose with an acetyl group, and B′ means a total substitution degree of the hydroxyl group of cellulose with a propionyl group or a butyryl group.

### Embodiment 18

A polarizing plate produced by laminating at least one layer of the cellulose mixed ester film of any of Embodiments 6 to 9 or 14 to 17 on a polarizer.

### Embodiment 19

The polarizing plate of Embodiment 18, wherein the polarizer is tenter-stretched substantially at 450 in the machine direction.

### Embodiment 20

An optical compensatory film comprising the cellulose mixed ester film of any of Embodiments 6 to 9 or 14 to 17 as the substrate thereof.

### Embodiment 21

An anti-reflection film comprising the cellulose mixed ester film of any of Embodiments 6 to 9 or 14 to 17 as the substrate thereof.

### Embodiment 22

A liquid crystal display device comprising at least one of the polarizing plate of Embodiment 18 or 19, the optical compensatory film of Embodiment 20, and the anti-reflection film of Embodiment 21.

### ADVANTAGEOUS EFFECTS OF THE INVENTION

The invention provides a method for producing a cellulose mixed ester capable of improving the handlability in producing a cellulose mixed ester thereby to significantly reduce the surface defects (scratches) of the film, and capable of avoiding the visibility change owing to the impurity trouble or the moisture on the display panel that may occur when the film is built in a liquid crystal display device; and provides a cellulose mixed ester film produced according to the production method.

The cellulose mixed ester film of the invention may provide a film for optical use, which has good weather resistance with time and especially has excellent durability to the environment at high temperatures.

When the cellulose mixed ester film of the invention is built in a liquid crystal display device is constructed, then it may prevent display unevenness and optical characteristic change depending on humidity and color of image.

### BRIEF DESCRIPTION OF THE DRAWING

FIG. 1 is a cross-sectional view showing the structure of an extruder. In the drawing, 22 is an extruder, 32 is a cylinder, 40 is a supply port, A is a feed zone, B is a compression zone, C is a metering zone.

### BEST MODE FOR CARRYING OUT THE INVENTION

The method for producing a cellulose mixed ester film and the cellulose mixed ester film produced according to the production method of the invention are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### <<Method for Producing Cellulose Mixed Ester Film>>

The method for producing a cellulose mixed ester film of the invention (hereinafter this may be referred to as “the production method of the invention”) is for producing a cellulose mixed ester film through melt casting film formation of a cellulose mixed ester to give a cellulose mixed ester film having a thickness of from 20 to 200 μm, which is characterized in that:

the cellulose mixed ester satisfies the following formulae (S-1) to (S-3), and contains fine particles having a mean primary particle size of from 0.005 μm to 2 μm in an amount of from 0.005 to 1.0% by mass relative to the cellulose mixed ester,

and the method comprises a melt casting film formation step of melting the cellulose mixed ester at 180 to 230° C. and extruding it through a die for melt casting film formation to give a cellulose mixed ester film:

2.5≦A+B≦3.0, (S-1)

0≦A≦2.2, (S-2)

0.8≦B≦3.0, (S-3)

wherein A means a substitution degree of the hydroxyl group of cellulose with an acetyl group, and B means a substitution degree of the hydroxyl group of cellulose with an acyl group having from 3 to 22 carbon atoms.

### (Cellulose Mixed Ester)

The cellulose mixed ester to be used in the production step of the invention satisfies the following (S-1) to (S-3):

2.5≦A+B≦3.0, (S-1)

0≦A≦2.2, (S-2)

0.8≦B≦3.0, (S-3)

wherein A means a substitution degree of the hydroxyl group of cellulose with an acetyl group, and B means a substitution degree of the hydroxyl group of cellulose with an acyl group having from 3 to 22 carbon atoms.

The glucose units with beta (β)-1,4 bonding to each other to constitute cellulose have a free hydroxyl group at the 2-, 3- and 6-positions thereof. Cellulose mixed ester is a polymer derived from it through partial or complete esterification of those hydroxyl groups therein. The acyl substitution degree means the total ratio of esterification of the 2-, 3- and 6-positions of cellulose (100% esterification corresponds to a substitution degree of 1). In the invention, A+B is more preferably 2.6≦A+B≦3.0, even more preferably 2.67≦A+B≦2.97. Also preferably, 0≦A≦1.8; 1.0≦B≦2.97, more preferably 1.2≦B≦2.97. In the invention, the substitution degree of the 2-, 3- and 6-positioned hydroxyl groups of cellulose is not specifically defined; but preferably, the substitution degree at the 6-position in the cellulose mixed ester is at least 0.7, more preferably at least 0.8, even more preferably at least 0.85, still more preferably at least 0.90. Within the range, the solubility and the heat resistance of the cellulose mixed ester may be more improved.

The acyl group having from 3 to 22 carbon atoms, which is represented by the substituent B in the cellulose mixed ester in the invention, may be any aliphatic acyl group or aromatic acyl group. In case where the acyl group in the cellulose mixed ester in the invention is an aliphatic acyl group, it preferably has from 3 to 18 carbon atoms, more preferably from 3 to 12 carbon atoms, even more preferably from 3 to 8 carbon atoms. Examples of the aliphatic acyl group include an alkylcarbonyl group, an alkenylcarbonyl group, and an alkynylcarbonyl group. In case where the acyl group is an aromatic acyl group, it preferably has from 6 to 22 carbon atoms, more preferably from 6 to 18 carbon atoms, even more preferably from 6 to 12 carbon atoms. These acyl groups may have a substituent.

Preferred examples of the acyl group are a propionyl group, a butyryl group, a pentanoyl group, a hexanoyl group, a heptanoyl group, an octanoyl group, a decanoyl group, a dodecanoyl group, a tridecanoyl group, a tetradecanoyl group, a hexadecanoyl group, an octadecanoyl group, an isobutyryl group, a pivaloyl group, a cyclohexanecarbonyl group, an oleoyl group, a benzoyl group, a naphthalenecarbonyl group, a phthaloyl group, a cinnamoyl group. Of those, more preferred are a propionyl group, a butyryl group, a dodecanoyl group, an octadecanoyl group, a pivaloyl group, an oleoyl group, a benzoyl group, an naphthylcarbonyl, a cinnamoyl group; and even more preferred are a propionyl group, a butyryl group.

The acyl group that constitutes the ester moiety of the cellulose mixed ester in the invention is preferably an aliphatic acyl group having at most 6 carbon atoms, and more preferably an acyl group selected from the group consisting of an acetyl group, a propionyl group, a butyryl group, a pentanoyl group and a hexanoyl group. More preferred is an acyl group selected from the group consisting of an acetyl group, a propionyl group, butyryl group and a pentanoyl group; and even more preferred is an acyl group selected from the group consisting of an acetyl group, a propionyl group and a butyryl group. One or more different types of acyl groups may constitute the ester moiety of the cellulose mixed ester in the invention.

Preferably, the cellulose mixed ester for use in the invention satisfies the following formulae (S-4) to (S-6):

2.6≦A+B′≦3.0, (S-4)

0≦A≦1.8, (S-5)

1.0≦B′≦3.0, (S-6)

wherein A means a substitution degree of the hydroxyl group of cellulose with an acetyl group, and B′ means a total substitution degree of the hydroxyl group of cellulose with a propionyl group and a butyryl group.

More preferably, the cellulose mixed ester for use in the invention satisfies 2.6≦A+B′≦3.0, 0≦A≦1.4, and 1.0≦B′≦3. Even more preferably, the cellulose mixed ester for use in the invention satisfies 2.7≦A+B′≦3.0, 0≦A≦1.0, and 1.3≦B′≦3. When the content of the acetyl group is decreased and the content of the propionyl group and the butyryl group is increased in that manner, then the optical characteristic change to temperature and moisture of the polymer film may be suppressed.

### (Method for Producing Cellulose Mixed Ester)

The method for producing a cellulose mixed ester of the invention is described. Further details of the starting cotton and its production method for the cellulose mixed ester of the invention are described in Hatsumei Kyokai Disclosure Bulletin (No. 2001-1745, published by the Hatsumei Kyokai on Mar. 15, 2001), pp. 7-12. The cellulose material is preferably one derived from hardwood pulp, softwood pulp or cotton linter. Also preferably, the cellulose material has high purity, having an α-cellulose content of from 92% by mass to 99.9% by mass. In case where the cellulose material is a sheet-like or bulky one, preferably, it is previously pulverized; and regarding the cellulose morphology thereof, the material is preferably pulverized to be powdery or fluffy.

Prior to acylation thereof, the cellulose material is preferably processed (activated) through contact with an activator. The activator may be a carboxylic acid or water. When water is used, the process preferably includes adding an excessive amount of an acid anhydride after the activation for dewatering, or washing the system with a carboxylic acid for substitution for water, or controlling the acylation condition. The activator may be added after conditioned at any temperature; and a method for its production may be selected from spraying, dropwise addition or dipping. As the activator, preferred is a carboxylic acid having from 2 to 7 carbon atoms (e.g., acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid, benzoic acid); and more preferred are acetic acid, propionic acid, butyric acid. During the activation, sulfuric acid may be added in an amount of from 0.1% by mass to 10% by mass relative to cellulose.

The amount of the activator is preferably from 0.05 to 100 times by mass of cellulose, more preferably from 0.1 to 20 times by mass, even more preferably from 0.3 to 20 times by mass. Preferably, the activation time is from 20 minutes to 72 hours, more preferably from 30 minutes to 24 hours, even more preferably from 30 minutes to 12 hours. The activation temperature is preferably from 0° C. to 90° C., more preferably from 15° C. to 80° C., even more preferably from 20° C. to 60° C. The cellulose activation step may be attained under pressure or under reduced pressure. For the heating means, employable are electronic waves such as microwaves or IR rays.

In the method for producing a cellulose mixed ester of the invention, it is desirable that the hydroxyl group of cellulose is acylated by adding a carboxylic acid anhydride to cellulose and reacting the two in the presence of a Brönsted acid or a Lewis acid serving as a catalyst. The method for producing a cellulose mixed ester of the invention includes a method of using two types of carboxylic acid anhydrides as the acylating agent, added as their mixture or added successively; a method of suing a mixed acid anhydride of two different types of carboxylic acids (e.g., acetic acid/propionic acid mixed anhydride); a method of using a carboxylic acid and a different carboxylic acid anhydride (e.g., acetic acid and propionic anhydride), reacting them in a reaction system to give a mixed acid anhydride (e.g., acetic acid/propionic acid mixed anhydride), and reacting it with cellulose; and a method of once preparing a cellulose mixed ester of which the substitution degree is less than 3, and then further acylating the remaining hydroxyl group with an acid anhydride or an acid halide.

Of the carboxylic acid anhydride, the carboxylic acid is preferably one having from 2 to 7 carbon atoms; and for example, the anhydride includes acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentanecarboxylic anhydride, heptanoic anhydride, cyclohexanecarboxylic anhydride, benzoic anhydride.

More preferred are anhydrides such as acetic anhydride, propionic anhydride, butyric anhydride, valeric anhydride, hexanoic anhydride, heptanoic anhydride; even more preferred are acetic anhydride, propionic anhydride, butyric anhydride.

For preparing a cellulose mixed ester, a combination of these acid anhydrides is preferably used. The blend ratio is preferably determined in accordance with the substitution ratio of the intended cellulose mixed ester. In general, it is desirable that the acid anhydride is added to cellulose in an excessive equimolar amount, more preferably in an amount of from 1.2 to 50 equivalents relative to the hydroxyl group of cellulose, even more preferably from 1.5 to 30 equivalents, still more preferably from 2 to 10 equivalents.

The acylation catalyst to be used in production of the cellulose mixed ester in the invention is preferably a Brönsted acid or a Lewis acid. The definition of Brönsted acid and Lewis acid is described, for example, in Dictionary of Physicochemistry, 5th Ed. (2000). Preferred examples of the Brönsted acid are sulfuric acid, perchloric acid, phosphoric acid, methanesulfonic acid, benzenesulfonic acid, p-toluenesulfonic acid. Preferred examples of the Lewis acid are zinc chloride, tin chloride, antimony chloride, magnesium chloride. As the catalyst, more preferred is sulfuric acid or perchloric acid; and even more preferred is sulfuric acid. The amount of the catalyst is preferably from 0.1 to 30% by mass relative to cellulose, more preferably from 1 to 15% by mass, even more preferably from 3 to 12% by mass.

In acylation of cellulose, a solvent may be added for controlling the viscosity, the reaction speed, the stirring capability, and the acyl substitution ratio. The solvent includes dichloromethane, chloroform, carboxylic acid, acetone, ethyl methyl ketone, toluene, dimethylsulfoxide, sulforane, and is preferably a carboxylic acid, for example, a carboxylic acid having from 2 to 7 (e.g., acetic acid, propionic acid, butyric acid, 2-methylpropionic acid, valeric acid, 3-methylvaleric acid, 2-methylvaleric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid). Preferred are acetic acid, propionic acid, butyric acid. These solvents may be mixed for use herein.

In acylation of cellulose, an acid anhydride and a catalyst and optionally a solvent may be mixed, and then mixed with cellulose; or these may be separately and successively mixed with cellulose. In general, it is desirable that a mixture of an acid anhydride and a catalyst, or a mixture of an acid anhydride and a catalyst and a solvent is prepared as an acylating agent, and then reacted with cellulose. For increasing the temperature inside the reactor owing to the reaction heat during acylation, it is desirable that the acylating agent is previously cooled. The cooling temperature is preferably −50° C. to 20° C., more preferably −35° C. to 10° C., even more preferably −25° C. to 5° C. The acylating agent may be added as a liquid, or it may be frozen, and may be added as a solid such as crystals, flakes or blocks.

The acylating agent may be added to cellulose all at a time, or, after divided into portions, they may be added one by one. Cellulose may be added to the acylating agent all at a time, or, after divided into portions, they may be added one by one. In case where the acylating agent is divided into portions and they are added one by one, it may be one acylating agent having the same composition, or may be plural acylating agents of different compositions. Preferred embodiments are as follows: 1) A mixture of an acid anhydride and a solvent is first added, and then a catalyst is added; 2) a mixture of an acid anhydride and a solvent and a part of a catalyst is first added, and then a mixture of the remaining catalyst and a solvent is added; 3) a mixture of an acid anhydride and a solvent is first added, and then a mixture of a catalyst and a solvent is added; 4) a solvent is first added, and then a mixture of an acid anhydride and a catalyst, or a mixture of an acid anhydride, a catalyst and a solvent is added.

The cellulose acylation is an exothermic reaction. In the method for producing a cellulose mixed ester in the invention, it is desirable that the ultimate temperature in acylation is from −50° C. to 50° C. for easy control of the degree of polymerization, preferably from −30° C. to 45° C., more preferably from −20° C. to 40° C., still more preferably from −20° C. to 35° C. Preferably, the acylation time is from 0.5 hours to 24 hours, more preferably from 1 hour to 12 hours, even more preferably from 1.5 hours to 6 hours.

In the method for producing a cellulose mixed ester in the invention, a reaction stopper is preferably added after the acylation. The reaction stopper may be any one capable of decomposing an acid anhydride, and its preferred examples are water, alcohol (e.g., ethanol, methanol, propanol, isopropyl alcohol) or a composition containing any of these. When the reaction stopper is added, large heat that exceeds over the cooling capacity of the reactor may be generated thereby causing the reduction in the degree of polymerization of the cellulose mixed ester, or as the case may be, the cellulose mixed ester may deposit having an undesirable morphology. Therefore, in order to evade the disadvantages, it is desirable to add a mixture of a carboxylic acid, such as acetic acid, propionic acid or butyric acid, and water, but not to add water and alcohol directly. As the carboxylic acid, especially preferred is acetic acid. The blend ratio of water to carboxylic acid may be any one. For example, the water content may be from 5% by mass to 80% by mass, preferably from 10% by mass to 60% by mass, more preferably from 15% by mass to 50% by mass.

The reaction stopper may be added to the acylation reactor; or the reaction product may be added to the reaction stopper vessel. Preferably, the time to be taken by the reaction stopper being added is from 3 minutes to 3 hours. The addition time for the reaction stopper is more preferably from 4 minutes to 2 hours, even more preferably from 5 minutes to 1 hour, still more preferably from 10 minutes to 45 minutes. When the reaction stopper is added, the reactor may be cooled or may not be cooled, but for the purpose of inhibiting depolymerization, it is desirable that the reactor is cooled so as to prevent temperature elevation. Also preferably, the reaction stopper may be cooled.

After stopping the acylation, a neutralizing agent (e.g., calcium, magnesium, iron, aluminium or zinc carbonate, acetate, hydroxide or oxide) or its solution may be added for the purpose of hydrolyzing the excessive carboxylic acid anhydride still remaining in the system or for neutralizing a part or all of the esterification catalyst. Preferred examples of the solvent for the neutralizing agent are polar solvents such as water, alcohol (e.g., ethanol, methanol, propanol, isopropyl alcohol), carboxylic acid (e.g., acetic acid, propionic acid, butyric acid), ketone (e.g., acetone, ethyl methyl ketone), dimethylsulfoxide; and their mixed solvents.

Thus obtained, the cellulose mixed ester may have a total substitution degree of the cellulose hydroxyl group of nearly 3, but for the purpose of obtaining the ester having a desired substitution degree, generally employed is a method of partial hydrolysis of the ester bond by keeping the ester at 20 to 90° C. for a few minutes to a few days in the presence of a small amount of a catalyst (generally, an acylation catalyst such as the remaining sulfuric acid) and water, thereby converting (ripening) it into a cellulose mixed ester having a desired acyl substitution degree. Since the cellulose sulfate ester may be hydrolyzed during the process of partial hydrolysis, the amount of the sulfate ester bonding to cellulose may be reduced by controlling the hydrolysis condition.

At the time when the desired cellulose mixed ester is obtained, it is desirable that the catalyst still remaining in the system is completely neutralized with the above-mentioned neutralizing agent or its solution, to thereby stop the partial hydrolysis. It is also desirable to add a neutralizing agent capable of producing a salt poorly soluble in the reaction solution (e.g., magnesium carbonate, magnesium acetate), thereby effectively removing the catalyst (e.g., sulfuric acid ester) existing in the solution or bonding to cellulose.

For the purpose of removing or reducing the unreacted matter, the hardly-soluble salt and the other impurities in the cellulose mixed ester, the reaction mixture after the acylation is preferably filtered. The filtration may be effected in any stage after the completion of the esterification and before the reprecipitation. For controlling the filtration pressure and the handlability, it is desirable to dilute the system with a suitable solvent prior to the filtration. For the filtration, the filter material is not specifically defined, including, for example, cloth, glass filter, cellulosic filter paper, cellulosic cloth filter, metal filter, polymer filter (e.g., polypropylene filter, polyethylene filter, polyamide filter, fluorine-containing filter). The filer pore side is preferably from 0.1 to 500 μm, more preferably from 2 to 200 μm, even more preferably from 3 to 60 μm.

The obtained, cellulose mixed ester solution may be mixed with a poor solvent such as water or an aqueous solution of a carboxylic acid (e.g., acetic acid, propionic acid, butyric acid), or a poor solvent may be mixed in the cellulose mixed ester reaction solution, whereby the cellulose mixed ester may be reprecipitated, washed and stabilized to obtain the intended cellulose mixed ester. The reprecipitation may improve the purification efficiency and may control the molecular weight distribution and the apparent density of the product. The reprecipitation may be attained continuously or batchwise for every constant amount. It is also desirable that the concentration of the cellulose mixed ester solution and the composition of the poor solvent are controlled for the substitution mode and the degree of polymerization of the cellulose mixed ester, to thereby control the morphology and the molecular weight distribution of the reprecipitated cellulose mixed ester.

The formed cellulose mixed ester is preferably washed. The washing may be any one capable of removing impurities; and in general, water or hot water is used. The temperature of the washing water is preferably from 5° C. to 100° C., more preferably from 15° C. to 90° C., even more preferably from 30° C. to 80° C. The washing treatment may be a batchwise treatment of repeating filtration and washing liquid exchange, or may be effected by the use of a continuous washing apparatus. Also preferably, the waste generated in the step of reprecipitation and washing may be recycled as the poor solvent for reprecipitation, or through evaporation, the solvent such as carboxylic acid may be recovered from the waste for recycling it. The procedure of the washing may be traced by any means, for which, for example, preferred is a method of hydrogen ion concentration determination, ion chromatography, electroconductivity determination, ICP, elementary analysis, atomic absorption spectrometry. Through the treatment, it is possible to remove the Brönsted acid (e.g., sulfuric acid, perchloric acid, trifluoroacetic acid, p-toluenesulfonic acid, methanesulfonic acid), the neutralizing agent (e.g., calcium, magnesium, iron, aluminium or zinc carbonate, acetate, hydroxide or oxide), the reaction product of neutralizing agent and catalyst, the carboxylic acid (e.g., acetic acid, propionic acid, butyric acid) and the reaction product of neutralizing agent and carboxylic acid in the cellulose mixed ester may be removed, and the treatment is therefore effective for increasing the stability (especially, resistance to ester bond decomposition at high temperature and high humidity) of the cellulose mixed ester.

It is also desirable to treat the cellulose mixed ester that had been washed through the hot water treatment, with an aqueous solution of a weak alkali (e.g., sodium, potassium, calcium, magnesium or aluminium carbonate, hydrogencarbonate, hydroxide, oxide), for further improving the stability thereof and for reducing the carboxylic acid smell thereof. The amount of the remaining impurities may be controlled by controlling the amount of the washing liquid, the washing temperature and time, the stirring method, the washing chamber form, and the composition and the concentration of the stabilizer.

In the invention, for the purpose of controlling the water content of the cellulose mixed ester to a desired level, it is desirable to dry the cellulose mixed ester. The drying method is not specifically defined so far as the intended water content may be obtained. Preferably, the drying is effectively attained by heating, aeration, pressure reduction or stirring, either singly or as combined. The drying temperature is from 0 to 200° C., preferably from 40 to 180° C., more preferably from 50 to 160° C. In this step, it is desirable that the cellulose mixed ester is dried at a temperature lower than the glass transition point (Tg) thereof, more preferably at a temperature lower than Tg by at least 10° C. The cellulose mixed ester thus obtained after drying in the invention preferably has a water content of at most 2% by mass, more preferably at most 1% by mass, even more preferably at most 0.5% by mass.

In case where the cellulose mixed ester is used as the material in film formation, it is preferably granular or powdery. After dried, the cellulose mixed ester may be ground or sieved for unifying the particle size thereof and for improving the handlability thereof. In case where the cellulose mixed ester is granular, it is desirable that at least 90% by mass of the particles thereof for use herein have a particle size of from 0.5 mm to 5 mm. Also preferably, at least 50% by mass of the particles for use herein have a particle size of from 1 mm to 4 mm. It is desirable that the cellulose mixed ester particles have a morphology as spherical as possible.

The degree of polymerization of the cellulose mixed ester preferably used in the invention is from 100 to 700 as the mean degree of polymerization thereof, more preferably from 120 to 550, even more preferably from 120 to 400, still more preferably from 130 to 350. The mean degree of polymerization may be measured according to a method of determination of molecular weight distribution through gel permeation chromatography (GPC), such as Uda et al's limiting viscosity method (Kazuo Uda, Hideo Saito, the Journal of the Fiber Society of Japan, Vol. 18, No. 1, pp. 105-120, 1962). Further, it is described in detail in JP-A-9-95538.

One or more different types of such cellulose mixed esters may be used either singly or as combined. The control of the degree of polymerization may be attained by removing a low-molecular-weight component. When a low-molecular component is removed, then the mean molecular weight (degree of polymerization) of the cellulose mixed ester may increase, but the viscosity may be lower than that of ordinary cellulose mixed ester, and therefore this is useful. The removal of a low-molecular component may be attained by washing the cellulose mixed ester with a suitable organic solvent. The cellulose mixed ester in the invention may contain any other polymer component except the cellulose mixed ester, as mixed therein. The polymer component to be mixed is preferably one having good compatibility with the cellulose mixed ester, and preferably has a transmittance, when formed into a film, of at least 80%, more preferably at least 90%, even more preferably at least 92%.

Preferably, the cellulose mixed ester for use in the invention has a ratio of mass-average molecular weight Mw/number-average molecular weight Mn of from 1.5 to 5.5, more preferably from 1.5 to 5.0, even more preferably from 2.0 to 4.5, still more preferably from 2.0 to 4.0. Preferably, the cellulose mixed ester is pelletized, and the preferred size of the pellets is from 1 mm³ to 10 cm³, more preferably from 5 mm³ to 5 cm³, even more preferably from 10 mm³ to 3 cm³. After this, the pellets are dried under the above-mentioned condition. Thus obtained, the cellulose mixed ester is preferably stored in a dark place at a low temperature so as to be hardly influenced by the storage environment. Also preferably, a moisture-proof bag formed of a shielding material such as aluminium, or a SUS drum or a container for storage is used for storing the ester.

Regarding the production of the cellulose mixed ester having a large degree of 6-substitution, referred to is the description in JP-A-11-5851, JP-A-2002-212338, JP-A-2002-338601. As other production methods for the cellulose mixed ester, also employable herein are a method of reacting with a carboxylic acid anhydride or a carboxylic acid halide in the presence of a base (e.g., sodium hydroxide, potassium hydroxide, barium hydroxide, sodium carbonate, pyridine, triethylamine, tert-butoxypotassium, sodium methoxide, sodium ethoxide); and a method of using, as the acylating agent, a mixed acid anhydride (e.g., carboxylic acid/trifluoroacetic acid mixed acid anhydride, carboxylic acid/methanesulfonic acid mixed acid anhydride). In particular, the latter method is effective for introducing an acyl group having many carbon atoms or an acyl group that could hardly be introduced according to a liquid-phase acylation method with a carboxylic acid/acetic anhydride/sulfuric acid catalyst.

### (Additives)

In addition to fine particles, various additives may be added, if desired, to the cellulose mixed ester in the invention in any stage before or after the preparation of the melt liquid. The other additives than fine particles in the invention includes UV absorbent; inorganic fine particles such as silica, kaolin, talc, diatomaceous earth, quartz, calcium carbonate, barium sulfate, titanium oxide, alumina; thermal stabilizer such as salt of Group 2 metal such as calcium, magnesium; antistatic agent, flame retardant, lubricant, oil.

### (UV Absorbent)

In the invention, a UV absorbent is preferably used, and a UV absorbent layer may be formed, if desired. The UV absorbent to form the UV absorbent layer may be a low-molecular UV absorbent or a polymer UV absorbent. Especially preferably, one or more UV absorbents are added to the ester. As the UV absorbent for liquid crystal, preferred is one having excellent UV absorbability at a wavelength of 380 nm or shorter from the viewpoint of preventing deterioration of liquid crystal, and having little visible light absorption at a wavelength of 400 nm or longer from the viewpoint of liquid crystal display capability. For example, it includes oxybenzophenone compounds, benzotriazole compounds, salicylate compounds, benzophenone compounds, cyanoacrylate compounds, nickel complex compounds. Especially preferred UV absorbents are benzotriazole compounds and benzophenone compounds. Above all, benzotriazole compounds are preferred as they give little unnecessary coloration to cellulose ester, cellulose mixed ester.

The UV absorbent for use in the UV absorbent layer is described below.

Benzotriazole UV absorbents include 2-(2′-hydroxy-5′-methylphenyl)benzotriazole, 2-[2′-hydroxy-3′,5′-bis(α,α-dimethylbenzyl)phenyl]benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amylphenyl)benzotriazole, 2-(2′-hydroxy-5′-t-octylphenyl)benzotriazole, 2,2′-methylene-bis[4-(1,1,3,3-tetramethylbutyl)-6-(2H-benzotriazol-2-yl)phenol], condensate of methyl 3-[3-t-butyl-5-(2H-benzotriazol-2-yl)-4-hydroxyphenyl]propionate and polyethylene glycol, 2-(2-hydroxyphenyl)benzotriazole-copolymer, 2-(2′-hydroxy-4′-octyloxyphenyl)-2H-benzotriazole, 2-(2H-benzotriazol-2-yl)-4-methyl-6-(3,4,5,6-tetrahydrophtyalimidylmethyl)phenol, 2,2′-methylenebis(4-t-butyl-6-2H-benzotriazolylphenol), 2,2′-methylenebis(4-t-octyl-6-2H-benzotriazolylphenol).

Benzophenone UV absorbents include 2,4-dihydroxybenzophenone, 2-hydroxy-4-methoxybenzophenone, 2-hydroxy-4-methoxybenzophenone-5-sulfonic acid, 2-hydroxy-4-n-octoxybenzophenone, 2-hydroxy-4-n-dodecyloxybenzophenone, 2-hydroxy-4-benzyloxybenzophenone, bis(5-benzoyl-4-hydroxy-2-methoxyphenyl)methane, 2,2′-dihydroxy-4-methoxybenzophenone, 2,2′-dihydroxy-4,4′-dimethoxybenzophenone, 2,2′,4,4′-tetrahydroxybenzophenone and 2-hydroxy-4-methoxy-2′-carboxybenzophenone.

Oxalic acid anilide UV absorbents include N,N′-diethyloxalic acid bis-anilide, 2-ethoxy-2′-ethyloxalic acid bis-anilide, 2-ethoxy-5-t-butyl-2′-ethyloxalic acid bis-anilide, and 2-ethoxy-5-t-butyl-2′-ethyl-4′-t-butyloxalic acid bis-anilide.

Formamidine UV absorbents include N-(4-ethoxycarbonylphenyl)-N′-methyl-N1-phenylformamidine, N-(4-ethoxycarbonylphenyl)-N′-ethyl-N′-phenylformamidine, N-(4-ethoxycarbonylphenyl)-N′-ethoxy-N′-phenylformamidine and N-(4-ethoxycarbonylphenyl)-N′,N′-diphenylformamidine.

Triazine UV absorbents include 2-[4,6-di(2,4-xylyl)-1,3,5-triazin-2-yl]-5-octyloxyphenol, 2-(4,6-diphenyl-1,3,5-triazin-2-yl)-5-[(hexyl)oxy]-phenol. Hydroxybenzoate light stabilizers include 2,4-di-t-butylphenyl-3′,5′-di-t-butyl-4′-hydroxybenzoate, 2,6-di-t-butylphenyl-3′,5′-di-t-butyl-4′-hydroxybenzoate, n-hexadecyl-3,5-di-t-butyl-4-hydroxybenzoate, and n-octadecyl-3,5-di-t-butyl-4-hydroxybenzoate.

Commercially-available UV absorbents such as those mentioned below are usable herein.

They include benzotriazole UV absorbents such as TINUVIN P (by Ciba Speciality Chemicals), TINUVIN 234 (by Ciba Speciality Chemicals), TINUVIN 320 (by Ciba Speciality Chemicals), TINUVIN 326 (by Ciba Speciality Chemicals), TINUVIN 327 (by Ciba Speciality Chemicals), TINUVIN 328 (by Ciba Speciality Chemicals), Sumisorb 340 (by Sumitomo Chemical); benzophenone UV absorbents such as Seesorb 100 (by Shipro Chemical), Seesorb 101 (by Shipro Chemical), Seesorb 101S (by Shipro Chemical), Seesorb 102 (by Shipro Chemical), Seesorb 103 (by Shipro Chemical), Adekastab LA-51 (by Asahi Denka Kogyo), Chemisorp 111 (by Chemipro Chemical), UVINUL D-49 (by BASF); oxalic acid anilide UV absorbents such as TINUVIN 312 (by Ciba Speciality Chemicals), and TINUVIN 315 (by Ciba Speciality Chemicals). Also usable are commercially-available salicylate UV absorbents such as Seesorb 201 (by Shipro Chemical) and Seesorb 202 (by Shipro Chemical); and cyanoacrylate UV absorbents such as Seesorb 501 (by Shipro Chemical) and UVINUL N-539 (by BASF). As polymer UV absorbents, those described in JP-A-2004-148542, [0035] to [0064] are usable.

As the case may be, a light stabilizer is preferably used in the UV absorbent layer. The light stabilizer includes hindered amine-type light stabilizers and hydroxybenzoate-type light stabilizers. Also preferred is use of a nickel-containing quencher-type stabilizer.

The hindered amine light stabilizer includes 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-t-butyl-2-butenyl)-4-hydroxy-2,2,6,6-tetramethylpiperidine, 4-stearoyloxy-2,2,6,6-tetramethylpiperidine, 4-methacryloyloxy-1,2,2,6,6-pentamethylpiperidine, 1-benzyl-2,2,6,6-tetramethyl-4-piperidyl maleate, bis(2,2,6,6-tetramethyl-4-piperidyl)succinate, bis(1,2,2,6,6)-pentamethyl-4-piperidyl)succinate, bis(2,2,6,6-tetramethyl-4-piperidyl)adipate, bis(2,2,6,6-tetramethyl-4-piperidyl)sebacate, bis(2,2,6,6-tetramethyl-4-piperidyl)fumarate, bis(1,2,3,6-tetramethyl-2,6-diethyl-4-piperidyl)sebacate, bis(1-allyl-2,2,6,6-tetramethyl-4-piperidyl)phthalate, bis(1,2,2,6,6-pentamethyl-4-piperidyl)sebacate, 1,1′-(1,2-ethanediyl)bis(3,3,5,5-tetramethylpiperpazinone), 2-methyl-2-(2,2,6,6-tetramethyl-4-piperidyl)imino-N-(2,2,6,6-tetramethyl-4-piperidyl)propionamide, 2-methyl-2-(1,2,2,6,6-pentamethyl-4-piperidyl)imino-N-(1,2,2,6,6-pentamethyl-4-piperidyl)propionamide, 1-propargyl-4-β-cyanoethyloxy-2,2,6,6-tetramethylpiperidine, 1-acetyl-2,2,6,6-tetramethyl-4-piperidyl acetate, tris(2,2,6,6-tetramethyl-4-piperidyl)trimellitate, 1-acryloyl-4-benzyloxy-2,2,6,6-tetramethylpiperidine, bis(1,2,2,6,6-pentamethyl-4-piperidyl)dibutyl malonate, bis(1,2,2,6,6-pentamethyl-4-piperidyl)dibenzyl malonate, bis(1,2,3,6-tetramethyl-2,6-diethyl-4-piperidyl)dibenzyl malonate, bis(1,2,2,6,6-pentamethyl-4-piperidyl)-2-(3,5-di-t-butyl-4-hydroxybenzyl)-2-n-butyl malonate, bis(2,2,6,6-tetramethyl-4-piperidyl) 1,5-dioxaspiro[5.5]undecane-3,3-dicarboxylate, bis(1,2,2,6,6-pentamethyl-4-piperidyl) 1,5-dioxaspiro[5.5]undecane-3,3-dicarboxylate, bis(1-acetyl-2,2,6,6-tetramethyl-4-piperidyl) 1,5-dioxaspiro[5.5]undecane-3,3-dicarboxylate, 1,3-bis[2,2′-[bis(2,2,6,6-tetramethyl-4-piperidyl) 1,3-dioxacyclohexane-5,5-dicarboxylate]], bis(2,2,6,6-tetramethyl-4-piperidyl)2-[1-methylethyl]-1,3-dioxacyclohexane-5,5-dicarboxylate]], 1,2-bis[2,2′-[bis(2,2,6,6-tetramethyl-4-piperidyl) 2-methyl-1,3-dioxacyclohexane-5,5-dicarboxylate]], bis(2,2,6,6-tetramethyl-4-piperidyl)-2-[2-(3,5-di-t-butyl-4-hydroxyphenyl)]ethyl 2-methyl-1,3-dioxacyclohexane-5,5-dicarboxylate, bis(2,6,6-tetramethyl-4-piperidyl) 1,5-dioxaspiro[5.11]heptadecane-3,3-dicarboxylate, hexane-1′,6′-bis-4-carbamoyloxy-1-n-butyl-2,2,6,6-tetramethylpiperidine), toluene-2′,4′-bis(4-carbamoyloxy-1-n-butyl-2,2,6,6-tetramethylpiperidine), dimethyl-bis(2,2,6,6-tetramethylpiperidin-4-oxy)-silane, phenyl-tris(2,2,6,6-tetramethylpiperidin-4-oxy)-silane, tris(1-propyl-2,2,6,6-tetramethyl-4-piperidyl)phosphite, tris(1-propyl-2,2,6,6-tetramethyl-4-piperidyl)phosphate, phenyl-[bis(1,2,2,6,6-pentamethyl-4-piperidyl)]phosphonate, tetrakis(2,2,6,6-tetramethyl-4-piperidyl) 1,2,3,4-butane-tetracarboxylate, tetrakis(1,2,2,6,6-pentamethyl-4-piperidyl) 1,2,3,4-butanetetracarboxylate, tetrakis(2,2,6,6-tetramethyl-4-piperidyl)-1,2,3,4-butanetetracarbonamide, tetrakis(1,2,2,6,6-pentamethyl-4-piperidyl)-1,2,3,4-butanetetracarbonamide, 2-dibutylamino-4,6-bis(9-aza-3-ethyl-8,8,10,10-tetramethyl-1,5-dioxaspiro[5.5]-3-undecylmethoxy)-s-triazine, 2-dibutylamino-4,6-bis(9-aza-3-ethyl-8,8,9,10,10-pentamethyl-1,5-dioxaspiro[5.5]-3-undecylmethoxy)-s-triazine, tetrakis(9-aza-3-ethyl-8,8,10,10-tetramethyl-1,5-dioxaspiro[5.5]-3-undecylmethyl)-1,2,3,4-butanetetracarboxylate, tetrakis(9-aza-3-ethyl-8,8,9,10,10-pentamethyl-1,5-dioxaspiro[5.5]-3-undecylmethyl)-1,2,3,4-butanetetracarboxylate, tridecyl-tris(2,2,6,6-tetramethyl-4-piperidyl) 1,2,3,4-butanetetracarboxylate, tridecyl-tris[1,2,2,6,6-pentamethyl-4-piperidyl)1,2,3,4-butanetetracarboxylate, di(tridecyl)-bis(2,2,6,6-tetramethyl-4-piperidyl) 1,2,3,4-butanetetracarboxylate, di(tridecyl)-bis(1,2,2,6,6-pentamethyl-4-piperidyl)1,2,3,4-butanetetracarboxylate, 2,2,4,4-tetramethyl-7-oxa-3,20-diazadispiro[5,1,11,2]heneicosan-21-one, 3,9-bis[1,1,-dimethyl-2-{tris(2,2,6,6-tetramethyl-4-piperidyloxycarbonyl)butylcarbonyloxy}ethyl]-2,4,8,10-tetroxaspiro[5.5]undecane, 3,9-bis[1,1-dimethyl-2-{tris(1,2,6,6-pentamethyl-4-piperidyloxycarbonyl)butylcarbonyloxy}ethyl]-2,4,8,10-tetroxaspiro[5.5]undecane, poly(2,2,6,6-tetramethyl-4-piperidyl acrylate), poly(1,2,2,6,6-pentamethyl-4-piperidyl acrylate), poly(2,2,6,6-tetramethyl-4-piperidyl methacrylate), poly(1,2,2,6,6-pentamethyl-4-piperidyl methacrylate), poly[[bis(2,2,6,6-tetramethyl-4-piperidyl)itaconate][vinylbutyl ether]], poly[[bis(1,2,2,6,6-pentamethyl-4-piperidyl)itaconate][vinylbutyl ether]], poly[[bis(2,2,6,6-tetramethyl-4-piperidyl)itaconate][vinyloctyl ether]], poly[[bis(1,2,2,6,6-pentamethyl-4-piperidyl)itaconate][vinyloctyl ether]], dimethyl succinate/2-(4-hydroxy-2,2,6,6-tetramethylpiperidyl)ethanol condensate, poly[hexamethylene[(2,2,6,6-tetramethyl-4-piperidyl)imino]], poly[ethylene[(2,2,6,6-tetramethyl-4-piperidyl)imino]hexamethylene[(2,2,6,6-tetramethylene-4-piperidyl)imino]], poly[[1,3,5-triazine-2,4-diyl][(2,2,6,6-tetramethyl-4-piperidyl)imino]hexamethylene[(2,2,6,6-tetramethyl-4-piperidyl)imino]], poly[[6-(diethylimino)-1,3,5-triazine-2,4-diyl][(2,2,6,6-tetramethyl-4-piperidyl)imino]hexamethylene[(2,2,6,6-tetramethyl-4-piperidyl)imino]], poly[[6-[(2-ethylhexyl)imino]-1,3,5-triazine-2,4-diyl][(2,2,6,6-tetramethyl-4-piperidyl)imino]hexamethylene[(2,2,6,6-tetramethyl-4-piperidyl)imino]], poly[[6-(1,1,3,3-tetramethylbutyl)imino]-1,3,5-triazine-2,4-diyl][(2,2,6,6-tetramethyl-4-piperidyl)imino]hexamethylene[(2,2,6,6-tetramethyl-4-piperidyl)imino]], poly[[6-(cyclohexylimino)-1,3,5-triazine-2,4-diyl][(2,2,6,6-tetramethyl-4-piperidyl)imino]hexamethylene[(2,2,6,6-tetramethyl-4-piperidyl)imino]], poly[[6-morpholino-1,3,5-triazine-2,4-diyl][(2,2,6,6-tetramethyl-4-piperidyl)imino]hexamethylene[(2,2,6,6-tetramethyl-4-piperidyl)imino]], poly[[[6-(butoxyimino)-1,3,5-triazine-2,4-diyl][(2,2,6,6-tetramethyl-4-piperidyl)imino]hexamethylene[(2,2,6,6-tetramethyl-4-piperidyl)imino]], poly[[6-[(1,1,3,3-tetramethylbutyl)oxy]-1,3,5-triazine-2,4-diyl][(2,2,6,6-tetramethyl-4-piperidyl)imino]hexamethylene[(2,2,6,6-tetramethyl-4-piperidyl)imino]], poly[oxy[6-[(1-piperidyl)-1,3,5-triazine-2,4-diyloxy-1,2-ethanediyl][(2,2,6,6-tetramethyl-3-oxo-1,4-piperidyl)-1,2-ethanediyl]][(3,3,5,5-tetramethyl-2-oxo-1,4-piperidyl)-1,2-ethanediyl]], poly[oxy[6-[(1,1,3,3-tetramethylbutyl)imino]-1,3,5-triazine-2,4-diyloxy-1,2-ethanediyl][(2,2,6,6-tetramethyl-3-oxo-1,4-piperidyl)-1,2-ethanediyl][(3,3,5,5-tetramethyl-2-oxo-1,4-piperidyl)-1,2-ethanediyl]], poly[[6-[(ethylacetyl)imino]-1,3,5-triazine-2,4-diyl][(2,2,6,6-tetramethyl-4-piperidyl)imino]hexamethylene[(2,2,6,6-tetramethyl-4-piperidyl)imino]], poly[[6-[(2,2,6,6-tetramethyl-4-piperidyl)butylimino]-1,3,5-triazine-2,4-diyl][(2,2,6,6-tetramethyl-4-piperidyl)imino]hexamethylene[(2,2,6,6-tetramethyl-4-piperidyl)imino]], 1,6,11-tris[{4,6-bis(N-butyl-N-(2,2,6,6-tetramethyl-4-piperidyl)amino)-1,3,5-triazin-2-yl}amino]undecane, 1,6,11-tris[{4,6-bis(N-butyl-N-(1,2,2,6,6-pentamethyl-4-piperidyl)amino)-1,3,5-triazin-2-yl}amino]undecane, 1,6,11-tris[{4,6-bis(N-octyl-N-(2,2,6,6-tetramethyl-4-piperidyl)amino)-1,3,5-triazin-2-yl}amino]undecane, 1,6,11-tris[{4,6-bis(N-octyl-N-(1,2,2,6,6-pentamethyl-4-piperidyl)amino)-1,3,5-triazin-2-yl}amino]undecane, polymethyl-propyl-3-oxo[1-(2,2,6,6-tetramethyl)piperidyl]siloxane, 1,1′,1″-[1,3,5-triazine-2,4,6-trityl-tris[(cyclohexylimino)-2,1-ethanediyl]]-tris[3,3,5,5-tetramethylpiperazin-2-one], 1,1,1-tris[polyoxypropylene[{4,6-bis(N-butyl-N-(2,2,6,6-tetramethyl-4-piperidyl)amino)-1,3,5-triazin-2-yl}aminoether-methyl]propane, 1,1,1-tris[polyoxyethylene-{4,6-bis(N-butyl-N-(2,2,6,6-tetramethyl-4-piperidyl)amino)-1,3,5-triazin-2-yl}aminoether-methyl]propane, 1,1,1-tris[polyoxyethylene-{4,6-bis(N-butyl-N-(1,2,2,6,6-pentamethyl-4-piperidyl)amino)-1,3,5-triazin-2-yl}aminoether-methyl]propane, 1,1,1-tris[polyoxypropylene-{4,6-bis(N-butyl-N-(2,2,6,6-tetramethyl-4-piperidyl)amino)-1,3,5-triazin-2-yl}aminoether-methyl]propane, 1,1,1-tris[polyoxypropylene-{4,6-bis(N-butyl-N-(1,2,2,6,6-pentamethyl-4-piperidyl)amino)-1,3,5-triazin-2-yl}aminoether-methyl]propane, 1,5,8,12-tetrakis[4,6-bis(N-(2,2,6,6-tetramethyl-4-piperidyl)-butylamino)-1,3,5-triazin-2-yl]-1,5,8,12-tetrazadodecane, 1,5,8,12-tetrakis[4,6-bis(N-(1,2,2,6,6-pentamethyl-4-piperidyl)butylamino)-1,3,5-triazin-2-yl]-1,5,8,12-tetrazadodecane.

The nickel-containing quencher includes nickel bis[2,2′-thiobis(4-t-octylphenolato], nickel bis[O-t-butyl-(3,5-di-t-butyl-4-hydroxybenzyl)phosphonate], nickel bis[O-ethyl-(3,5-di-t-butyl-4-hydroxybenzyl)phosphonate]2,2′-thiobis(4-t-octylphenolato)-butylamino-nickel(II), 2,2′-thiobis(4-t-octylphenolato)-cyclohexylamino-nickel(II), 2,2′-thiobis(4-b-octylphenolato)-diethanolamino-nickel(II), 2,2′-thiobis(4-t-octylphenolato)-diethanolamino-nickel(II), 2,2′-thiobis(4-t-octylphenolato)-phenyl-diethanolamino-nickel(II), 2,2′-thiobis(4-t-octylphenolato)-i-octylamino-nickel(II), 2,2′-thiobis(4-t-octylphenolato)-octylamino-nickel(II), 2,2′-thiobis(4-t-octylphenolato)-cyclohexyl-diethanolamino-nickel(II) and nickel dibutyldithiocarbamate.

Combined use of a UV absorbent and a light stabilizer may give more excellent weather resistance. In the invention, it is also desirable to color the film in some cases, for the purpose of controlling its color; and the colorant for the case includes, for example, inorganic pigments such as titanium oxide, zinc oxide, red iron oxide, titanium oxide-calcined pigment, ultramarine, cobalt aluminate, carbon black; organic pigments such as azo compounds, quinacridone compounds, anthraquinone compounds, perylene compounds, isoindolinone compounds, phthalocyanine compounds, quinophthalone compounds, threne compounds, diketopyrrolopyrrole compounds; body pigments such as barium sulfate, calcium carbonate; and dyes such as basic dyes, acid dyes, mordant dyes.

### (Fine Particles)

The cellulose mixed ester in the invention contains fine particles having a mean primary particle size of from 0.005 μm to 2 μm in an amount of from 0.005 to 1.0% by mass relative to the cellulose mixed ester. The fine particles may be those of inorganic compound or those of organic compound.

The inorganic compound includes SiO₂, ZnO, TiO₂, SnO₂, Al₂O₃, ZrO₂, In₂O₃, MgO, BaO, MoO₂, V₂O₅, talc, clay, calcined kaolin, calcined calcium silicate, calcium silicate hydrate, aluminium silicate, magnesium silicate, calcium phosphate. Preferred is at least one of SiO₂, ZnO, TiO₂, SnO₂, Al₂O₃, ZrO₂, In₂O₃, MgO, BaO, MoO₂ and V₂O₅; and more preferred are SiO₂, TiO₂, SnO₂, Al₂O₃, ZrO₂.

As the fine particles of SiO₂, for example, usable are commercial products such as Aerosil R972, R972V, R974, R812, 200, 200V, 300, R202, 0X50, TT600 (all by Nippon Aerosil). As the fine particles of ZrO₂, for example, usable are commercial products such as Aerosil R976 and R811 (both by Nippon Aerosil).

As the fine particles of an organic compound for use in the invention, for example, preferred are polymers such as silicone resin, fluororesin, acrylic resin; and more preferred is silicone resin. The silicone resin preferably has a three-dimensional network structure; and, for example, herein usable are commercial products such as Tospearl 103, 105, 108, 120, 145, 3120 and 240 (all trade names by Toshiba Silicone).

Regarding the size of the fine particles to be in cellulose mixed ester in the invention, the mean primary particle size thereof is preferably from 0.005 μm to 2 μm from the viewpoint of suppressing the haze of the film, more preferably from 0.005 μm to 0.5 μm, even more preferably from 0.005 μm to 0.1 μm. The mean primary particle size of the fine particles as referred to herein is determined as follows: Fine particles in a cellulose mixed ester film are observed with a transmission electronic microscope (having a magnification power of 500,000 to 1,000,000). 100 particles are measured, and their data are averaged, and the average indicates the mean primary particle size of the particles.

The fine particles may be added to the cellulose mixed ester according to an ordinary kneading method. Preferably, fine particles are previously dispersed in a solvent and then mixed and dispersed with a cellulose mixed ester, then the solvent was evaporated away to give a solid, and this is used in the process of producing a cellulose mixed ester melt. The method is favorable as readily giving a uniform melt. For uniformly dispersing the fine particles in the film, it is desirable that the method includes finely dispersing the fine particles from powder to fine particles owing to the shear in the kneader or in the die during film formation. If desired, any other functional material (e.g., plasticizer and/or UV absorbent) may be simultaneously dissolved or dispersed and mixed in the solvent along with the fine particles therein.

Preferably, the mean secondary particle size of the fine particles in the cellulose mixed ester film finally obtained according to the production method of the invention is from 0.01 to 5 μm; more preferably, the mean secondary particle size is from 0.02 to 3 μm; even more preferably, the mean secondary particle size is from 0.02 to 1 μm. The mean secondary particle size of the fine particles as referred to herein is determined as follows: The fine particles in a cellulose mixed ester film are observed with a transmission electronic microscope (having a magnification power of 100,000 to 1,000,000). 100 particles therein are measured, and their data are averaged, and the average indicates the mean secondary particle size of the particles.

Preferably, the fine particles of inorganic compound are surface-treated for make them stably exist in the cellulose mixed ester film. The inorganic fine particles are preferably surface-treated before use herein. The surface treatment method includes chemical surface treatment with a coupling agent, and physical surface treatment such as plasma discharge treatment or corona discharge treatment. In the invention, preferred is the method of using a coupling agent. The coupling agent is preferably an organoalkoxy-metal compound (e.g., silane coupling agent, titanium coupling agent). In case where inorganic fine particles are used (especially when SiO₂ is used), the treatment with a silane coupling agent is especially effective. For the silane coupling agent, an organosilane compound of the following general formula (II) may be used. Not specifically defined, the amount of the coupling agent to be used may be recommendably from 0.005 to 5% by mass relative to the inorganic fine particles, more preferably from 0.01 to 3% by mass.

RₓSi(OR′)₍₄₋ₓ₎ (11)

(In the formula, R and R′ each independently represent a hydrogen atom, an alkyl group, an aryl group, an allyl group, or a fluoroalkyl group. The alkyl group may have an epoxy group, an amino group, an acryl group, an isocyanate group and/or a mercapto group, as a functional group. x indicates an integer of from 0 to 3, preferably an integer of from 0 to 2.)

Examples of the organosilane of formula (II) are the following, to which, however, the invention should not be limited.

In case where x=0 in formula (II), they include tetramethoxysilane, tetraethoxysilane, tetraisopropoxysilane, tetra-n-butoxysilane.

In case where x=1, they include methyltrimethoxysilane, methyltriethoxysilane, ethyltrimethoxysilane, vinyltrimethoxysilane, vinyltriethoxysilane, phenyltrimethoxysilane, phenyltriethoxysilane, CF₃CH₂CH₂Si(OCH₃)₃, CF₃(CF₂)₅CH₂CH₂Si(OCH₃)₃, γ-glycidoxypropyltrimethoxysilane, γ-glycidoxypropyltriethoxysilane, γ-aminopropyltrimethoxysilane, γ-trimethoxysilylpropyl isocyanate, γ-mercaptopropyltrimethoxysilane, γ-methacryloxypropyltrimethoxysilane, γ-acryloxypropyltrimethoxysilane.

In case where x=2, they include dimethyldimethoxysilane, dimethyldiethoxysilane, γ-glycidoxypropylmethyldimethoxysilane, γ-aminopropylmethyltriethoxysilane, γ-mercaptopropylmethyldimethoxysilane, γ-methacryloxypropylmethyldimethoxysilane.

For the purpose of controlling the hardness and the brittleness of the cured film and for introducing a functional group, two or more different types of organosilanes may be used, as combined.

The coupling agent may be treated according to a direct treatment method and a integral blend method with fine particles. The direct method may be roughly grouped into a dry method, a slurry method and a spray method. The fine particles obtained according to the direct treatment method are excellent in that when they are added to a binder, their surfaces may be surely modified with the coupling agent. Above all, the dry method is popular, which comprises uniformly dispersing fine particles in an aqueous alcoholic solution, an organic solvent or an aqueous solution of a silane coupling agent, and then drying them. A stirrer such as Henschel mixer, super mixer, ready mixer, V-shape mixer or open kneader is preferably used. Of those mixers, more preferred is an open kneader. Preferably, fine particles, and a small amount of water or a water-containing organic solvent and a coupling agent are mixed and stirred in an open kneader, then water is removed, and the residue is further finely pulverized.

The slurry method includes processing fine particles into their slurry in the process of producing fine particles, in which a coupling agent is added to the slurry. Its advantage is that the fine particles may be processed during their production. The spray method includes adding a coupling agent to fine particles in a process of producing the fine particles, and this is advantageous in that the fine particles may be processed during their production but is disadvantageous in that it lacks uniform processability.

The integral blend method is described. This comprises adding a coupling agent and fine particles into a binder, and is a simple method though it requires well kneading them. The invention is characterized in that the cellulose mixed ester contains from 0.005 to 1.0% by mass of fine particles relative to the ester. The content of the fine particles is preferably from 0.01 to 0.8% by mass, more preferably from 0.02 to 1.0% by mass.

### (Other Additives)

Various additives (e.g., plasticizer, degradation inhibitor, fine particles, optical characteristic-controlling agent) may be added to the cellulose mixed ester in the invention in a process of producing it, in accordance with the use thereof. They may be added in any stage of the melt (dope) production process; however, the melt (dope) production process may include adding an additive to the melt as its final step.

### (Plasticizer)

A plasticizer may be added to the cellulose mixed ester in the invention whereby the crystal melting temperature (Tm) of the cellulose mixed ester may be lowered. The molecular weight of the plasticizer for use in the invention is not specifically defined, and it may have a low molecular weight or a high molecular weight. Regarding its type, the plasticizer may include phosphates, alkylphthalylalkyl glycolates, carboxylates, fatty acid esters with polyalcohols. Regarding its form, the plasticizer may be solid or oily. In other words, the plasticizer is not specifically defined in point of its melting point and boiling point. For use in melt casting film formation, the plasticizer is preferably a non-volatile one.

Examples of phosphates are triphenyl phosphate, tributyl phosphate, tributoxyethyl phosphate, tricresyl phosphate, trioctyl phosphate, trinaphthyl phosphate, trixylyl phosphate, tris-ortho-biphenyl phosphate, cresylphenyl phosphate, octyldiphenyl phosphate, biphenyldiphenyl phosphate, 1,4-phenylene-tetraphenyl phosphate. In addition, the phosphate-type plasticizers described in claims 3 to 7 in JP-T-6-501040 are also preferred for use herein.

Alkylphthalylalkyl glycolates include, for example, methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate, octylphthalylethyl glycolate.

Carboxylates include, for example, phthalates such as dimethyl phthalate, diethyl phthalate, dibutyl phthalate, dioctyl phthalate and diethylhexyl phthalate; citrates such as acetyltrimethyl citrate, acetyltriethyl citrate, acetyltributyl citrate; adipates such as diethyl adipate, dibutyl adipate, diisobutyl adipate, bis(2-ethylhexyl)adipate, diisodecyl adipate, bis(butyldiglycol adipate); aromatic polycarboxylates such as tetraoctyl pyromellitate, trioctyl trimellitate; aliphatic polycarboxylates such as dibutyl adipate, dioctyl adipate, dibutyl sebacate, dioctyl sebacate, diethyl azelate, dibutyl azelate, dioctyl azelate; fatty acid esters of polyalcohols such as glycerin triacetate, diglycerin tetraacetate, acetylglyceride, monoglyceride, diglyceride. In addition, preferably, butyl oleate, methylacetyl linolate, dibutyl sebacate and triacetin may also be used either singly or as combined with the above.

Further, polymer plasticizers are also usable herein, for example, aliphatic polyesters formed of glycol and dibasic acid, such as polyethylene adipate, polybutylene adipate, polyethylene succinate, polybutylene succinate; aliphatic polyesters formed from hydroxycarboxylic acid such as polylactic acid, polyglycolic acid; aliphatic polyesters formed from lactone such as polycaprolactone, polypropiolactone, polyvalerolactone; vinylic polymers such as polyvinylpyrrolidone. The plasticizer may be used either alone or as combined with a low-molecular-weight plasticizer.

The polyalcohol-type plasticizer includes glycerin ester compounds such as glycerin ester, diglycerin ester; polyalkylene glycols such as polyethylene glycol, polypropylene glycol; polyalkylene glycol compounds with an acyl group bonding to the hydroxyl group thereof, and they have good compatibility with cellulose fatty acid esters and may significantly express their plasticizing effect.

Concretely, the glycerin esters include glycerin diacetate stearate, glycerin diacetate palmitate, glycerin diacetate myristate, glycerin diacetate laurate, glycerin diacetate caprate, glycerin diacetate nonanoate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanoate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate myristate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, glycerin oleate propionate, to which, however, the invention should not be limited. These may be used either singly or as combined. Of those, preferred are glycerin diacetate caprylate, glycerin diacetate pelargonate, glycerin diacetate caprate, glycerin diacetate laurate, glycerin diacetate myristate, glycerin diacetate palmitate, glycerin diacetate stearate, glycerin diacetate oleate.

Concrete examples of the diglycerin esters includes mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramyristate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprylate, diglycerin triacetate laurate, diglycerin triacetate myristate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimyristate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprylate, diglycerin acetate trilaurate, diglycerin acetate trimyristate, diglycerin acetate tripalmitate, diglycerin acetate tristearate, diglycerin acetate trioleate, diglycerin laurate, diglycerin stearate, diglycerin caprylate, diglycerin myristate, diglycerin oleate, to which, however, the invention should not be limited. These may be used either singly or as combined.

Of those, preferred are diglycerin tetraacetate, diglycerin tetrapropionate, diglycerin tetrabutyrate, diglycerin tetracaprylate, diglycerin tetralaurate.

Concrete examples of the polyalkylene glycols are polyethylene glycol and polypropylene glycol having a mean molecular weight of from 200 to 1000, to which, however, the invention should not be limited. These may be used either singly or as combined.

Concrete examples of the polyalkylene glycol compounds with an acyl group bonding to the hydroxyl group thereof are polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanoate, polyoxyethylene caprate, polyoxyethylene laurate, polyoxyethylene myristate, polyoxyethylene palmitate, polyoxyethylene stearate, polyoxyethylene oleate, polyoxyethylene linolate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanoate, polyoxypropylene caprylate, polyoxypropylene laurate, polyoxypropylene myristate, polyoxypropylene palmitate, polyoxypropylene stearate, polyoxypropylene oleate, polyoxypropylene linolate, to which, however, the invention should not be limited. These may be used either singly or as combined.

The amount of the plasticizer to be added is preferably from 0 to 20% by mass, more preferably from 2 to 18% by mass, most preferably from 4 to 15% by mass. When the content of the plasticizer is larger than 20% by mass, then the thermal flowability of the cellulose mixed ester may be bettered, but the plasticizer may bleed out on the surface of the melt-formed film or the glass transition temperature Tg of the film, which is an index of the heat resistance thereof, may lower.

### (Stabilizer)

In the invention, if desired, one or more different types of phosphite compounds, phosphorus ester compounds, phosphates, thiophosphates, weak organic acids, epoxy compounds may be mixed and added as a thermal degradation inhibitor or a coloration-resistant stabilizer, not detracting from the necessary properties of the film. As concrete examples of the phosphite-type stabilizer, preferably used are the compounds described in JP-A-2004-182979, paragraphs [0023] to [0039]. As concrete examples of the phosphorus ester compounds, usable are the compounds described in JP-A-51-70316, JP-A-10-306175, JP-A-57-78431, JP-A-54-157159 and JP-A-55-13765.

The amount of the stabilizer to be added in the invention is preferably from 0.005 to 0.5% by mass relative to the cellulose mixed ester, more preferably from 0.01 to 0.4% by mass, even more preferably from 0.05 to 0.3% by mass. When the amount thereof is at least 0.005% by mass, then the stabilizer may sufficiently exhibit its effect of preventing degradation and coloration during melt casting film formation. Further, when the amount is at most 0.5% by mass, then the stabilizer may not bleed out on the cellulose mixed ester film produced through melt casting film formation.

Also preferably in the invention, a degradation inhibitor and an antioxidant are added to the film. A phenolic compound, a thioether compound or a phosphorus compound may be added as a degradation inhibitor or antioxidant, and it exhibits a synergistic effect for degradation inhibition and antioxidation. As other stabilizers, the materials described in detail in Hatsumei Kyokai Disclosure Bulletin (No. 2001-1745, published by the Hatsumei Kyokai on Mar. 15, 2001), pp. 17-22 are preferably used.

### (Degradation Inhibitor)

A degradation inhibitor (e.g., antioxidant, peroxide-decomposing agent, radical inhibitor, metal inactivator, acid scavenger, amine) and a UV absorbent may be added to the cellulose mixed ester film. Such degradation inhibitor and UV absorbent are described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-8-29619, JP-A-8-239506, JP-A-2000-204173. Preferably, the amount of the additive is from 0.01 to 1% by mass of the melt (dope) for film formation, more preferably from 0.01 to 0.2% by mass. When the amount is less than 0.01% by mass, then the degradation inhibitor may be almost ineffective. When the amount is more than 1% by mass, then the degradation inhibitor may bleed out on the film surface. An especially preferred example of the degradation inhibitor is butylated hydroxytoluene (BHT).

### (Optical Controlling Agent)

In the invention, an optical controlling agent may be added. For example, a retardation controlling agent may be added for controlling the optical anisotropy of the film. For controlling the retardation of the cellulose mixed ester film, it is desirable to use an aromatic compound having at least two aromatic rings as a retardation controlling agent. Preferably, the amount of the aromatic compound to be used is from 0.01 to 20 parts by mass relative to 100 parts by mass of the cellulose mixed ester. More preferably, the aromatic compound is used in an amount of from 0.05 to 15 parts by mass relative to 100 parts by mass of cellulose acetate, even more preferably from 0.1 to 10 parts by mass. In the invention, two or more different types of aromatic compounds may be sued. The aromatic ring of the aromatic compound may include an aromatic hetero ring in addition to an aromatic hydrocarbon ring.

The aromatic hydrocarbon ring is especially preferably a 6-membered ring (i.e., benzene ring). In general, the aromatic hetero ring is an unsaturated hetero ring. The aromatic hetero ring is preferably a 5-membered ring, a 6-membered ring or a 7-membered ring, more preferably a 5-membered ring or a 6-membered ring. The aromatic hetero ring generally has a largest number of double bonds. The hetero atom to be in the hetero ring is preferably a nitrogen atom, an oxygen atom and a sulfur atom, more preferably a nitrogen atom. Examples of the aromatic hetero ring are furan ring, thiophene ring, pyrrole ring, oxazole ring, isoxazole ring, thiazole ring, isothiazole ring, imidazole ring, pyrazole ring, furazan ring, triazole ring, pyran ring, pyridine ring, pyridazine ring, pyrimidine ring, pyrazine ring and 1,3,5-triazine ring.

### (Fluorine Atom-Containing Polymer Lubricant)

Preferably, the cellulose mixed ester in the invention contains a fluorine atom-containing polymer. The fluorine atom-containing polymer may exhibit an effect as a lubricant.

The fluorine atom-containing polymer includes, for example, those described in JP-A-2001-269564. The fluorine atom-containing polymer is preferably a polymer prepared through polymerization of a monomer that contains, as the essential ingredient thereof, a fluoroalkyl group-containing ethylenic unsaturated monomer (monomer A). Not specifically defined, the fluoroalkyl group-containing ethylenic unsaturated monomer (monomer A) for the polymer may be any compound having an ethylenic unsaturated group and a fluoroalkyl group in the molecule. Preferred are those having an acryl ester group or its analogous group. Concretely mentioned are fluoro(meth)acrylates of the following general formula (1). (Meth)acrylate indicates a generic term for methacrylate, acrylate, fluoroacrylate, chloroacrylate.

CH₂═C(R¹)—COO—(X)n-Rf (1)

(In the formula, Rf represents a perfluoroalkyl group or partially-fluorinated alkyl group having from 1 to 20 carbon atoms, and Rf may be linear or branched and may have a functional group containing an oxygen atom and/or a nitrogen atom in the main chain thereof. R¹ represents H, an optionally-fluorinated alkyl group, Cl or F; X represents a divalent linking group; n indicates an integer of 0 or more.)

Preferably, the perfluoroalkyl group for Rf has from 1 to 18 carbon atoms, more preferably from 4 to 18 carbon atoms, even more preferably from 6 to 14 carbon atoms, most preferably from 6 to 12 carbon atoms. Preferably, the partially fluorinated alkyl group has a perfluoroalkyl group as a part thereof, in which the preferred range of the number of the carbon atoms constituting the perfluoroalkyl group is the same as above. The oxygen atom-containing functional group which the main chain may have includes —SO₂—, —(C═O)—; and the nitrogen atom-containing functional group includes —NH—, —N(CH₃)—, —N(C₂H₅)—, —N(C₃H₇)—.

The optionally-fluorinated alkyl group for R¹ may be any of an unsubstituted alkyl group, a perfluoroalkyl group, or a partially-fluorinated alkyl group. Preferably, it is an unsubstituted alkyl group or a partially-fluorinated alkyl group. The unsubstituted alkyl group is preferably a methyl group.

Preferred examples of the divalent linking group for X are —(CH₂)ₘ—, —CH₂CH(OH)—(CH₂)ₘ—, —(CH₂)ₘN(R²)—SO₂—, —(CH₂)ₘN(R²)—CO—, —CH(CH₃)—, —CH(CH₂CH₃)—, —C(CH₃)₂—, —CH(CF₃)—, —C(CH₃)(CF₃)—, —C(CF₃)₂—. The material represented by a general formula (3) is also preferred for the fluoroalkyl group-containing ethylenic unsaturated monomer (A). R² is a hydrogen atom or an alkyl group having from 1 to 6 carbon atoms.

n indicates an integer of 0 or more, preferably from 0 to 25, more preferably from 1 to 15, even more preferably from 1 to 10. When n is 2 or more, the linking groups represented by X's may be the same or different.

One or more different types of fluoroalkyl group-containing ethylenic unsaturated monomers (monomer A) may be used either singly or simultaneously as combined. The fluoroalkyl group in the fluoroalkyl group-containing ethylenic unsaturated monomer (monomer A) preferably has from 6 to 18 carbon atoms, more preferably from 6 to 14 carbon atoms, even more preferably from 6 to 12 carbon atoms, in view of the releasing capability (lubrication). The amount of the fluoroalkyl group-containing ethylenic unsaturated monomer (monomer A) to be introduced into the polymer (I) is not specifically defined. Preferably, the monomer is polymerized in an amount of at least 10% by mass, more preferably its content is at least 15% by mass, even more preferably at least 20% by mass.

Further, the fluorine atom-having polymer in the invention may contain a polyoxyalkylene group-containing unsaturated monomer (monomer B). Not specifically defined, the polyoxyalkylene group-containing ethylenic unsaturated monomer (monomer B) may be any one having a polyoxyalkylene group and an ethylenic unsaturated group in one molecule. The oxyalkylene group is preferably an ethyleneoxide group and/or a propyleneoxide group. The degree of polymerization of the polymer may be generally from 1 to 100, preferably from 5 to 50. The ethylenic unsaturated group is preferably a (meth)acryl ester group or a group containing its analogue, from the viewpoint of the easy availability of the starting material, the compatibility with the ingredients in various coating compositions, the easiness in controlling the compatibility and the polymerization reactivity.

Further, the polymer may contain an ethylenic unsaturated monomer (monomer C) having at least two unsaturated bonds in one molecule. Not specifically defined, the ethylenic unsaturated monomer (monomer C) having at least two unsaturated bonds in one molecule may be suitably selected depending on the composition of the matrix resin, the solvent and others in the intended composition. The ethylenic unsaturated group is preferably a (meth)acryl ester group or a group containing its analogue, from the viewpoint of the easy availability of the starting material, the compatibility with the ingredients in various coating compositions, the easiness in controlling the compatibility and the polymerization reactivity.

Preferred examples of the fluorine atom-having polymer for use in the invention are described below; however, the fluorine atom-having polymer usable in the invention should not be limited to these.

PF-1: 2-heptadecylfluorooctyl-ethyl acrylate/butyl acrylate=30/70 (by mol, molecular weight 3000).
PF-2: 2-heptadecylfluorooctyl-ethyl acrylate/2-ethylhexyl acrylate=25/75 (by mol, molecular weight 5000).
PF-3: 2-tridecafluorohexyl-ethyl acrylate/butyl acrylate=20/80 (by mol, molecular weight 8000).
PF-4: 2-tridecafluorohexyl-ethyl acrylate/butyl acrylate=15/85 (by mol, molecular weight 5000).
PF-8: 2-heptadecylfluorooctyl-ethyl acrylate/poly(mean degree of polymerization 5)oxyethylene methacrylate/butyl acrylate=30/20/50 (by mol, molecular weight 9000).
PF-9: 2-tridecafluorohexyl-ethyl acrylate/poly(mean degree of polymerization 5)oxyethylene methacrylate/2-ethylhexyl acrylate/methyl acrylate/triethylene glycol dimethacrylate=30/20/30/15/5 (by mol, molecular weight 3000).
PF-10: 2-tridecafluorohexyl-ethyl acrylate/poly(mean degree of polymerization 5)oxyethylene methacrylate/2-butyl acrylate/methyl methacrylate/tetraethylene glycol dimethacrylate=30/25/25/15/5 (by mol, molecular weight 3500).
PF-11: 2-tridecafluorohexyl-ethyl acrylate/poly(mean degree of polymerization 5)oxyethylene methacrylate/2-hexyl acrylate/methyl methacrylate/tetraethylene glycol dimethacrylate=30/25/25/10 (by mol, molecular weight 6000).
PF-12: 2-tridecafluorohexyl-ethyl acrylate/poly(mean degree of polymerization 5)oxyethylene methacrylate/2-hexyl acrylate/methyl methacrylate=30/25/25/20 (by mol, molecular weight 6000).
PF-13: 2-heptadecylfluorooctyl-ethyl acrylate/poly(mean degree of polymerization 5)oxyethylene methacrylate/2-hexyl acrylate/methyl methacrylate=25/25/30/20 (by mol, molecular weight 8000).
PF-14: 2-heptadecylfluorooctyl-ethyl acrylate/poly(mean degree of polymerization 5)oxyethylene methacrylate/2-hexyl acrylate/styrene=30/25/35/10 (by mol, molecular weight 9000).

### (Pelletization)

Preferably, the above cellulose mixed ester and additives are pelletized prior to melt casting film formation.

In pelletization, it is desirable that cellulose mixed ester is previously dried, but when a vent-type extruder is used, drying it may be attained in the extruder. For drying it, for example, herein employable is a method of heating it in a heating furnace at 90° C. for at least 8 hours, which, however, is not limitative. For pelletization, the above cellulose mixed ester and additives are melted in a twin-screw extruder at 150° C. to 230° C., then extruded out as noodles, and they are solidified in water and pelletized. Also herein employable for pelletization is an underwater cutting method that comprises melting a polymer mixture in an extruder, followed by directly cutting the resulting melt in water immediately after extruded out through the extruder die into water. The extruder may be any ordinary one in which a mixture can be fully melted and kneaded, including, for example, known single-screw extruders, non-engaging multi-directional twin-screw extruders, engaging multi-directional twin-screw extruders, engaging unidirectional twin-screw extruders. Preferably, the size of the pellets is as follows: The cross section is from 1 mm² to 300 mm², and the length is from 1 mm to 30 mm; more preferably the cross section is from 2 mm² to 100 mm², and the length is from 1.5 mm to 10 mm.

In pelletization, the additives may be put into the extruder through the material take-in mouth or the vent mouth formed in the extruder. Preferably, the number of revolution of the extruder is from 10 rpm to 1000 rpm, more preferably from 20 rpm to 700 rpm, even more preferably from 30 rpm to 500 rpm. When the number of revolution is at least 10 rpm, then the retention time may not be too long, and the thermal deterioration to cause molecular weight reduction or yellowing may be easy to prevent. When it is at most 1000 rpm, then the molecule breakage by shearing to cause molecular weight reduction or crosslinked gel formation may be easy to prevent. The extruder retention time in pelletization is preferably from 10 seconds to 60 minutes, more preferably from 15 seconds to 30 minutes. So far as the polymer mixture can be well melted therein, the retention time in the extruder is preferably as short as possible for preventing the resin deterioration and yellowing.

### (Melt Casting Film Formation)

### 1) Drying:

In the invention, the pellets prepared according to the method as above are preferably used, and prior to melt casting film formation, the water content of the pellets is preferably reduced to at most 1%, more preferably at most 0.5%, even more preferably at most 0.01%, and then they are put into the hopper of a melt extruder. In this stage, the hopper is kept preferably at a temperature of from 20° C. to 110° C., more preferably from 40° C. to 100° C., even more preferably from 50° C. to 90° C.

In this stage, it is desirable that moisture-free air is introduced into the hopper so as to have a constant flow rate and a constant temperature therein, which, however, is not limitative so far as the intended water content could be attained. More preferably, the hopper may have a vacuum closed structure, and may be filled with an inert gas such as nitrogen.

### 2) Melt Extrusion:

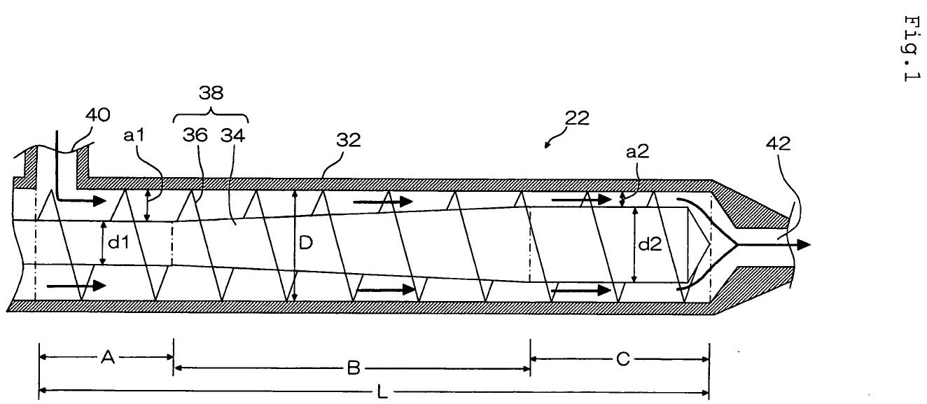

The above cellulose mixed ester resin is fed into the cylinder of an extruder via its supply port. A structure of an extruder 22 is shown in FIG. 1. The inside of the cylinder 32 comprises a feed zone (region A) in which the cellulose mixed ester resin fed through the supply port is quantitatively transported, a compression zone (region B) in which the cellulose mixed ester resin is melt-kneaded and compressed, and a metering zone (region C) in which the melt-kneaded and compressed cellulose mixed ester resin is metered, in that order from the side of the supply port 40. The resin is preferably dried for reducing the water content thereof according to the method mentioned above; however, for the purpose of preventing the resin melt from being oxidized by the remaining oxygen, more desirably, the extruder is made to have an inert gas (e.g., nitrogen) atmosphere or is degassed to vacuum through its vent.

Preferably, the screw compression ratio of the extruder is set to be from 2.5 to 4.5, and L/D is set to be from 20 to 70. The screw compression ratio is represented by the ratio by volume of the feed zone A to the metering zone C, or that is, it is represented by (the volume per unit length of the feed zone A)/(the volume per unit length of the metering part C), and this may be computed from the outer diameter dl of the screw axis in the feed zone A, the outer diameter d2 of the screw axis in the metering zone C, the groove diameter al in the feed zone A, and the groove diameter a2 in the metering zone C. L/D means a ratio of the cylinder length to the cylinder inner diameter. Preferably, the extrusion temperature is set to be from 190 to 240° C. In case where the temperature inside the extruder is over 230° C., then it is desirable to provide a cooling unit between the extruder and the die.

When the screw compression ratio is too small, then the resin could not be fully melted and kneaded to give an unmelted part, and the shearing heat may be too small and the crystal would be melted insufficiently, whereby the produced cellulose mixed ester film may often have fine crystals remaining therein, and further, the film may often catch bubbles therein. As a result, the strength of the cellulose mixed ester film may be low, or when the film is stretched, the remaining crystals may detract from the stretchability of the film and the film could not be sufficiently oriented. On the contrary, when the screw compression ratio is too large, then the resin may receive too much shearing stress and the resin, as thereby heated, may be readily degraded with the result that the produced cellulose mixed ester film may be readily yellowed. In addition, when too much shearing stress is given to the resin, then the molecules may be cut and the molecular weight of the resin may be thereby reduced, and the mechanical strength of the film may lower. In order that the produced cellulose mixed ester film is hardly yellowed and in order that the film strength is good and the film is hardly cut when stretched, the screw compression ratio is preferably within a range of from 2.5 to 4.5, more preferably from 2.8 to 4.2, even more preferably from 3.0 to 4.0.

When L/D is too small, then it may cause melting failure or kneading failure; and like in the case where the compression ratio is small, the produced cellulose mixed ester film may have fine crystals remaining therein. On the contrary, when L/D is too large, then the residence time of the cellulose mixed ester resin in the extruder may be too long, whereby the resin may be readily degraded. In addition, when the residence time is long, then the molecules may be cut whereby the molecular weight of the resin may be reduced and the mechanical strength of the cellulose mixed ester film may therefore lower. In order that the produced cellulose mixed ester film is hardly yellowed and in order that the film strength is high and the film is hardly broken when stretched, L/D is preferably within a range of from 20 to 70, more preferably from 22 to 65, even more preferably from 24 to 50.

In case where the extrusion temperature is too low, then the crystal may be insufficiently melted and the produced cellulose mixed ester film may have fine crystals remaining therein, therefore resulting in that the film strength may lower, and, when the film is stretched, the remaining crystals may interfere with its stretchability and the stretched film could not be fully oriented. On the contrary, when the extrusion temperature is too high, then the cellulose acylate resin may be degraded and may be much yellowed (as YI). In order that the produced cellulose mixed ester film is hardly yellowed and in order that the film strength may be high and the film may be therefore hardly cut while stretched, the extrusion temperature is preferably from 180° C. to 230° C., more preferably from 185° C. to 230° C., even more preferably from 190° C. to 230° C.

Regarding their characteristic data, the cellulose mixed ester film produced by the use of the extruder having a temperature set as in the above may have a haze of at most 2.0% and an yellow index (YI value) of at most 10.

The haze is an index indicating as to whether the extrusion temperature is too low or not, or that is, it is an index indicating the amount of the crystals remaining in the cellulose mixed ester film. When the haze is more than 2.0%, then the strength of the produced cellulose mixed ester film may be low and the film may be often broken when stretched. The yellow index (YI value) is an index indicating as to whether the extrusion temperature is too high or not; and when the yellow index (YI value) is at most 10, then the film has no problem in point of its yellowing degree.

Regarding the type of the extruder for use herein, in general, a single-screw extruder is much used, as relatively inexpensive in point of its equipment cost. Types of the screw include a full-flight screw, a Maddock screw and a Dulmage screw. For the cellulose mixed ester resin which has relatively poor thermal stability, full-flight screws are preferred. Although it involves high equipment cost, a twin-screw extruder whose screw segment is modified and to which a vent port is provided along the body to be able to perform extrusion while discharging unnecessary volatile components may also be used. Twin screw extruders are roughly classified into co-rotating types and counter-rotating types. Although both can be used, co-rotating types in which residence areas are not easily formed and which have high self-cleaning ability are preferred. Although twin screw extruders require high equipment cost, they are suitable for producing a film of a cellulose acetate resin because they have high kneadability and high resin supply ability, enabling extrusion at low temperatures. By providing a vent port at an appropriate position, cellulose acylate pellets or powder which have not been dried can be directly used. Moreover, pieces of films produced during film forming can be directly reused without drying.

Although the screws have different diameters depending on the intended extrusion amount per unit time, the diameter is preferably from 10 mm to 300 mm, more preferably from 20 mm to 250 mm, even more preferably from 30 mm to 150 mm. For improving the film thickness accuracy, it is important to reduce the extrusion amount fluctuation, and it may be effective to provide a gear pump between the extruder and the die to thereby supply a constant amount of a cellylose-mixed resin ester via the gear pump. The gear pump has a pair of gears, i.e., a drive gear and a driven gear engaged with each other. By driving the drive gear to engage and rotate the two gears, a resin melt is sucked into the cavity through a suction port provided on the housing, and the resin is discharged through a discharge port also provided in the housing in a constant amount. Even if the pressure of the resin at the tip of the extruder slightly fluctuates, such fluctuation is absorbed by the use of the gear pump, and thus the fluctuation in the pressure of the resin in the downstream of the film forming apparatus becomes very small, and this reduces film thickness fluctuation. By using a gear pump, the resin pressure fluctuation through the die can be kept within ±1%.

To improve the capability of constant supply through gear pumps, an approach of controlling the pressure before a gear pump at a constant value by changing the rotational number of the screw is also applicable. A high accuracy gear pump using 3 or more gears in which fluctuation in the gear is eliminated is also effective. For the other advantages of using a gear pump, since film fromation can be performed under decreased pressure at the screw tip, reduction in energy consumption, prevention of increase in the resin temperature, improvement in transportation efficiency, shortening of the residence time in the extruder and reduction in L/D in the extruder can be expected. Further, when using a filter for removing contaminants, the amount of the resin supplied through the screw may fluctuate due to increase in the filtration pressure in the absence of a gear pump; this problem, however, can be solved by using a gear pump in combination. On the other hand, such a gear pump has a disadvantage that its equipment becomes long depending on which equipment is selected, and the residence time of the resin is prolonged. In addition, due to the shearing stress in the gear pump, molecular chains may be broken. Accordingly, attention must be paid to these disadvantages.

A preferred residence time for the resin which is introduced into the extruder through its supply port and discharged from the die is from 2 minutes to 60 minutes, more preferably from 3 minutes to 40 minutes, even more preferably from 4 minutes to 30 minutes. If the polymer flow circulation in the bearing of the gear pump becomes poor, sealing with the polymer at the driving part and the bearing part becomes poor, causing problems such as large fluctuation in resin metering and extursion pressure. Therefore, designing of gear pumps (particularly clearance) in accordance with the melt viscosity of cellulose mixed ester resin is necessary. Further, in some cases, the residence part in the gear pump gives rise to deterioration of cellulose mixed ester resin, and therefore a structure with the smallest possible residence therein is preferred. Polymer tubes and adapters connecting the extruder and the gear pump or the gear pump and the die must also be designed with the smallest possible residence in the structure. In addition, for stabilization of the extrusion pressure of cellulose mixed ester resin whose melt viscosity is highly dependent on the temperature, the temperature fluctuation is preferably kept as small as possible. Generally, a band heater whose equipment cost is low is often used for heating the polymer tube, but an aluminum cast heater with a smaller temperature fluctuation is more preferably used. Further, in order that G′, G″, tan δ and η inside the extruder may have maximum and minimum values, it is desirable that the extruder barrel is divided into 3 to 20 portions and these are separately heated with heaters.

The cellulose mixed ester resin is melted in the extruder configured as above, and the resin melt is continuously fed to the die through the extrusion port. Any type of commonly used dies such as a T-die, a fish-tail die and a hanger coat die may be used as long as the die is designed so that the residence of the resin melt in the die is short. A static mixer may be disposed immediately before the T-die in order to improve the uniformity of the resin temperature. The clearance of the T-die outlet is generally from 1.0 to 5.0 times, preferably from 1.2 to 3 times, more preferably from 1.3 to 2 times the film thickness. When the lip clearance is too smaller than the film thickness, then a well-formed sheet is difficult to obtain by film forming. When the lip clearance is too larger than the film thickness, then the uniformity in the thickness of the sheet may lower.

The die is a very important device for determining the thickness uniformity of the film, and a die capable of precisely controlling its thickness is preferred. The thickness is generally controllable at intervals of from 40 to 50 mm. Dies capable of controlling the film thickness at intervals of preferably 35 mm or less, more preferably 25 mm or less are preferred. Since the melt viscosity of a cellulose acylate resin is highly dependent on the temperature and the shear rate thereof, a design in which the unevenness in the temperature of the die and the unevenness in the resin flow rate in the width direction are as small as possible is essential. In addition, an automatic thickness control die in which the film thickness in the downstream is measured to calculate the thickness deviation and the result is given as a feedback for controlling the thickness in the die is effective for reducing the film thickness fluctuation in long-term continuous production. A single layer film forming apparatus whose equipment cost is low is generally used for producing a film. In some cases, however, a multi-layer film forming apparatus may also be used for forming a functional layer as an outer layer so as to produce a film having two or more layer structures. Generally, a thin functional layer is preferably stacked on the surface layer, but the ratio of the thickness of the layers is not particularly limited.

For removing the impurities from the resin through filtration or for preventing the gear pump from being damaged by the impurities, breaker plate type filtration is preferred for which a filter member is disposed at the outlet port of the extruder.

In addition, for more accurately removing the impurities through such filtration, a filtering device is also preferably employed herein, which comprises a leaf-type disc filter after the gear pump therein. The filtration may be one-stage filtration through one filter or multi-stage filtration through plural filters. The filtration accuracy of the filter member is preferably higher; however, in view of the pressure resistance of the filter member and on the filtration pressure increase owing to clogging of the filter member, the filtration accuracy is preferably from 15 μm to 3 μm, more preferably from 10 μm to 3 μm. In particular, in case where a leaf-type disc filter device is used for final filtration to remove impurities, it is desirable to use a filter member having high filtration accuracy in view of the product quality, and for ensuring the pressure resistance the filter life aptitude, the number of the filter members to be built in the device may be controlled. For the filter material, preferred are iron and steel materials as it is used at high temperature and under high pressure. Of iron and steel materials, more preferred is stainless steel or steel. From the viewpoint of the corrosion resistance thereof, even more preferred is stainless steel. Regarding its constitution, the filter material may be a knitted wire material as well as a sintered filter material formed by sintering long fibers of metal or metal powder. From the viewpoint of the filtration accuracy and the filter life, preferred is a sintered filter material.

### 3) Casting:

The resin melt extruded in the form of a sheet through a die according to the above method is solidified by cooling on a casting drum to give a film. In this step, the contact between the casting drum and the melt-extruded sheet is preferably increased using an electrostatic application method, an air knife method, an air chamber method, a vacuum nozzle method or a touch roll method. Such a method for contact improvement may be performed on the entire surface of the melt-extruded sheet or on some part thereof. Particularly, a method called edge pinning, in which only both edges of the film are adhered to the drum, is often employed, but the method is not limited thereto. Preferably, a plurality of casting drums are used to gradually cool the resin. While using three cooling rolls is rather common, it is not limitative. The roll has a diameter of preferably from 50 mm to 5000 mm, more preferably from 100 mm to 2000 mm, even more preferably from 150 mm to 1000 mm. The face-to-face distance between the plural rolls is preferably from 0.3 mm to 300 mm, more preferably from 1 mm to 100 mm, even more preferably from 3 mm to 30 mm.

The casting drum is set preferably at 60° C. to 160° C., more preferably at 70° C. to 150° C., even more preferably at 80° C. to 140° C. The resin is then peeled off from the casting drum and wound up after nip rolls. The winding rate is preferably from 10 m/minute to 100 m/minute, more preferably from 15 m/minute to 80 m/minute, even more preferably from 20 m/minute to 70 m/minute.

The film width is preferably from 0.7 m to 5 m, more preferably from 1 m to 4 m, even more preferably from 1.3 m to 3 m. The unstretched film thus obtained has a thickness of preferably from 20 μm to 400 μm, more preferably from 40 μm to 300 μm and further preferably from 50 μm to 200 μm. In the invention, when the thickness of the obtained cellulose mixed ester film is more than 200 μm, then the film may be further stretched thereby to have a thickness desired in the invention. When a so-called touch roll method is employed, the surface of the touch roll may be made of rubber or resin such as Teflon, or a metal roll may also be used. A roll called a flexible roll obtained by reducing the thickness of a metal roll, whose roll surface may be slightly depressed due to pressure upon touching and whose pressing area may be thus increased, may also be used. The temperature of the touch roll is preferably from 60° C. to 160° C., more preferably from 70° C. to 150° C., even more preferably from 80° C. to 140° C.

### (Winding)

Preferably, both ends of the sheet thus obtained are trimmed and the sheet is wound up. The trimmed portions may be crushed, or if desired, granulated, depolymerized or polymerized again, and reused as a raw material for the same type of film or a different type of film. As a trimming cutter, any cutter such as a rotary cutter, a shear blade and a knife may be used. The material of the cutter may be any one of carbon steels and stainless steels. In general, use of an ultrahard blade or a ceramic blade is preferred because they have a long life and generation of chips upon cutting can be reduced.

Before wound up, the film is preferably laminated with another film for preventing it from being scratched. The winding up tension is preferably from 1 kg/m in width to 50 kg/m in width, more preferably from 2 kg/m in width to 40 kg/m in width, even more preferably from 3 kg/m in width to 20 kg/m in width. When the winding up tension is too small, then the film may be difficult to uniformly wind up. On the contrary, when the winding up tension is too large, then the film may be wound up too tightly and therefore, not only the appearance of the wound film may be poor but also the raised portions in the film may be extended due to creep, resulting in waving of the film, or the extended film may have a residual birefringence. The winding up tension is detected by tension control along the line, and the film is preferably wound up while controlled to have a constant winding-up tension. When the film temperature varies depending on the position in the film forming line, films may have a slightly different length due to thermal expansion. Accordingly, it is necessary that the drawing ratio of nip rolls is adjusted so that a tension higher than a pre-determined level is not applied to the film in the line. The film can be wound up under a constant tension by controlling the tension controller. More preferably, however, the tension is tapered proportional to the roll diameter to thereby determine an appropriate winding-up tension. Generally, the tension is gradually reduced as the roll diameter increases, but in some cases, the tension is preferably increased as the roll diameter increases.

### (Melt Casting Film Formation Step)

The melt casting film formation step in the invention and its condition are described.

In general, melt casting film formation is to obtain a desired cellulose mixed ester film through a kneading and extrusion step of heating a cellulose mixed ester at a predetermined temperature and mixing it with additives, a casting step, a stretching step, a relaxation step, a cooling step, a winding step and a processing step. The condition for the melt casting film formation is optimized, as described in detail hereinunder.

### (Preheating of Cellulose Mixed Ester)

Preferably, a cellulose mixed ester is previously fully dried, and then fed into the hopper of a melt extruder. Preferably, the cellulose mixed ester is dried to have a water content of at most 0.5% by mass, more preferably at most 0.2% by mass, even more preferably at most 0.1% by mass. Accordingly, the cellulose mixed ester may be prevented from being hydrolyzed while, and impurities may be prevented from being generated thereby. Preferably, the cellulose mixed ester may be dried at 80° C. to 180° C. for 0.1 hours to 100 hours. The treatment may be effected in an air atmosphere or in an inert gas (e.g., nitrogen) atmosphere or in vacuum. The pretreatment may reduce the impurities that may be generated during film formation. In particular, the ester is dried by heating under reduced pressure. This is because the sources of the impurities may be from hydrolysis of cellulose mixed ester with water, or dehydration with sulfuric acid released from the bonding sulfuric acid, or oxidative decomposition with oxygen. Regarding the heating temperature of the hopper preferably used in the invention, the cellulose mixed ester is recommendably heated at from (Tg−50° C.) to (Tg+30° C.), more preferably from (Tg−40° C.) to (Tg+10° C.), even more preferably from (Tg−30° C.) to Tg of the ester. Accordingly, the cellulose mixed ester is prevented from readsorbing water from air in the hopper.

### (Kneading Extrusion)

Using a kneading screw installed in a melt extruder and having a compression ratio of from 2 to 15, cellulose mixed ester is kneaded at a desired melting temperature at which the ester is heated in the preheating step. Specifically, in the invention, the cellulose mixed ester is melted at a temperature of from 180° C. to 230° C., preferably from 190° C. to 225° C., more preferably from 190° C. to 220° C., for removing die streaks. When the cellulose mixed ester is melted at a temperature higher than 230° C., then it may be decomposed, and the decomposed product may remain in the die to give die streaks, which extremely worsen the film thickness evenness. Further, the film may be noticeably colored, and there occurs another problem in that the loss of the trimmed edges of the film could not be recycled. The present invention is based on the improvement over the method described in the Examples of a prior patent application in that, according to the prior-application method, the cellulose mixed ester is decomposed at an extremely high temperature. When the melting point is lower than 180° C., then the melting failure may occur, therefore causing fish eyes in the formed film. Therefore, in the invention, in order to prevent the resin melting failure, it is recommended to use a screw having a high compression ratio. Preferably, the compression ratio is from 2 to 15, more preferably from 3 to 15, even more preferably from 4 to 12, still more preferably from 5 to 10. In general, the ester is melted at a compression ratio of less than 3.

In this stage, the melting temperature may be kept constant all the time, or may be varied to have a controlled temperature profile that varies in some sections. More preferably, the temperature on the upstream side (hopper side) is kept higher than the temperature on the downstream side (T-die side) by from 1° C. to 50° C., more preferably by from 2° C. to 30° C., even more preferably by from 3° C. to 20° C., since the decomposition of cellulose mixed ester may be more favorably prevented. Specifically, for promoting the melting, the upstream side that governs it is kept at a higher temperature, and after melted, the temperature is kept lower for the purpose of preventing the decomposition of the cellulose mixed ester. Preferably, the kneading time is from 2 minutes to 60 minutes, more preferably from 3 minutes to 40 minutes, even more preferably from 4 minutes to 30 minutes. Also preferably, the inner atmosphere of the melt extruder is an inert gas (e.g., nitrogen) atmosphere.

### (Casting)

Preferably, the cellulose mixed ester melt is introduced into a gear pump to remove the pulsation of the extruder. Afterwards, it is desirable to filter the melt through a metal mesh filter or the like. The mesh size of the filter is preferably from 2 to 30 μm, more preferably from 2 to 20 μm, even more preferably from 2 to 10 μm. In this stage, the time for filtration is shortened as much as possible under pressure. The filtration pressure is preferably from 0.5 MPa, to 15 MPa, more preferably from 2 Pa to 15 MPa, even more preferably from 10 Pa to 15 MPa. The filtration pressure is preferably higher since the filtration time may be shorter; however, it is a high pressure within a range within which the filter is not broken. The temperature during filtration is preferably from 180° C. to 230° C., more preferably from 180° C. to 220° C., even more preferably from 190 to 220° C. When the temperature during filtration is not higher than the uppermost limit, then it is favorable since a problem of promoted thermal degradation may hardly occur; and when the temperature is not lower than the lowermost limit, then it is also favorable since there hardly occurs a problem of too much time-consuming filtration to promote thermal degradation. It is desirable that the time for filtration is as short as possible to thereby prevent the film from yellowing. The filtration amount per cm² of the filter for 1 minute is preferably from 0.05 to 100 cm³, more preferably from 0.1 to 100 cm³, even more preferably from 0.5 to 100 cm³.

Next, the film formation die is, for example, a T-shaped die (T-die) or a hanger-type (hanger coat die); and a T-die is preferred herein. As fed through a die, a resin is sheetwise extruded out onto a cooling drum; and as so mentioned hereinabove, it is desirable to extrude it out through the die of which the temperature is controlled to be lower than the melting temperature of the resin. The melting temperature may vary in the melt extruder in plural portions thereof, and in such a case, the melting temperature nearest to the T-die is taken as the standard. After this, the distance between the T-die and the casting-drum is kept constant (preferably from 1 to 50 cm), as so mentioned in the above. In this step, it is desirable that the system is kept in a casing so as to reduce the temperature fluctuation during this. Further in the invention, the T-die temperature is preferably kept lower than the melting temperature by from 5° C. to 30° C. This is for the purpose of preventing the cellulose mixed ester staying on the T-die from being decomposed and scorched to cause die streaks, and this is characterized by lowering the T-die temperature. In ordinary film formation, the temperature between the melt extruder and the T-die is the same or the temperature of the T-die is elevated whereby the melt viscosity of the resin melt is lowered to remove the formed die streaks; and this is an ordinary technique. However, in case where a cellulose mixed ester that is easily decomposed under heat is formed into a film through melt casting film formation, then it is effective to lower the temperature as in the above.

For removing the lateral stepwise unevenness (stepwise unevenness occurring in the widthwise direction) of the cellulose mixed ester film, in the invention, it is desirable that the T-die is spaced from the casting drum by from 2 cm to 50 cm. More preferably, the spacing is from 5 cm to 40 cm, even more preferably from 7 cm to 35 cm. In general, for preventing the film from necking in, the distance between the T-die and the casting drum is as small as possible, and in the invention, it is said that the distance is near to 1 cm to 3 cm.

However, in the invention, since the cellulose mixed ester hardly necks in, it is desirable the distance between the casting drum and the T-die is broad, as so mentioned in the above. In this stage, the casting drum temperature is preferably from (Tg−30° C.) to Tg, more preferably from (Tg−20° C.) to (Tg−1° C.), even more preferably from (Tg−15° C.) to (Tg−2° C.). Further, thus prolonging the distance between the T-die and the casting drum is further effective for leveling the die streaks to reduce them. Tg of the cellulose mixed ester of the invention is preferably from 70° C. to 180° C., more preferably from 80° C. to 160° C., even more preferably from 90° C. to 150° C.

The extrusion may be for single-layer film formation, or may be multi-layer film formation via a multi-manifold die or a feed block die. After that, the resin is extruded out onto some casting drums (preferably 2 to 20 casting drums) that are suitably so selected as to have a suitable diameter (preferably from 10 to 200 cm) and a suitable temperature (preferably Tg−30° C.). In this stage, according to an electrostatic application method, an air knife method, an air chamber method, a vacuum nozzle method or a touch roll method, the adhesiveness between the casting drum and the melt-extruded sheet is increased. The adhesiveness increasing method may be applied to the entire surface of the melt-extruded sheet or to a part thereof.

Next, the molten cellulose mixed ester (melt), as extruded out through the die, is cooled and solidified on the casting drum preferably for a period of time as long as possible. Specifically, the melt extruded out through the die at Tg or higher is cooled to around Tg on the casting drum and is thus shrunk. During this stage, the in-plane shrinkage is inhibited by the friction between the melt and the casting drum, and therefore, the thickness-direction shrinkage is dominant. Specifically, the in-plane orientation is formed in this, thereby expressing the thickness-direction retardation (Rth) (hereinafter this may be referred to as “Rth”). When this shrinkage is rapid, then it may express Rth fluctuation, and therefore it is necessary to gradually cool the film as so mentioned hereinabove. Specifically, it is preferable that the film is cooled and solidified at a temperature between (Tg+30° C.) and Tg at a rate of from 10° C./sec to 100° C./sec (solidification speed), more preferably the solidification speed is from 15° C./sec to 80° C./sec, even more preferably from 20° C./sec to 60° C./sec. Ordinary resin is solidified at 300° C./sec or more, and therefore the above range in cooling in the invention is a sufficiently slow cooling speed. Accordingly, it is desirable to condition the temperature between the casting drum and the T-die, and the preferred temperature is from (Tg−30° C.) to (Tg+50° C.), more preferably from (Tg−20° C.) to (Tg+40° C.), even more preferably from (Tg−10° C.) to (Tg+30° C.).

In the invention, the number of the casting drums is preferably from 2 to 10, more preferably from 2 to 6, even more preferably from 3 to 5. The temperature of these casting drums may be the same or different. Preferably, the temperature of the most upstream casting drum is lower than that of the most downstream casting drum. In case where 3 or more casting drums are disposed, the temperature of those casting drums may be such that the temperature of the former stage drum may be higher or lower than that of the latter stage drum. In other words, the roll temperature may be set in any desired manner so far as the temperature of the most downstream drum is lower than that of the most upstream drum. The diameter of those casting drums may be generally from 20 cm to 200 cm. The film forming speed may from be 15 m/sec to 300 m/sec, more preferably from 20 m/sec to 200 m/sec, even more preferably from 30 m/sec to 100 m/sec.

After cooled, the cellulose mixed ester film is peeled away from the casting drum, and led through nip rolls and cut under tension by the nip rolls, and this is preferably wound up under a winding tension of from 0.01 kg/cm² to 10 kg/cm², more preferably from 0.10 kg/cm² to 9 kg/cm², even more preferably from 0.10 kg/cm² to 9 kg/cm². The winding speed is preferably from 10 m/min to 100 m/min, more preferably from 15 m/min to 80 m/min, even more preferably from 20 m/min to 70 m/min. The film width is preferably from 1.5 m to 5 m, more preferably from 1.6 m to 4 m, even more preferably from 1.7 m to 3 m. Just after peeled away from the casting drum, the temperature of the sheet is near to Tg; and therefore, the sheet is stretched by the winding tension to express its Re and Rth, and this is more noticeable at its edges than at its center.

Accordingly, the in-plane retardation (Re) (hereinafter this may be referred to as “Re”), and Rth may express parabolic unevenness. After the casting drum, disposed are nip rolls, and herein employed is a method of blocking the winding tension by the nip rolls; however, the tension could not be completely blocked and some slight tension may propagate even to the sheet after peeled away from the casting drum. This causes Re and Rth fluctuation. Since the fluctuation occurs in the entire region in the width direction of the film, and when the film size is small, the fluctuation could hardly be detected; but when a large-size film is cut, the fluctuation is problematic. Accordingly, it is important that the film of the invention is wound up under the above-mentioned weak tension (in general, however, a film is wound up under at least 20 kg/cm²). Winding up the film under such a low tension may cause winding failure, but the problem may be solved by knurling the film at its both sides. Thus obtained, the thickness of the film is preferably from 20 μm to 400 μm, more preferably from 40 μm to 200 μm, even more preferably from 50 μm to 150 μm. In the invention, when the thickness of the obtained cellulose mixed ester film is more than 200 μm, then the film may be further stretched to have a thickness falling within a desired range in the invention.

Stretching the unstretched film may give a stretched film having reduced thickness fluctuation, Re fluctuation and Rth fluctuation, and reduced moisture-dependent Re and Rth fluctuation. Thus obtained, the sheet is preferably trimmed at its both edges and is then wound up. The trimmed portions may be crushed, or if desired, granulated, depolymerized or polymerized again, and reused as a raw material for the same type of film or a different type of film. Before wound up, the film is preferably laminated with another film for preventing it from being scratched.

### (Stretching Step)

Preferably, the cellulose mixed ester film formed in the melt casting film formation step is stretched in at least one direction in a stretching step. The stretching is attained preferably at Tg to (Tg+50° C.), more preferably at (Tg+1° C.) to (Tg+30° C.), even more preferably at (Tg+2° C.) to (Tg+20° C.). Preferably, the draw ratio in stretching is from −10% to 50% in at least one direction. The draw ration in stretching is more preferably from 1% to 150%, even more preferably from 1% to 100%, still more preferably from 1% to 50%. The stretching may be attained in one stage or in multiple stages. The draw ratio as referred to herein may be obtained according to the following formula:

Draw Ratio (%)=100×{(length after stretching)−(length before stretching)}/(length before stretching).

The stretching may be made in the machine direction (machine-direction stretching), using at least two pairs of nip rolls of which the peripheral speed on the take-out side is kept higher; or may be made in the transverse direction (the machine direction and the right-angle direction) (transverse direction stretching), with both edges of the film held zipped.

In any case, when the draw ratio is larger, then both Re and Rth may be larger. For freely controlling the ratio of Rth/Re in machine-direction stretching, it may be attained by controlling the value obtained by dividing the nip roll distance by the film width (aspect ratio). Specifically, when the aspect ratio is made small, then the ratio Rth/Re may be made large. In transverse direction stretching, it may be controlled by stretching the film in the machine direction in addition to stretching it in the transverse direction, or may be controlled by relaxing the film contrary to it. Specifically, the ratio Rth/Re may be increased by stretching the film in the machine direction, or on the contrary, the ratio Rth/Re may be decreased by relaxing the film in the machine direction. It is desirable that the stretching rate is from 10%/min to 10000%/min, more preferably from 20%/min to 1000%/min, even more preferably from 30%/min to 800%/min.

In the invention, for further reducing the Re, Rth and thickness fluctuation, it is desirable to use an unstretched film with little fluctuation and to change the stretching temperature to have a temperature profile inclined in the transverse direction. Both in machine-direction stretching and in transverse direction stretching, both edges of the film are stretched to a higher degree to express Re and Rth; and therefore, it is desirable to make the temperature at both edges of the film higher than that in the center part thereof. The edges are meant to indicate a region of 10% of the overall width of the film; and the object may be attained by heating this region higher by from 6° C. to 40° C. than the center part of the film, more preferably by from 7° C. to 30° C., even more preferably by from 8° C. to 25° C. For heating both edges of the film at a higher temperature, a heat source (e.g., panel heater, IR heater) may be additionally disposed near to both edges thereof, or a hot air jet port may be additionally disposed near to it. In that manner, the temperature profile is intentionally given to the film, whereby more uniform stretching of the film may be attained than in a case where the film is stretched at a constant temperature. Such a phenomenon is peculiar to cellulose mixed ester film.

In this, the cooling temperature after the heat treatment may vary depending on the heat-treatment temperature and the film thickness; but in general, the film is cooled in air at a temperature falling within a range of from −40° C. to (Tg−10)° C. Preferably, the range is from 0 to 40° C. In this stage, the temperature difference between the film and the cooling medium such as air to cool the surface and the back of the film may have some influence on the non-thermal deformability of the obtained (biaxial) stretched film. When the temperature difference from the cooling gas is too large, then the thermal shrinkage difference between the two faces, that is, the surface and the back of the obtained (biaxial) stretched film may be large, and therefore, when heated, the film may be deformed and warped and its deformation may be great. Taking the point into consideration, it is desirable that the temperature difference between the film and the cooling medium such as air to cool the surface and the back of the film is smaller; however, for attaining the object of the present invention, it is important to control the temperature difference to be at most 5° C.

Before and after the stretching, the cellulose mixed ester film preferably has machine-direction and transverse direction dimensional shrinkage falling within ±0.1% or less at 105° C. for 5 hours. More preferably, the dimensional shrinkage of the film at 80° C. and a relative humidity of 90% is less than ±0.5% both in the machine direction and the transverse direction; and the haze thereof is preferably at most 1.2%, more preferably at most 0.6%. Also preferably, the tear strength of the film is at least 10 g both in the machine direction and the transverse direction; the tensile strength is preferably at least 50 N/mm² both in the machine direction and in the transverse direction; and the elasticity is preferably at least 3 kN/mm² both in the machine direction and in the transverse direction.

These unstretched and stretched cellulose mixed ester films may be used either singly or as combined with a polarizing plate; and a liquid crystal layer or a refractivity-controlled layer (low refractivity layer) or a hard coat layer may be disposed on it for use herein.

The stretched film may be obtained by stretching the unstretched film. In this, when an unstretched film (unprocessed film) having small Re fluctuation is stretched, then a stretched film having small Re fluctuation may be obtained; and this may be effective for reducing the Rth fluctuation, the thickness fluctuation and the temperature dependency of Re and Rth of the stretched film. In the invention, a film having reduced thickness fluctuation is used, as so mentioned in the above, whereby the film may be stretched uniformly both in the thickness and the retardation thereof. (However, when a film having thickness fluctuation as described in the above-mentioned JP-A-2000-352620 in which the method of the present invention is not employed is stretched, then the mechanically-weak part of the film is first stretched and therefore the thickness fluctuation may be augmented. One may have an impression that the stretching may reduce the thickness fluctuation, but in fact, the cellulose mixed ester film of the type is contrary to it.)

### (Characteristics of Cellulose Mixed Ester Film)

### (Thickness)

The cellulose mixed ester film of the invention is characterized in that its thickness is from 20 to 200 μm, more preferably from 20 μm to 160 μm, even more preferably from 30 μm to 120 μm, still more preferably from 40 to 120 μm. Accordingly, in case where it is stretched, it is desirable that the unstretched film previously has a large thickness depending on the draw ratio in stretching, and it is formed into a desired cellulose mixed ester film. Preferably, the angle θ between the machine direction (longitudinal direction) and the slow axis of Re of the film is nearer to 0°, +90° or −90°.

Both in the thickness direction and the transverse direction, the thickness fluctuation of the cellulose mixed ester film of the invention is preferably from 0 to 5 μm, more preferably from 0 to 3 μm, even more preferably from 0 to 2 μm.

### (Friction Value)

The production method of the invention is to reduce the friction value and to improve the transferability of the cellulose mixed ester film by adding fine particles to the ester. In the invention, it is desirable that the dynamic and static friction value of the cellulose mixed ester film is both from 0.2 to 1.5, more preferably from 0.2 to 1.3, even more preferably from 0.256 to 1.0. Regarding their existing condition, when the fine particles are coarse, then the friction value may be smaller or may be larger, and the two are unfavorable for the transferability of the film, and such coarse particles are not recommendable as causing faults.

The friction value may be determined as follows: A sample of 100 mm×200 mm and a sample of 75 mm×100 mm are conditioned under a condition of 25° C. and a relative humidity of 60% for 2 hours. Using a Tensilon tensile tester (RTA-100, by Orientec), the large film is put on a sample bed and fixed thereon, and the small film having a weight of 200 g is put onto it. Next, the weight is pulled in the horizontal direction, and at the time when the weight has begun to move, the force of the moving weight is measured. The static friction coefficient and the dynamic friction coefficient are computed, from which the static friction value and the dynamic friction value are derived. F=μ×W (F: friction value, μ: friction coefficient, W: weight (kgf))

### (Arithmetic Mean Roughness)

The particles-containing cellulose mixed ester film produced according to the production method of the invention is characterized in that its surface roughness falls within a suitable range. The surface roughness of the cellulose mixed ester film is represented by an ordinary arithmetic mean roughness (Ra). In the invention, the arithmetic mean roughness (Ra) of the cellulose mixed ester film is from 3 nm to 200 nm, preferably from 5 nm to 100 nm, more preferably from 5 nm to 80 nm. The arithmetic mean roughness (Ra) may be measured, using an ordinary contact-type or non-contact-type surface roughness meter.

### (Optical Characteristics)

The optical characteristics of the cellulose mixed ester film of the invention produced according to the production method of the invention are described below with reference its preferred examples, to which, however, the invention should not be limited.

In this description, the in-plane retardation (Re) and the thickness-direction retardation (Rth) are calculated, based on the following: Re(λ) and Rth(λ) are an in-plane retardation and a thickness-direction retardation, respectively, of a film at a wavelength of λ. Re(λ) is determined by applying light having a wavelength of λ to a film in the normal direction of the film, using KOBRA 21ADH (by Oji Scientific Instruments). Rth(λ) is determined as follows: Based on three retardation data determined in three different directions, or that is, Re(λ) as above, a retardation value measured by applying light having a wavelength of λ nm to the sample in the direction tilted by +50° relative to the normal direction of the film with the slow axis (judged by KOBRA 21ADH) as the tilt axis (rotation axis) thereof, and a retardation value measured by applying light having a wavelength of λ nm to the sample in the direction tilted by −50° relative to the normal direction of the film with the slow axis as the tilt axis thereof, Rth(λ) is computed by KOBRA 21ADH.

For this, an estimated value of the mean refractivity of the film and the film thickness must be inputted to the instrument. nx, ny and nz are also computed by KOBRA 21ADH in addition to Rth(λ). The mean refractivity of cellulose acylate is 1.48; and the data of some other polymer films than cellulose acetate for optical use are as follows: Cyclo-olefin polymer (1.52), polycarbonate (1.59), polymethyl methacrylate (1.49), polystyrene (1.59). For the mean refractivity data of still other already-existing polymer materials, referred to are the numerical data in Polymer Handbook (by John Wiley & and Sons, Inc.) or those in polymer film catalogues. When the mean refractivity of the sample is unknown, it may be measured with an Abbe's refractiometer. Unless otherwise specifically indicated, λ in this description is at 590±5 nm.

Preferably, the in-plane retardation (Re) at a wavelength of 590 nm of the cellulose mixed ester film of the invention is from 0 to 10 nm, and the absolute value of the thickness-direction retardation (Rth) thereof is from 0 to 60 nm. More preferably, the in-plane retardation (Re) is from 0 to 8 nm, and the absolute value of the thickness-direction retardation (Rth) is from 0 to 50 nm; even more preferably the in-plane retardation (Re) is from 0 to 5 nm, and the absolute value of the thickness-direction retardation (Rth) is from 0 to 40 nm. Preferably, the Re fluctuation is from 0 to 10 nm, more preferably from 0 to 5 nm, even more preferably from 0 to 3 nm. Preferably, the Rth fluctuation is from 0 to 10%, more preferably from 0% to 7%, even more preferably from 0% to 5%. Having the optical characteristics, the cellulose mixed ester film of the invention is extremely favorable for protective film for polarizer.

In addition, the invention solves a problem of moisture-dependent optical characteristics of the film, and is characterized in that the difference between the optical characteristics between of film at 25° C. and a relative humidity of 10% and those of the film at 25° C. and a relative humidity of 80% is small. Specifically, the cellulose mixed ester film of the invention is evaluated based on the absolute value of the Re change of the film that fluctuates depending on the ambient humidity. The moisture-dependent Re change (nm) is the absolute value of the difference between Re (at a relative humidity of 80%) and Re (at a relative humidity of 10%); and the moisture-dependent Rth change (nm) is represented by the absolute value of the difference between Rth (at a relative humidity of 80%) and Rth (at a relative humidity of 10%). Preferably, the moisture-dependent Re change of the cellulose mixed ester film of the invention is at most 10 nm; and further, the invention may realize the moisture-dependent Re change of 5 nm and even 1 nm. Also preferably, the moisture-dependent Rth change of the film is at most 25 nm; and further, the invention may realize the moisture-dependent Rth change of 20 nm and even 15 nm. As compared with that of conventional cellulose triacetate, the moisture-dependent change of the film is a favorable level of ⅔ to ½ of the conventional one.

The behavior of the wavelength-dependent optical characteristics of the cellulose mixed ester film of the invention may be controlled. Specifically, it is desirable that the absolute value of the difference between Re(400) and Re(700) at a wavelength of 400 nm and 700 nm, respectively, is from 0 to 15 nm, and the absolute value of the difference between Rth(400) and Rth(700) is from 0 to 35 nm.

These are expressed by numerical formulae. It is desirable that the in-plane retardation (Re) and the thickness-direction retardation (Rth) at a wavelength of 400 nm and 700 nm of the cellulose mixed ester film of the invention satisfy the following formulae (A-1) and (A-2):

0≦Re(700)−Re(400)≦15 nm, (A-1)

0≦Rth(700)−Rth(400)≦35 nm. (A-2)

(In the formulae, Re(400) and Re(700) mean an in-plane retardation (Re) at a wavelength f 400 nm and 700 nm; and Rth(400) and Rth(700) mean an thickness-direction retardation (Rth) at a wavelength f 400 nm and 700 nm.)

Regarding the intrinsic birefringence of the cellulose mixed ester film of the invention, which is a method of indicating the optical characteristic of the film, the intrinsic birefringence of the film in the in-plane direction in an environment at 25° C. and a relative humidity of 60% at a wavelength of 590 nm is preferably from 0 to 0.001, and the absolute value of the thickness-direction intrinsic birefringence of the film is preferably from 0 to 0.003. More preferably, the intrinsic birefringence of the film in the in-plane direction is from 0 to 0.0008, and the absolute value of the thickness-direction intrinsic birefringence thereof is from 0 to 0.0025; even more preferably, the intrinsic birefringence of the film in the in-plane direction is from 0 to 0.0006, and the absolute value of the thickness-direction intrinsic birefringence thereof is from 0 to 0.001.

### (Axial Shifting)

Preferably, the optical slow axis of the cellulose mixed ester film of the invention is parallel to or at a right angle to the machine direction or the transverse direction of the film. In particular, when the film is stretched in the machine direction, then it is preferably nearer to at 0°, more preferably at 0±3°, even more preferably at 0±1.5°, still more preferably at 0±0.5°. In case where the film is stretched in the transverse direction, it is preferably at 90±3° or at −90±3°, even more preferably at 90±1.5° or −90±1.5°, even more preferably at 90±0.5° or −90±0.5°.

### (Transmittance)

A sample of 20 mm×70 mm is analyzed with a transparency meter (AKA phototube calorimeter, by KOTAKI Manufacturing) at 25° C. and a relative humidity of 60% to measure its visible light (615 nm) transmittance. The cellulose mixed ester film of the invention preferably has a transmittance of at least 90%, more preferably at least 91%, even more preferably at least 92%.

### (Haze)

A sample of 40 mm×80 mm is analyzed with a haze meter (HGM-2DP, by Suga Test Instruments) at 25° C. and a relative humidity of 60% according to JIS K-6714. The cellulose mixed ester film of the invention preferably has a haze within a range of from 0 to 1.5%, more preferably from 0 to 1.2%, even more preferably from 0 to 0.8%, still more preferably from 0.1 to 0.5%.

From the above viewpoint, it is desirable that the cellulose mixed ester film of the invention has a haze of from 0.1 to 1.2%, a visible light transmittance of at least 91%, an intrinsic birefringence in the in-plane direction in an environment at 25° C. and a relative humidity of 60% at a wavelength of 590 nm of from 0 to 0.001, and an absolute value of a thickness-direction intrinsic birefringence of from 0 to 0.003.

### (Functionalization of Cellulose Mixed Ester Film)

### —Surface Treatment—

Preferred embodiments of functionalization of the cellulose mixed ester film of the invention are described below. A method of surface treatment of the cellulose mixed ester film is first described.

If desired, the cellulose mixed ester film may be surface-treated to thereby improve the adhesiveness of the cellulose mixed ester film to various functional layers (e.g., undercoat layer, back layer). The surface treatment is, for example, glow discharge treatment, UV irradiation treatment, corona treatment, flame treatment, or acid or alkali treatment. The glow discharge treatment as referred to herein may be low-temperature plasma treatment to be effected under a low gas pressure of from 10⁻³ to 20 Torr (about 0.13 to 2666 Pa), or may be glow discharge treatment under atmospheric pressure.

Glow discharge treatment under low pressure is described in U.S. Pat. Nos. 3,462,335, 3,761,299, 4,072,769, and British Patent 891,469. A specific gas such as inert gas, nitrogen oxide, organic compound gas may be introduced. Polymer surface glow discharge treatment may be attained under atmospheric pressure or under reduced pressure. To the atmosphere in glow discharge treatment, various gas such as oxygen, nitrogen, helium or argon, or water may be introduced during the treatment. Preferably, the vacuum degree in glow discharge treatment is from 0.005 to 20 Torr (6.666 to 2666 Pa), more preferably from 0.02 to 2 Torr (2.666 to 266 Pa). The voltage in glow discharge treatment is preferably between 500 and 5000 V, more preferably between 500 and 3000 V. The discharge frequency to be sued may be from direct current to thousands MHz, more preferably from 50 Hz to 20 MHz, even more preferably from 1 KHz to 1 MHz. The discharge intensity is preferably from 0.01 KV·A·min/m² to 5 KV·A·min/m², more preferably from 0.15 KV·A·min/m² to 1 KV·A·min/m².

For the surface treatment of the cellulose mixed ester film of the invention, also preferred is UV irradiation treatment. The mercury lamp to be sued in UV irradiation treatment is preferably a high-pressure mercury lamp of a quartz tube, and the UV wavelength is preferably within a range of from 180 nm to 380 nm. Regarding the method of UV irradiation treatment, a high-pressure mercury lamp having a main wavelength of 365 nm may be used as the light source, so far as the surface temperature of the cellulose mixed ester film could rise up to about 150° C. not interfering with the support property. In case where low-temperature treatment is needed, preferred for it is a low-pressure mercury lamp having a main wavelength of 254 nm. In addition, ozoneless-type high-pressure mercury lamp and low-pressure mercury lamp are also usable. Regarding the quantity of light for the treatment, the adhesiveness between the cellulose mixed ester film and the layer adhering to it may increase when the quantity of light is larger; but with the increase in the quantity of light, there may occur some problems in that the support may discolor and may become brittle. Accordingly, preferred is a high-pressure mercury lamp having a main wavelength of 365 nm, and the quantity of light for irradiation is preferably from 20 to 10000 (mJ/cm²), more preferably from 50 to 2000 (mJ/cm²). In case where a low-pressure mercury lamp having a main wavelength of 254 nm is used, then the quantity of light for irradiation is preferably from 100 to 10000 (mJ/cm²), more preferably from 300 to 1500 (mJ/cm²).

For the surface treatment of the cellulose mixed ester film of the invention, also preferred is corona discharge treatment. The corona discharger for the corona discharge treatment includes Pillar's solid state corona processor, LEPEL-type surface processor, VATEPHON-type processor. The corona discharge treatment may be effected in air under normal pressure. The discharge frequency in treatment may be from 5 to 40 kHz, more preferably from 10 to 30 kHz; and the waveform is preferably sinusoidal current. The gap clearance between the electrode and the dielectric roll is preferably from 0.1 mm to 10 mm, more preferably from 1.0 mm to 2.0 mm. The discharge treatment may be attained above the dielectric support roller disposed in the discharge zone, and the treatment level may be from 0.3 to 0.4 KV·A·min/m², more preferably from 0.34 to 0.38 KV·A·min/m².

Next described is flame treatment, a type of surface treatment. Gas for use in the flame treatment may be any of natural gas, liquefied propane gas or city gas; however, the blend ratio of the gas and air is important.

Preferably, the blend ratio by volume of natural gas/air is from 1/6 to 1/10, more preferably from 1/7 to 1/9. The blend ratio of liquefied propane gas/air may be from 1/14 to 1/22, preferably from 1/16 to 1/19; and that of city gas/air may be from 1/2 to 1/8, preferably from 1/3 to 1/7.

The frame treatment may be effected recommendably to a level of from 1 to 50 Kcal/m², more preferably from 3 to 20 Kcal/m².

Next, concretely described is alkali saponification treatment favorably used for the surface treatment of the cellulose mixed ester film of the invention. Preferably, the surface of a cellulose mixed ester film is dipped in an alkali solution, then neutralized with an acid solution, washed with water and dried, as a cycle of the treatment.

The alkali solution includes a potassium hydroxide solution and a sodium hydroxide solution, in which the hydroxide ion concentration is preferably from 0.1 mol/L to 4.0 mol/L, more preferably from 0.5 mol/L to 3.5 mol/L. Preferably, the liquid temperature of the alkali solution is within a range of from room temperature to 90° C., more preferably from 40° C. to 70° C. The alkali saponification treatment comprises dipping a film in an alkali solution, generally washing it with water, and thereafter leading it to pass through an aqueous acid solution, and washed with water to give a surface-treated cellulose mixed ester film.

In this step, the aqueous acid solution may be an aqueous solution of hydrochloric acid, nitric acid, sulfuric acid, acetic acid, formic acid, chloroacetic acid or oxalic acid, and its concentration is preferably from 0.01 mol/L to 3.0 mol/L, more preferably from 0.05 mol/L to 2.0 mol/L. The alkali saponification time is preferably from 20 to 600 seconds, more preferably from 30 to 300 seconds, even more preferably from 40 to 210 seconds. Preferably, the time for neutralization with an acid solution is from 20 to 600 seconds, more preferably from 30 to 250 seconds, even more preferably from 40 to 180 seconds. Washing with water after neutralization may be effected preferably for a period of from 20 to 400 seconds, more preferably from 30 to 300 seconds, even more preferably from 40 to 210 seconds.

The surface energy of the solid thus obtained according to the method may be measured according to a contact angle method, a wet heat method and an adsorption method as described in “Basis and Application of Wetting” (published by Realize Co., on Dec. 10, 1989); and a contact angle method is preferably used herein. The contact angle to water of the surface of the cellulose mixed ester film of the invention (25° C./relative humidity 60%) is preferably at most 45°, more preferably from 10 to 45°, even more preferably from 10 to 40°, most preferably from 10 to 30°.

### (Adhesive Layer)

For adhering a functional layer to the cellulose mixed ester film of the invention, herein employable are a method of activating the surface of the film and then a functional film is directly applied to the film to obtain the adhesion power; and a method of forming an undercoat layer (adhesive layer) on the film after surface-treating the film in some way or not after surface-treating it, and thereafter applying a functional layer onto it.

Various methods are tried for the constitution of the undercoat layer. For example, there are known a single layer method of forming one layer as the undercoat layer; and a multi-layer method of forming, as the first layer, a well-adhering layer (this may be hereinafter referred to as “first undercoat layer”) on a support (cellulose mixed ester film), and thereafter applying, as the second layer, a second undercoat layer well adhering to a functional layer, onto it.

For the single layer method, often employed is a method of swelling the cellulose mixed ester film and applying an undercoat layer material thereto in a mode of interfacial mixing to thereby attain good adhesiveness between the two. Examples of the undercoat polymer for the undercoat layer are water-soluble polymer, cellulose mixed ester, latex polymer, water-soluble polyester. The water-soluble polymer includes gelatin, gelatin derivative, casein, agar, sodium alginate, starch, polyvinyl alcohol, polyacrylic acid copolymer, maleic anhydride copolymer; and the cellulose mixed ester includes carboxymethyl cellulose, hydroxyethyl cellulose. The latex polymer includes vinyl chloride-containing copolymer, vinylidene chloride-containing copolymer, acrylate-containing copolymer, vinyl acetate-containing copolymer, butadiene-containing copolymer.

For the first undercoat layer in the multi-layer method, for example, usable are copolymers starting from monomers selected from vinyl chloride, vinylidene chloride, butadiene, methacrylic acid, acrylic acid, itaconic acid, maleic anhydride; as well as oligomers and polymers such a polyethyleneimine, epoxy resin, grafted gelatin, nitrocellulose.

For the second undercoat layer, for example, usable are the above-mentioned water-soluble polymer, cellulose mixed ester, latex polymer, water-soluble polyester.

In a preferred embodiment of the cellulose mixed ester film of the invention, the film is provided with a hydrophilic binder layer comprising a hydrophilic binder for adhering to a polarizer. The hydrophilic binder includes, for example, —COOM group-containing vinyl acetate-maleic acid copolymer compound or hydrophilic cellulose derivative (e.g., methyl cellulose, carboxymethyl cellulose, hydroxyalkyl cellulose), polyvinyl alcohol derivative (e.g., vinyl acetate-vinyl alcohol copolymer, polyvinyl acetal, polyvinyl formal, polyvinyl benzal), natural polymer compound (e.g., gelatin, casein, gum arabic), hydrophilic group-containing polyester derivative (e.g., sulfone group-containing polyester copolymer).

The undercoat layer optionally applying to the cellulose mixed ester film of the invention may contain a mat agent of inorganic or organic fine particles, not substantially detracting from the transparency of the functional layer of the film.

As the mat agent of inorganic fine particles, usable are silica (SiO₂), titanium dioxide (TiO₂), calcium carbonate, magnesium carbonate. As the mat agent of organic fine particles, usable are polymethyl methacrylate, cellulose acetate propionate, polystyrene, those soluble in processing liquid as in U.S. Pat. No. 4,142,894, and polymers as in U.S. Pat. No. 4,396,706.

The mean particle size of the particulate mat agent is preferably from 0.01 to 10 μm, more preferably from 0.05 to 5 μm. The content of the agent is preferably from 0.5 to 600 mg/m², more preferably from 1 to 400 mg/m². The undercoat layer may be applied in any ordinary well-known coating method of, for example, a dip coating method, an air knife coating method, a curtain coating method, a roller coating method, a wire bar coating method, a gravure coating method, a slide coating method, or an extrusion coating method of using a hopper as in U.S. Pat. No. 2,681,294.

### (Conductive Layer)

Preferably in the constitution of a protective film for polarizer for which the cellulose mixed ester film of the invention is used, at least one antistatic layer is provided on the film, or a hydrophilic binder layer is provided for adhesion to the polarizer.

First described in the conductive layer. The conductive material to be in the conductive layer is preferably a conductive metal oxide or a conductive polymer. The layer may be a transparent conductive film formed through vapor deposition or sputtering. Preferred examples of the conductive metal oxide are ZnO, TiO₂, SnO₂, Al₂O₃, In₂O₃, SiO₂, MgO, BaO, MoO₂, V₂O₅, and their composite oxides; and more preferred are ZnO, SnO₂ and V₂O₅.

Examples of the hetero atom in the composite oxides are mentioned. Adding Al, In, Ta, Sb, Nb, halogen or Ag is effective; and its amount is preferably within a range of from 0.01 mol % to 25 mol %.

Preferably, the volume resistivity of the conductive metal oxide powder is at most 10⁷ Ω·cm, more preferably at most 10⁵ Ω·cm. Preferably, the primary particle size of the metal oxide powder is from 100 angstroms to 0.2 μm; and preferably, the conductive layer contains the powder having a specific structure of such that the major diameter of the high-order structure of the powder aggregates is from 300 angstroms to 6 μm, in a fraction percentage by volume of from 0.01% to 20%. The amount of the conductive fine particles (metal oxide powder) to be used is preferably from 0.01 to 5.0 g/m², more preferably from 0.005 to 1 g/m².

Not specifically defined, the binder for dispersion of the conductive fine particles may be any one capable of forming a film. For example, it includes proteins such as gelatin, casein; cellulose compounds such as carboxymethyl cellulose, hydroxyethyl cellulose, acetyl cellulose, diacetyl cellulose, triacetyl cellulose; saccharides such as dextran, agar, sodium alginate, starch derivative; and synthetic polymers such as polyvinyl alcohol, polyvinyl acetate, polyacrylate, polymethacrylate, polystyrene, polyacrylamide, poly-N-vinylpyrrolidone, polyester, polyvinyl chloride, polyacrylic acid.

The conductive layer may contain an ion-conductive substance. The ion-conductive substance is a substance showing ionic conductivity and containing an ion that serves as an electricity carrier. Its examples include ionic polymer compounds and electrolyte-containing metal oxide sols. The electric resistance of the conductive layer is preferably at most 10¹²Ω (25° C. and relative humidity of 10%), more preferably at most 10¹⁰Ω, even more preferably at most 10⁹Ω. As the conductive material, also preferred are organic electron-conductive materials, for example, polyaniline derivatives, polythiophene derivatives, polypyrrole derivatives, polyacetylene derivatives.

### (Surfactant)

A surfactant is preferably used in forming the functional layer of the cellulose mixed ester film of the invention. The surfactant for use in forming the functional layer in the invention may be grouped into dispersant, coating agent, wetting agent, antistatic agent, depending on its use and object. Suitably using the surfactant mentioned below may attain the object. The surfactant for use in the invention may be any of nonionic and ionic (anionic, cationic, betaine) surfactants. In addition, a fluorine-containing low-molecular surfactant is also preferably used as a coating agent in an organic solvent or as an antistatic agent. The layer in which the surfactant may be used may be a film of a cellulose mixed ester or any other functional layer. For optical use, examples of the functional layer are an undercoat layer, an interlayer, an alignment control layer, a refractivity control layer, a protective layer, an antiglare layer, an adhesive layer, a back undercoat layer, a back layer. Not specifically defined, the amount to be used may be any one capable of attaining the object. In general, the amount is preferably from 0.0001 to 5% by mass of the overall mass of the layer to which it is added, more preferably from 0.0005 to 2% by mass. The coating amount of the surfactant in the case is preferably from 0.02 to 1000 mg/m², more preferably from 0.05 to 200 mg/m².

### (Lubricant Layer)

A lubricant may be added to any layer to be formed on the cellulose mixed ester film. Especially preferably, it is added to the outermost layer. As the lubricant to be used herein, for example, known are polyorganosiloxanes as disclosed in JP-B-53-292, higher fatty acid amides as disclosed in U.S. Pat. No. 4,275,146, higher fatty acid esters (esters of fatty acids having from 10 to 24 carbon atoms and alcohols having from 10 to 24 carbon atoms) as disclosed in JP-B-58-33541, British Patent 927,446, JP-A-55-126238, JP-A-58-90633, metal salts of higher fatty acids as disclosed in U.S. Pat. No. 3,933,516, esters of linear higher fatty acids and linear higher alcohols as disclosed in JP-A-A-58-50534, and alkyl group-containing higher fatty acid-higher alcohol esters as disclosed in WO90/108115.8.

Of those, polyorganosiloxanes may be generally-known polyalkylsiloxanes such as polydimethylsiloxane, polydiethylsiloxane, or polyarylsiloxanes such as polydiphenylsiloxane, polymethylphenylsiloxane; as well as modified polysiloxanes, such as organopolysiloxanes having an alkyl group with at least 5 carbon atoms, alkylpolysiloxanes having a polyoxyalkylene, group in the side branch, organopolysiloxanes having alkoxy, hydroxy, hydrogen, carboxyl, amino or mercapto group in the side branch, as shown in JP-B-53-292, JP-B-55-49294 and JP-B-60-140341. In addition, block copolymers having a siloxane unit, and graft copolymers having a siloxane unit in the side chain, as shown in JP-A-60-191240, are also usable. In forming the lubricant layer, the lubricant may be used along with a film-forming binder. The polymer may be any known hydrophilic binder such as thermoplastic resin, thermosetting resin, radiation-curable resin, reactive resin and their mixture, and gelatin. Regarding its lubricating capability, the layer preferably has a static friction coefficient of at most 0.25. This is measured as follows: A sample is conditioned at a temperature of 25° C. and a relative humidity of 60% for 2 hours, and then measured with a static friction coefficient meter, HEIDON-10, using a 5 mmφ stainless steel ball. When the value is smaller, then the sample has better lubricity.

### (Mat Agent in Functional Layer)

In the functional layer of the cellulose mixed ester film of the invention, preferably used is a mat agent for improving the lubricity of the film and for improving the blocking resistance thereof at high humidity. In this case, the mean height of the projections of the film surface is preferably from 0.005 to 10 μm, more preferably from 0.01 to 5 μm. The number of the projections is preferably larger; however, if it is too large, then the haze of the film may increase. Preferred projections may have any form, for example, they may be spherical or formless so far as the mean height of the projections falls within the above range. In case where the projections are formed of the above-mentioned mat agent, then the content of the agent may be from 0.5 to 600 mg/m², more preferably from 1 to 400 mg/m². In this case, the composition of the mat agent to be used is not specifically defined, and the agent may be an inorganic substance or an organic substance, or may also be a mixture of two or more types of them.

The mat agent may be any of an inorganic compound or an organic compound, including, for example, inorganic fine powder such as barium sulfate, manganese colloid, titanium dioxide, strontium barium sulfate, silicon dioxide; silicon dioxide such as synthetic silica obtained in a wet method or through gellation of silicic acid; titanium dioxide (rutile-type or anatase-type) formed from titanium slag and sulfuric acid. The mat agent may also be obtained by grinding an inorganic substance having a relatively large particle size of, for example, at least 20 μm, and then classifying it (shaking filtration, pneumatic classification).

In addition to the above, the mat agent also includes a ground and classified substance of an organic polymer compound such as polytetrafluoroethylene, cellulose acetate, polystyrene, polymethyl methacrylate, polypropyl methacrylate, polymethyl acrylate, polyethylene carbonate, starch. Further, also employable are a polymer compound produced through suspension polymerization or a spherical polymer compound or inorganic compound produced according to a spray drying method or a dispersion method.

### (Other Functional Layers)

A transparent hard coat layer may be formed on the cellulose mixed ester film of the invention. The transparent hard coat layer is preferably an active ray-curable resin layer or a thermosetting resin layer. The active ray-curable resin layer is a layer that comprises, as the essential ingredient thereof, a resin capable of crosslinkable and curable through irradiation with active rays such as UV rays or electron rays (active ray-curable resin). The active ray-curable resin typically includes an UV-curable resin and an electron ray-curable resin, and in addition, it may be a resin curable through irradiation with any other active ray than UV ray or electron ray. The UV-curable resin includes, for example, UV-curable acrylurethane resin, UV-curable polyester acrylate resin, UV-curable epoxyacrylate resin. UV-curable polyol acrylate resin, UV-curable epoxy resin. JP-A-2003-039014 describes an invention, which comprises winding a coated film or drying it while holding in the transverse direction, and curing the coating liquid that contains an active ray-curable substance to thereby obtain a film having good surface smoothness, and the invention is applicable to the present invention.

An anti-reflection film may be formed on the cellulose mixed ester film of the invention, thereby producing an anti-reflection film. As the constitution of the anti-reflection layer, known are various structures such as a single-layer structure and a multi-layer structure. The multi-layer structure generally comprises a high refractivity layer and a low refractivity layer that are alternately laminated. Examples of the constitution are a two-layer constitution of high refractivity layer/low refractivity layer in that order from the side of a transparent support; and a three-layer constitution comprising three layers of different refractivity as laminated in an order of middle refractivity layer (having a refractivity higher than that of a transparent support or a hard coat layer, but lower than that of a high refractivity layer)/high refractivity layer/low refractivity layer. Further proposed is a laminate of more anti-reflections layers. Above all, preferred is a constitution of high refractivity layer/middle refractivity layer/low refractivity layer formed in that order on a hard coat layer-having substrate, from the viewpoint of the durability, the optical characteristics, the cost and the producibility thereof.

An antiglare layer may be formed on the cellulose mixed ester film of the invention. The antiglare layer may be designed to have surface roughness, in which, therefore light may be scattered on the surface or in the inside of the antiglare layer so that the antiglare layer may express its function. Accordingly, the layer is so designed that it contains a fine particulate substance therein. Preferred embodiments of the constitution of the layer are mentioned below. Preferably, the antiglare layer has a thickness of from 0.5 to 5.0 μm, and contains at least one type of fine particles having a mean particle size of from 0.25 to 10 μm. For example, the antiglare layer is a layer that contains silicon dioxide particles having a mean particle size of from 1.1 to 2 times the thickness of the layer, and silicon dioxide fine particles having a mean particle size of from 0.005 μm to 0.1 μm, for example, in a binder such as diacetyl cellulose, and the layer may thereby exhibit its antiglare function. The “particles” include inorganic particles and organic particles.

The cellulose mixed ester film of the invention may be processed for curling prevention. The curling prevention treatment is for processing the film so at to have a function of curling with the processed surface thereof facing inside. As a result of the curling prevention treatment given thereto, the transparent resin film could be such that, when one surface of the film is subjected to some other surface treatment thereby to make the two faces of the film given different types of surface treatment to a different degree, then the film is prevented from curling with the surface-processed face thereof facing inside. In one embodiment, the curling preventive layer may be formed on the opposite side of the support to the side thereof coated with an antiglare layer or an anti-reflection layer; or in another embodiment, an adhesive layer may be formed on one surface of a transparent resin film. In still another embodiment, a curling preventing layer may be formed on the opposite side of the film.

### <<Use of Cellulose Mixed Ester Film of the Invention>>

Preferably, the cellulose mixed ester film of the invention is combined with any of the functional layers described in detail in Hatsumei Kyokai Disclosure Bulletin (No. 2001-1745, published by the Hatsumei Kyokai on Mar. 15, 2001), pp. 32-45. Above all, preferred are impartation of a polarizer, impartation of an optical compensatory layer (optical compensatory sheet), impartation of an anti-reflection layer (anti-reflection film).

### (1) Impartation of Polarizer (Construction of Polarizing Plate):

At present, one general method of producing commercially-available polarizers comprises dipping a stretched polymer in a solution containing iodine or dichroic dye in a bath to thereby infiltrate iodine or dichroic dye into the binder. Iodine and dichroic dye in the polarizer are aligned in the binder and express the polarization property. Preferably, the dichroic dye has a hydrophilic substituent (e.g., sulfo, amino, hydroxyl). For example, the compounds described in Hatsumei Kyokai Disclosure Bulletin (No. 2001-1745, published on Mar. 15, 2001 by the Hatsumei Kyokai), p. 58 may be used.

For the binder for the polarizer, usable are a polymer that is crosslinkable by itself, and a polymer that is crosslinkable with a crosslinking agent. These polymers may be combined for use herein. For the binder, for example, preferred are water-soluble polymers (e.g., poly(N-methylolacrylamide), carboxymethyl cellulose, gelatin, polyvinyl alcohol, modified polyvinyl alcohol); more preferred are gelatin, polyvinyl alcohol and modified polyvinyl alcohol; most preferred are polyvinyl alcohol and modified polyvinyl alcohol. Modified polyvinyl alcohol is described in JP-A-8-338913, JP-A-9-152509, JP-A-9-316127. Preferably, the binder thickness is from 1 μm to 50 μm, more preferably from 2 mm to 50 μm, even more preferably from 5 mm to 30 μm. The binder in the polarizer may be crosslinked. A crosslinking boron compound (e.g., boric acid, borax) may be used as the crosslinking agent. The amount of the crosslinking agent to the binder is preferably from 0.1 to 20% by mass of the binder.

Preferably, the polarizer is colored with iodine or dichroic dye, after stretched (according to a stretching method), or rubbed (according to a rubbing method).

In the stretching method, the draw ratio is preferably from 2.5 to 30.0 times, more preferably from 3.0 to 10.0 times. The stretching may be attained according to a parallel stretching method or a method of stretching in the oblique direction by the use of a tenter stretched in the oblique direction as in JP-A-2002-86554. The saponified cellulose mixed ester film is laminated with the thus-stretched, polarizer thereby constructing a polarizing plate. The direction in which the polarizer is stuck to the cellulose mixed ester film is preferably such that the casting axial direction of the ester film could be at 45° to the stretching axial direction of the polarizer.

The adhesive to be used in laminating the polarizer and the cellulose mixed ester film is not specifically defined. For example, it includes PVA resin (including modified PVA with acetoacetyl group, sulfonic acid group, carboxyl group or oxyalkylene group), and aqueous boron compound solution. Of those, preferred is PVA resin. After dried, the thickness of the adhesive layer is preferably from 0.01 μm to 10 μm, more preferably from 0.05 μm to 5 μm.

### (2) Impartation of Optical Compensatory Layer (Construction of Optical Compensatory Sheet):

An optically anisotropic layer is for compensating the liquid crystal compound in a liquid crystal cell at the time of black level of a liquid crystal display device, and the optical compensatory sheet may be produced by forming an alignment layer on a cellulose mixed ester film and further imparting thereto an optically anisotropic layer. An alignment layer is formed on the above-mentioned, surface-treated cellulose mixed ester film. The film has a function of defining the direction in which liquid crystalline molecules are aligned. However, in case where the alignment state of liquid crystalline molecules is fixed after they are aligned, the alignment is useless for its role, and therefore it is not always an indispensable constitutive element in the invention. Specifically, only the optically anisotropic layer on an alignment layer of which the alignment state is fixed may be transferred onto a polarizer, with which the polarizing plate of the invention may be constructed. The alignment layer may be formed, for example, through rubbing treatment of an organic compound (preferably polymer), oblique vapor deposition of an inorganic compound, formation of a microgrooved layer, or accumulation of an organic compound (e.g., ω-tricosanoic acid, dioctadecylmethylammonium chloride, methyl stearate) according to a Langmuir-Blodgett's method (LB film). Further, there are known other alignment layers that may have an alignment function through impartation of an electric field or magnetic field thereto or through light irradiation thereto.

For forming the alignment layer, preferably employed is a spin-coating method, a dip-coating method, a curtain-coating method, an extrusion-coating method, a rod-coating method or a roll-coating method. Especially preferred is a rod-coating method. Also preferably, the thickness of the film is from 0.1 to 10 μm, after dried. The drying under heat may be effected at 20 to 110° C. For sufficient crosslinking, the heating temperature is preferably from 60 to 100° C., more preferably from 80 to 100° C. The drying time may be from 1 minute to 36 hours, but preferably from 1 to 30 minutes. The pH of the coating solution is preferably so defined that it is the best for the crosslinking agent used. For example, when glutaraldehyde is used, the pH of the coating solution is preferably from 4.5 to 5.5, more preferably pH 5. Thus formed, the thickness of the alignment layer is preferably within a range of from 0.1 to 10 μm.

Next, the liquid crystalline molecules in the optically anisotropic layer on the alignment layer are aligned. Then, if desired, the alignment layer polymer may be reacted with the polyfunctional monomer contained in the optically anisotropic layer, or the alignment layer polymer may be crosslinked with a crosslinking agent.

The liquid crystalline molecules to be in the optically anisotropic layer include rod-shaped liquid crystalline molecules and discotic liquid crystalline molecules. The rod-shaped liquid crystalline molecules and the discotic liquid crystalline molecules may be polymer liquid crystals or low-molecular liquid crystals, further including crosslinked low-molecular liquid crystals no more having liquid crystallinity.

### —Rod-Shaped Liquid Crystalline Molecules—

The rod-shaped liquid crystalline molecules may bond to a (liquid crystal) polymer.

The rod-shaped liquid crystalline molecules are described in Quarterly Journal of General Chemistry, Vol. 22, Liquid Crystal Chemistry (1994), Chaps. 4, 7 and 11, edited by the Chemical Society of Japan; Liquid Crystal Devices Handbook, edited by the 142nd Committee of the Nippon Academic Promotion, Chap. 3.

Preferably, the rod-shaped liquid crystalline molecules have a birefringence falling within a range of from 0.001 to 0.7. Preferably, the rod-shaped liquid crystalline molecules have a polymerizing group for fixing their alignment state. The polymerizing group is preferably a radical-polymerizing unsaturated group or a cationic polymerizing group. Concretely, for example, there are mentioned the polymerizing groups and the polymerizing liquid crystal compounds described in JP-A-2002-62427, paragraphs [0064] to [0086].

—Discotic Liquid crystalline Molecules—

The discotic liquid crystalline molecules include liquid crystalline compounds in which the molecular center nucleus is radially substituted with side branches of a linear alkyl, alkoxy or substituted benzoyloxy group. Preferably, the molecules or the molecular aggregates of the compounds are rotary-symmetrical and may undergo certain alignment. It is not always necessary that, in the optically anisotropic layer formed of such discotic liquid crystalline molecules, the compounds that are finally in the optically anisotropic layer are discotic liquid crystalline molecules. For example, low-molecular discotic liquid crystalline molecules may have a group capable of being reactive when exposed to heat or light, and as a result, they may polymerize or crosslink through thermal or optical reaction to give high-molecular compounds with no liquid crystallinity.

Preferred examples of the discotic liquid crystalline molecules are described in JP-A-8-50206. Polymerization of discotic liquid crystalline molecules is described in JP-A-8-27284. For fixing the discotic liquid crystalline molecules through polymerization, the discotic core of the discotic liquid crystalline molecules must be substituted with a polymerizing group. Preferably, the polymerizing group bonds to the discotic core via a linking group. Accordingly, the compounds of the type may keep their alignment state even after their polymerization. For example, there are mentioned the compounds described in JP-A-2000-155216, paragraphs [0151] to [0168].

### —Other Compositions of Optically Anisotropic Layer—

Along with the above-mentioned liquid crystalline molecules, a plasticizer, a surfactant, a polymerizing monomer and others may be added to the optically anisotropic layer for improving the uniformity of the coating film, the strength of the film and the alignment of the liquid crystalline molecules in the film. Preferably, the additives have good compatibility with the liquid crystalline molecules and may have some influence on the tilt angle change of the liquid crystalline molecules, not interfering with the alignment of the molecules.

### —Formation of Optically Anisotropic Layer—

The optically anisotropic layer may be formed by applying a coating solution that contains liquid crystalline molecules and optionally a polymerization initiator and other optional components mentioned below, on the alignment layer. The thickness of the optically anisotropic layer is preferably from 0.1 to 20 μm, more preferably from 0.5 to 15 μm, most preferably from 1 to 10 μm. The aligned liquid crystalline molecules may be fixed as they are in an alignment state. Preferably, the fixation is effected through polymerization. The polymerization includes thermal polymerization with a thermal polymerization initiator and optical polymerization with an optical polymerization initiator. Preferred is optical polymerization.

Preferably, the optical compensatory film may be combined with the above-mentioned polarizer. Concretely, the above-mentioned optically anisotropic layer-coating solution is applied onto the surface of a polarizer to from an optically anisotropic layer thereon. As a result, no polymer film exists between the polarizer and the optically anisotropic layer, and a thin polarizing plate is thus constructed of which the stress (strain×cross section×elasticity) to be caused by the dimensional change of the polarizer is reduced. When the polarizing plate of the invention is fitted to large-size liquid crystal display devices, then it does not produce a problem of light leakage and the devices can display high-quality images. Preferably, the polarizer and the optical compensatory layer are so stretched that the tilt angle between the two may correspond to the angle formed by the transmission axis of the two polarizing plates to be stuck to both sides of the liquid crystal cell to constitute LCD, and the machine direction or the transverse direction of the liquid crystal cell. In general, the tilt angle is 45°. Recently, however, some devices in which the tile angle is not always 45° have been developed for transmission-type, reflection-type or semi-transmission-type LCDs, and it is desirable that the stretching direction is varied in any desired manner depending on the plan of LCDs.

### (Use in Liquid Crystal Display Device)

### —Constitution of Ordinary Liquid Crystal Display Device—

The cellulose mixed ester film of the invention may be used in various applications. The cellulose mixed ester film of the invention may be effectively used as an optical compensatory sheet in liquid crystal display devices. In case where the film is used for the optical compensatory sheet as it is, then the film is preferably so disposed that the transmission axis of the polarizing plate (mentioned below) could be substantially parallel or perpendicular to the slow axis of the optical compensatory sheet of the cellulose mixed ester film. The configuration of the polarizing plate and the optical compensatory sheet is described in JP-A-10-48420. A liquid crystal display device has a constitution that comprises a liquid crystal cell having a liquid crystal sandwiched between two electrode substrates, two polarizing plates disposed on both sides thereof, and at least one optical compensatory sheet disposed between the liquid crystal cell and the polarizing plates.

In general, the liquid crystal layer of the liquid crystal cell is formed by sealing up a liquid crystal in the space formed by putting a spacer between two substrates. A transparent electrode layer is formed on the substrate as a transparent film that contains a conductive substance. The liquid crystal cell may further has a gas barrier layer, a hard coat layer or an undercoat layer (for adhesion to transparent electrode layer). In general, these layers are formed on the substrate. The substrate of the liquid crystal cell generally has a thickness of from 80 μm to 500 μm.

The optical compensatory sheet is a birefringent film for removing coloration from liquid crystal panel. The cellulose mixed ester film of the invention may be used as the optical compensatory film by itself. Further, the cellulose mixed ester film may be functionalized to be an anti-reflection layer, an antiglare layer, a λ/4 layer or a biaxially-stretched film. For improving the viewing angle characteristic of a liquid crystal display device, a film having an opposite birefringence to the cellulose mixed ester film of the invention (in point of the positivity/negativity relation) may be laminated on the ester film to construct an optical compensatory sheet for use herein. The preferred thickness range of the optical compensatory sheet may be the same as that of the above-mentioned cellulose mixed ester film of the invention.

The polarizer of the polarizing plates includes an iodine-base polarizer, a dichroic dye-containing dye-base polarizer, and a polyene-base polarizer. Any of these polarizers may be produced generally by the use of a polyvinyl alcohol film. Preferably, the protective film of the polarizing plate has a thickness of from 25 μm to 350 μm, more preferably from 40 μm to 200 μm. The liquid crystal display device may have a surface treatment film. The function of the surface treatment film includes hard coating, antifogging treatment, antiglare treatment, and anti-reflection treatment.

As so mentioned hereinabove, proposed is an optical compensatory sheet having, on the support thereof, an optically anisotropic layer that contains a liquid crystal (especially discotic liquid crystalline molecules) (JP-A-3-9325, JP-A-6-148429, JP-A-8-50206, JP-A-9-26572). The cellulose mixed ester film of the invention may be used as the support for such optical compensatory sheet.

### —Optically Anisotropic Layer Containing Discotic Liquid Crystalline Molecules—

The optically anisotropic layer is preferably a layer that contains obliquely-aligned discotic liquid crystalline molecules. Preferably, the angle formed by the disc plane of the discotic liquid crystalline molecule and the support face changes in the depth direction of the optically anisotropic layer (as hybrid alignment). The optical axis of the discotic liquid crystalline molecule exists in the normal direction of the disc face thereof. The discotic liquid crystalline molecule has a birefringence of such that the refractivity in the disc face direction is larger than the refractivity in the normal direction of the disc face. The discotic liquid crystalline molecules may be aligned substantially parallel to the support surface.

### (VA-Mode Liquid Crystal Display Device)

The cellulose mixed ester film of the invention may be used as the support of the optical compensatory film in a VA-mode liquid crystal display device having a VA-mode liquid crystal cell. The optical compensatory sheet for use in a VA-mode liquid crystal display device is preferably such that the direction in which the absolute value of the retardation of the sheet is the smallest does not exist both in the in-plane direction and in the normal direction of the optical compensatory sheet. The optical properties of the optical compensatory sheet to be used in the VA-mode liquid crystal display device are determined depending on the optical properties of the optically anisotropic layer, the optical properties of the support and the configuration of the optically anisotropic layer and the support.

In case where two optical compensatory sheets are used in the VA-mode liquid crystal display device, it is desirable that the in-plane retardation of the optical compensatory sheets falls within a range of from −5 nm to 5 nm. Accordingly, it is desirable that the absolute value of the in-plane retardation of the two optical compensatory sheets is from 0 to 5.

In case where one optical compensatory sheet is used in the VA-mode liquid crystal display device, it is desirable that the in-plane retardation of the optical compensatory sheet is within a range of from −10 nm to 10 nm. The cellulose mixed ester film of the invention is desirably so designed that its optical characteristics may satisfy various VA-mode cells, falling within the above optical characteristic ranges. The range depends on the cell gap. One-sheet type cellulose mixed ester film preferably has Re of from 40 to 120 nm, more preferably from 50 to 100 nm, even more preferably from 50 to 90 nm, and has Rth of preferably from 160 to 300 nm, more preferably from 170 to 260 nm, even more preferably from 180 to 240 nm. In case where two optical compensatory sheets are sued in the VA-mode liquid crystal display device, the cellulose mixed ester film of the invention may be so designed as to have the optical characteristics necessary for various VA-mode cells. The range depends on the cell gap. Two-sheet type cellulose mixed ester film preferably has Re of from 20 to 80 nm, more preferably from 30 to 70 nm, even more preferably from 30 to 60 nm, and has Rth of preferably from 80 to 200 nm, more preferably from 90 to 180 nm, even more preferably from 95 to 165 nm.

(OCB-Mode Liquid crystal Display Device and HAN-Mode Liquid Crystal Display Device)

The cellulose mixed ester film of the invention is advantageously used as a support of the optical compensatory film in an OCB-mode liquid crystal cell-having OCB-mode liquid crystal display device or in a HAN-mode liquid crystal cell-having HAN-mode liquid crystal display device. It is desirable that, in the optical compensatory film in an OCB-mode liquid crystal display device and in a HAN-mode liquid crystal display device, the direction in which the absolute value of the retardation of the film is the smallest is neither the in-plane direction nor the normal direction of the optical compensatory film. The optical properties of the optical compensatory film for use in the OCB-mode liquid crystal display device or in the HAN-mode liquid crystal display device depend on the optical properties of the optically anisotropic layer, the optical properties of the support and the configuration of the optically anisotropic layer and the support of the film. The cellulose mixed ester film of the invention is desirably so designed that its optical characteristics may satisfy various OCB-mode liquid crystal cells. Regarding the range, Re is preferably from 20 nm to 100 nm, more preferably from 30 nm to 80 nm, even more preferably from 30 nm to 60 nm; and Rth is preferably from 150 nm to 300 nm, more preferably from 160 nm to 260 nm, even more preferably from 170 nm to 250 nm.

### (Other Liquid Crystal Display Devices)

The cellulose mixed ester film of the invention may be advantageously used as a support of the optical compensatory sheet in an ASM (axially symmetrically aligned microcell)-mode liquid crystal cell-having. ASM-mode liquid crystal display device. The ASM-mode liquid crystal cell is characterized in that the cell thickness is held by a position-controllable resin spacer. The other properties of the cell are the same as those of the TN-mode liquid crystal cell. ASM-mode liquid crystal cells and ASM-mode liquid crystal display devices are described in Kume et al's report (Kume et al., SID 98 Digest 1089 (1998)). The cellulose mixed ester film of the invention may be used as a support of the optical compensatory film in a TN-mode liquid crystal display device having a TN-mode liquid crystal cell. TN-mode liquid crystal cells and TN-mode liquid crystal display devices are well known from the past. The optical compensatory film for use in TN-mode liquid crystal display devices is described in JP-A-3-9325, JP-A-6-148429, JP-A-8-50206 and JP-A-9-26572. For use as the optical compensatory sheet in such various liquid crystal display devices, the cellulose mixed ester film of the invention may be processed to have desired optical characteristics.

### <<Measurement Method and Evaluation Method>>

Measurement methods and evaluation methods for cellulose mixed ester film are described below. Additional characteristics evaluation methods are separately described below.

### (Re and Rth, and Humidity-Dependent Re and Rth Fluctuation)

A cellulose mixed ester film is conditioned at 25° C. and a relative humidity of 60% for 24 hours. Then, using an automatic birefringence meter (KOBRA-21ADH, by Oji Scientific Instruments), the sample is analyzed at 25° C. and a relative humidity of 60%, as follows: The vertical direction to the film surface and the slow axis of the film are taken as a rotation axis, and light having a wavelength of 590 nm is applied to the film in different inclination directions relative to the normal direction of the film, at intervals of 10 degrees between +50° and −50° from the normal direction, and different points of the film are analyzed to determine the retardation data. From these, the in-plane retardation (Re) and the thickness-direction retardation (Rth) are calculated. Unless otherwise specifically indicated, Re and Rth are the data measured in this manner.

Then, at 25° C. and a relative humidity of 10%, the sample is analyzed in the same manner as above to determine its Re (relative humidity 10%) and Rth (relative humidity 10%). Further, at 25° C. and a relative humidity of 80%, the sample is analyzed in the same manner to determine its Re (relative humidity 80%) and Rth (relative humidity 80%). The sample is thus analyzed for its moisture-dependent Re fluctuation and moisture-dependent Rth fluctuation, according to the following formulae:

Moisture-dependent Re fluctuation (%/relative humidity %)=[100×{absolute value of the difference between (Re (relative humidity 80%) and Re (relative humidity 10%)}/Re (relative humidity 60%)]/70.

Moisture-dependent Rth fluctuation (%/relative humidity %)=[100×{absolute value of the difference between (Rth (relative humidity 80%) and Rth (relative humidity 10%)}/Rth (relative humidity 60%)]/70.

### (Re Fluctuation, Rth Fluctuation, Thickness Fluctuation)

The film to be tested is sampled in the machine direction at intervals of 1 m, giving 100 MD-samples of 1 cm×1 cm each. On the other hand, the film is sampled in the overall transverse direction at regular intervals of 5 cm, giving TD samples of 1 cm×1 cm each. The difference between the maximum value and the minimum value of these samples is divided by the mean value of the data, and it is expressed as percentage. This indicates the Re fluctuation and Rth fluctuation of the film. The thickness fluctuation is determined as follows: The difference between the maximum value and the minimum value of the MD samples and TD samples is divided by the mean value of the data, and it is expressed as percentage to indicate the thickness fluctuation.

### (Substitution Degree of Cellulose Mixed Ester)

The substitution degree of the hydroxyl group in cellulose with acetyl group is determined through ¹³C-NMR according to the method described in Carbohydr. Res. 273 (1995) 83-91 (by Tezuka, et al.).

### (Degree of Polymerization of Cellulose Mixed Ester)

About 0.2 g of an absolutely-dried cellulose mixed ester is weighed accurately, and dissolved in 100 ml of a mixed solvent of methylene chloride/ethanol=9/1 (by mass). Using an Ostwald viscometer, the time taken by the dropping sample is counted at 25° C., and the degree of polymerization of the sample is computed according to the following formulae:

ηᵣₑₗ=T/T₀

[η]=ln(ηᵣₑₗ)/C

DP=[η]/Km

[In the formulae, T means the time taken by the dropping sample (sec); To means the time taken by the dropping solvent alone; ln means a natural logarithmic number; C means a concentration (g/L); Km is 6×10⁻⁴.]

### (Haze)

Using a haze meter (HGM-2DP, by Suga Test Instruments), a sample of 40 mm×80 mm is analyzed at 25° C. and a relative humidity of 60% according to JIS K-6714.

### (Transparency)

A sample of 20 mm×70 mm is analyzed with a transparency meter (AKA phototube calorimeter, by KOTAKI Manufacturing) at 25° C. and a relative humidity of 60% to measure its visible light (615 nm) transmittance.

### (Axial Shifting)

Using an automatic birefringence meter (KOBRA-21ADH, by Oji Scientific Instruments), a sample of 70 mm×100 mm is analyzed to measure the axial shift angle thereof. 20 samples taken in the overall transverse direction at regular intervals, and their data are averaged as absolute value. The range for the slow axis angle (axial shifting) is as follows: 20 samples are taken in the overall transverse direction at regular intervals, and analyzed; then 4 samples having a larger axial shifting absolute value and 4 samples having a smaller axial shifting absolute value are picked up. The difference between the mean value of the former 4 samples and the mean value of the latter 4 samples is computed, and this indicates the axial shifting.

### (Friction Value)

A sample of 100 mm×200 mm and a sample of 75 mm×100 mm are conditioned under a condition of 25° C. and a relative humidity of 60% for 2 hours. Using a Tensilon tensile tester (RTA-100, by Orientec), the large film is put on a sample bed and fixed thereon, and the small film having a weight of 200 g is put onto it. Next, the weight is pulled in the horizontal direction, and at the time when the weight has begun to move, the force of the moving weight is measured. The static friction coefficient and the dynamic friction coefficient are computed, from which the static friction value and the dynamic friction value are derived.

F=μ×W (μ: friction coefficient, W: weight (kgf)).

### (Scratching)

The film analyzed for its friction value is visually observed, and evaluated according to the following:

A: No scratch found.
B: Some but slight scratch found.
C: Some detectable scratch found.
D: Remarkable scratch found.

### (Alkali Hydrolyzability)

Using an automatic alkali saponification processor (by Shinto Scientific), a sample of 100 mm×100 mm is saponified in an aqueous sodium hydroxide solution (2 mol/L) at 60° C. for 3 minutes, then washed with water for 4 minutes, neutralized with dilute nitric acid (0.01 mol/L) at 30° C. for 4 minutes, and then washed with water for 4 minutes. Next, this is dried at 100° C. for 3 minutes, and then spontaneously dried for 1 hour, and its alkali hydrolyzability is evaluated according to the following visual evaluation standard and the haze value before and after the saponification treatment (25° C., relative humidity 60%).

A: Not whitened at all.
B: Slightly whitened.
C: Much whitened.
D: Extremely whitened.

### (Curl Value)

In a curling conditioning chamber (HEIDON No. YB53-168, by Shinto Scientific), a sample of 35 mm×3 mm is conditioned at a relative humidity of 25%, 55% or 85% for 24 hours, and the radius of curvature of the sample is measured with a curl plate. The wet curl thereof, the sample is statically kept in water at 25° C. for 30 minutes, and its curl value is measured.

### (Water Content)

Using a water content meter and a sample drier (CA-03, VA-05, both by Mitsubishi Chemical), a sample of 7 mm×35 mm is analyzed according to a Karl-Fischer method. The amount of water (g) is divided by the sample mass (g) to obtain the water content.

### (Remaining Solvent Amount)

According to gas chromatography (GC-18A, by Shimadzu), a sample of 7 mm×35 mm is analyzed for its base remaining solvent amount.

### (Thermal Shrinkage)

A sample of 30 mm×120 mm is aged at 90° C. and a relative humidity of 5% for 24 hours and 120 hours, and this is punched to have a hole of 6 mmφ at both edges at intervals of 100 mm. The dimension of the original distance (L1) is measured to a level of minimum gauze, 1/1000 mm. Then, the sample is heated at 90° C. and a relative humidity of 5% for 24 hours and 120 hours, and the dimension of the punch distance (L2) is measured. The thermal shrinkage is obtained as {(L1−L2)/L1}×100.

### (Moisture Transmittance, Moisture Transmittance Coefficient)

A sample of 70 mmφ is conditioned at 25° C. and a relative humidity of 90% and at 40° C. and a relative humidity of 90% for 24 hours. Using a moisture transmission tester (KK-709007, by Toyo Seiki), the water content per unit area (g/m²) of the sample is computed according to JIS Z-0208. The moisture transmittance is obtained as (mass after wet conditioning)−(mass before wet conditioning). As forced evaluation, the sample is conditioned at 60° C. and a relative humidity of 95% for 24 hours, and analyzed to determine its moisture transmittance coefficient.

### (Impurity Detection)

Reflected light is applied to the range of overall width×1 m of a sample, and this is visually checked for impurities existing therein. Next, this is observed with a polarization microscope to detect impurities (lint).

### (Elasticity)

Using a universal tensile tester STM T50BP by Toyo Baldwin, a sample is pulled in an atmosphere at 23° C. and a relative humidity of 70%, at a pulling rate of 10%/min, and its stress in 0.5% elongation is measured, from which is obtained the elasticity of the sample.

### (Measurement of Bright Impurities)

Two polarizing plate are disposed in a cross-Nicol condition to block transmitting light, and a sample is put between the two polarizing plate. The polarizing plates are glass-protected plates. Light is applied to one side, and the number of brightening points is counted on the opposite side in accordance with the diameter thereof per 1 cm², using an optical microscope (50-power).

### (Measurement of Tg)

20 mg of a sample is put into a sample pan of DSC. This is heated from 30° C. up to 250° C. at 10° C./min in a nitrogen atmosphere, and then cooled down to 30° C. at −10° C./min. Next, this is again heated from 30° C. up to 250° C., and the temperature at which the base line begins to shift from the low temperature side is read, and this is Tg of the sample.

### EXAMPLES

The characteristics of the invention are described more concretely with reference to the following Examples and Comparative Examples. In the following Examples, the material used, its amount and the ratio, the details of the treatment and the treatment process may be suitably modified or changed not overstepping the sprit and the scope of the invention. Accordingly, the invention should not be limitatively interpreted by the Examples mentioned below.

### Example 1

### (1-1) Formation of Cellulose Mixed Ester Film

### (1) Preparation of Cellulose Mixed Ester Pellets:

As a cellulose mixed ester, used was cellulose mixed ester A (powder having an acetyl substitution degree of 1.00, a propionyl substitution degree of 1.90, a total substitution degree of 2.90, a viscosity-average degree of polymerization of 180, a water content of 0.1% by mass, a viscosity in 6 mas. % dichloromethane solution of 140 mPa·s, a mean particle size of 1.4 mm and a standard deviation of 0.4 mm). The cellulose mixed ester A had a remaining acetic acid amount of 0.05% by mass, a remaining propionic acid amount of 0.03% by mass, a Ca content of 51 ppm, an Mg content of 15 ppm, an Fe content of 0.45 ppm, and a sulfur content, as sulfate group of 0.16 ppm.

The ester A had a 6-acetyl substitution degree of 0.31 and a 6-propionyl substitution degree of 0.66, and this was 33.5% of all acetyl. It had a ratio of mass-average molecular weight/number-average molecular weight of 2.7. The cellulose mixed ester A was cast on a glass plate, using methylene chloride/methanol=90/10 (by mass) and according to solution casting film formation, thereby obtaining a film having a thickness of 80 μm. The yellow index of the film of the cellulose mixed ester A alone was 0.86, the haze thereof was 0.1, the transparency thereof was 93.9%, and Tg (glass transition temperature, measured through DSC) thereof was 125° C. The cellulose mixed ester A was produced, starting from cellulose collected from cotton liter.

The cellulose mixed ester A was dried at 105° C. for 5 hours to have a water content of 0.07% by mass, and then a UV absorbent and fine particles were added thereto according to Table 1. In addition, hexaacetyl sorbitol was added to the cellulose mixed ester in an amount of 5% by weight of the ester. These were mixed, put into the hopper of a twin-screw kneading extruder, and kneaded and melted therein at 150 to 200° C. at a screw revolution of 300 rpm for a residence time of 40 seconds. Then, this was extruded out in a water bath at 50° C., through a die at 200 kg/hr as strands having a diameter of 3 mm, then dipped for 1 minute (strand solidification), led to pass through water at 10° C. for 30 seconds to cool them, and thereafter pelletized into pellets having a length of 5 mm. Thus obtained, the pellets of cellulose mixed ester A were dried at 105° C. for 120 minutes, and then packed in a moisture-proof bag of an aluminium-having laminate film, and stored.

### (2) Filtration:

The above cellulose mixed ester was pelletized into columnar pellets having a diameter of 3 mm and a length of 5 mm, and dried in a vacuum drier at 110° C. for 3 hours. These were put into a hopper, melted at 215° C., and then filtered through a sintered metal filer having a pore size of 5 μm, under a pressure of 10 MPa and at a speed of 0.1 m/min. The resulting filtrate was confirmed to have a transparent and homogeneous composition.

### (3) Melt Casting Film Formation:

Next, this was put into a hopper kept at 107° C. The upstream side melting temperature was 195° C., the intermediate melting temperature was 210° C., the downstream side melting temperature was 225° C., the compression ratio was 14, the T-die temperature was Tg−7° C., the distance between the T-die and the casting drum was 8 cm, the solidification speed was 30° C./sec, the casting drum temperature profile was as follows: The first roll (upstream) was at (Tg−10)° C., the second roll (upstream) was at (Tg−11)° C., and the third roll (upstream) was at (Tg−12)° C., and the cooling speed was −15° C./sec. The melt was melt-extruded, taking 10 minutes. In this step, employed was an individual-level electrostatic application method (a 10 kV wire was disposed at 10 cm spaced from the melt-landing point on the casting drum). The solidified melt was peeled off, and via nip rolls, this was wound up under a winding tension of 6 kg/cm². Just before wound up, both edges (about 3% of the overall width) of the film were trimmed away, then the film was knurled at both edges to a width of 10 mm and a height of 50 μm, and then wound up. On every level, the film was wound up to a length of 500 m having a width of 1.5 m, at a speed of 30 m/min. The thickness of the film is as in Table 1.

### (4) Evaluation:

(Die streaks)

The film was visually checked for die streaks under a reflected light source, and was evaluated as follows:

A: No die streaks found.
B: A few but slight die streaks found.
C: Some obvious die streaks found.
D: Many die streaks found in the entire surface.

### (Particles Dropping)

The obtained sample film of 20 cm×30 cm was conditioned at 25° C. and a relative humidity of 60% for 3 hours, and then its side having faced the casting drum in its melt casting film formation was stuck to a glass plate with a double-adhesive tape, and its surface was rubbed with a sheet of black paper of 10 cm×10 cm with a load of 1 kg applied thereto, as a reciprocating motion for 10 times. Next, the surface of the black paper was visually checked for powdery impurities, and the sample was evaluated as follows:

A: No powdery impurities found
B: A few but slight powdery impurities found.
C: Some obvious powdery impurities found.
D: Many powdery impurities found in the entire surface.

### (Adhesiveness)

The obtained sample film of 5 cm×5 cm was conditioned at 25° C. and a relative humidity of 80%, then its side having faced the casting drum in melt casting film formation was put on the air side thereof, and this was sealed up in a moisture-proof bag. Then, a load of 10 kg was applied to the entire film. Further, this was aged at 60° C. for 3 days, then restored at 25° C. and a relative humidity of 60%, and after 2 hours, this was visually checked for the adhering trace of the film pieces, and was evaluated as follows:

A: No adhering trace found.
B: A little but slight adhering trace found.
C: Some obvious adhering trace found.
D: Much adhering trace found in the entire surface.

### (Surface Condition)

The obtained sample film of 20 cm×30 cm was heated at 150° C. for 24 hours, then restored at 25° C. and a relative humidity of 60%, and after 25 hours, the film surface was visually checked and evaluated as follows:

A: No change found in the surface condition.
B: A slight oily bleeding unevenness found in the surface.
C: Some obvious oily bleeding unevenness found in the surface.
D: Much oily bleeding unevenness found in the entire surface.

### (Light Resistance)

A cellulose mixed ester sample was first saponified as follows: Concretely, KOH was dissolved to have a concentration of 1.5 mol/L, then conditioned at 60° C., and this was used as a saponification solution. The sample was saponified with the solution for 1 minute. Next, the sample was washed with water for 2 minutes, then neutralized with aqueous sulfuric acid (0.1 mol/L) for 20 seconds, and further washed with water for 2 minutes. Next, this was exposed to dry air at 110° C. at a wind velocity of 15 m/sec for 5 minutes for drying. Next, the saponified film was stuck to both surfaces of a polarizer to construct a polarizing plate. These were stuck in such a manner that the stretching direction of the polarizer could be the same as the machine direction of the cellulose mixed ester film. The polarizer was produced according to Example 1 in JP-A-2001-141926, as follows: The film was stretched in the machine direction between two pairs of nip rolls running at a different peripheral speed, to obtain a polarizer having a thickness of 20 μm. In that manner, two pairs of the polarizing plates were prepared, and they were so disposed that the polarizing plates could be perpendicular to each other, and then exposed to a xenon lamp at 40° C. (50,000 luxes, 20 days). Then, this was restored to 25° C. and a relative humidity of 60%, and after 2 hours, the reduction (%) in the degree of polarization of the perpendicularly-crossing polarizing plates was measured. Based on the degree of polarization before irradiation with xenon, the light resistance of the sample film was evaluated.

The physical properties of the thus-obtained, unstretched cellulose mixed ester film were measured according to the methods mentioned in the above, and shown in Table 1. The control sample 1-1 containing neither UV absorbent nor fine particles had a large friction value and was readily scratched; and in addition, its adhesiveness and light resistance were extremely bad. As opposed to it, the samples 1-4 to 1-9 of the invention, containing UV absorbent and fine particles, had a low friction value and was scratched little, and it was excellent in all points of die streaks, haze, transmittance, particles dropping, adhesiveness, surface condition and light resistance. In particular, the surface condition that may be worsened owing to addition of UV absorbent was greatly improved by the combined use of fine particles; and this is an effect that could not be anticipated from prior-art knowledge. As opposed to it, the comparative sample 1-2 not containing fine particles had a large friction value and was scratched, and this was not good in point of haze, transmittance, adhesiveness and surface condition. The comparative sample 1-3 not containing UV absorbent was problematic in that its particles dropping resistance and light resistance were poor.

The comparative samples 1-10 to 1-13, which contained fine particles and UV absorbent but in which their content was outside the scope of the invention, could not satisfy all the requirements of friction value, scratching resistance, haze, transmittance, particles dropping resistance, adhesiveness, surface condition and light resistance. Further, the comparative samples 1-14 and 1-15, for which the downstream melting temperature was outside the scope of the invention, could not satisfy all the requirements of friction value, haze, transmittance, scratching resistance, particles dropping resistance, adhesiveness and light resistance. In particular, the comparative sample 1-15, which has been produced in a mode of melt casting film formation at a melting temperature of 245° C. as in Examples in JP-A-2000-352620, had a large friction value and a large haze value, though it contained fine particles; and its transmittance reduction was noticeable and its adhesiveness and surface condition were not good. In the comparative sample 1-16, in which the fine particles had a large mean primary particle size and fell outside the scope of the invention, the secondary particle size of the fine particles was also large, and the film was problematic in that its haze increased, its transmittance decreased, its scratch resistance was poor and its particles dropping resistance was poor.

As in the above, in accordance with the invention where a UV absorbent and fine particles were suitably added to a filming polymer and the polymer was formed into a film through melt casting film formation, excellent optical films were produced. The samples 1-4 to 1-9 of the invention had a remaining acetic acid content of less than 0.01% by mass, a Ca content of less than 0.05% by mass, and an Mg content of 0.01% by mass. The MD/TD mean thermal shrinkage (80° C./relative humidity 90%/48 hours) of the films was −0.04%, and the films thus obtained hardly undergo thermal shrinkage.

The sample 1-4, one typical film sample of the invention, was as follows: The tilt width was 19.3 nm, the threshold wavelength was 389.2 nm, the absorption edge was 376.6 nm, the absorption at 380 nm was 1.5%, the axial shifting (molecular alignment axis) was 0.2°, the elasticity was 2.93 GPa in the machine direction and 2.98 GPa in the transverse direction, the tensile strength was 116 MPa in the machine direction and 109 MPa in the transverse direction, the elongation was 64% in the machine direction and 62% in the transverse direction, the alkali hydrolyzability was A, the curl value was −0.2 at a relative humidity of 25% and 1.1 in wet. Its water content was 1.8% by mass, its thermal shrinkage was −0.07% in the machine direction and −0.10% in the transverse direction. The number of the impurities (lint) was less than 5/m. Regarding the number of the brightening points, those of 0.02 mm or less was in an amount of less than 10 points/3 m; those of from 0.02 to 0.05 mm was in an amount of less than 4 points/3 m; and those of 0.05 mm or more were not found. These properties are excellent for its use in optical applications. After coated, the sample was not sticky (O), and its moisture permeability was good (O). The characteristic values of the other samples of the invention were almost on the same level as that of the sample 1-4.

TABLE 1

| | | | | Fine Particles | | | Downstream | Thickness (μm) | | | |
|---|---|---|---|---|---|---|---|---|---|---|---|
| | | UV Absorbent | | | Primary | | Side Melting | Un- | | Friction Value | |
| Sample | | | Content | | Particle | Content | Temperature | stretched | Stretched | Static | Dynamic |
| No. | Group | Type | (mas. %) | Type | Size (nm) | (mas. %) | (° C.) | Film | Film | Friction | Friction |
| 1-1 | control | no | — | no | — | 0 | 225 | 80 | — | 5.6 | 4.2 |
| 1-2 | comparison | UV-1 | 1.2 | no | — | 0 | 225 | 80 | — | 4.9 | 4 |
| 1-3 | comparison | no | — | SiO₂ | 20 | 0.05 | 225 | 80 | — | 0.67 | 0.62 |
| 1-4 | the invention | UV-1 | 1.2 | SiO₂ | 20 | 0.05 | 225 | 80 | — | 0.49 | 0.46 |
| 1-5 | the invention | UV-2 | 1.2 | SiO₂ | 20 | 0.05 | 225 | 80 | — | 0.48 | 0.41 |
| 1-6 | the invention | UV-3 | 1.2 | SiO₂ | 20 | 0.05 | 225 | 80 | — | 0.43 | 0.39 |
| 1-7 | the invention | UV-4/ | 0.6/0.6 | SiO₂ | 20 | 0.05 | 225 | 134 | 80 | 0.45 | 0.42 |
| | | UV-5 | | | | | | | | | |
| 1-8 | the invention | UV-6 | 1.2 | TiO₂ | 20 | 0.05 | 225 | 80 | — | 0.46 | 0.42 |
| 1-9 | the invention | UV-7/ | 0.4/ | SnO₂ | 150 | 0.05 | 225 | 80 | — | 0.56 | 0.52 |
| | | UV-8/ | 0.4/ | | | | | | | | |
| | | UV-9 | 0.4 | | | | | | | | |
| 1-10 | comparison | UV-1 | 1.2 | SiO₂ | 20 | 0.003 | 225 | 80 | — | 4 | 3.4 |
| 1-11 | comparison | UV-1 | 1.2 | SiO₂ | 20 | 1.5 | 225 | 80 | — | 0.25 | 0.22 |
| 1-12 | comparison | UV-1 | 0.15 | SiO₂ | 20 | 0.05 | 225 | 80 | — | 0.68 | 0.64 |
| 1-13 | comparison | UV-1 | 4.5 | SiO₂ | 20 | 0.05 | 225 | 80 | — | 0.76 | 0.64 |
| 1-14 | comparison | UV-1 | 1.2 | SiO₂ | 20 | 0.05 | 175 | 80 | — | 0.59 | 0.48 |
| 1-15 | comparison | UV-1 | 1.2 | SiO₂ | 20 | 0.05 | 245 | 80 | — | 4.2 | 3.6 |
| 1-16 | comparison | UV-1 | 1.2 | SiO₂ | 3500 | 0.05 | 220 | 80 | — | 3.9 | 3.6 |
| 2-1 | the invention | UV-1 | 1.2 | SiO₂ | 20 | 0.05 | 225 | 80 | — | 0.48 | 0.42 |
| 2-2 | the invention | UV-1 | 1.2 | SiO₂ | 20 | 0.05 | 225 | 80 | — | 0.43 | 0.44 |
| 9-1 | comparison | UV-1 | 1.2 | SiO₂ | 20 | 0.05 | 220 | 80 | — | 1.28 | 2.01 |

| | | Film Evaluation | | | | | | | | | |
|---|---|---|---|---|---|---|---|---|---|---|---|
| | | Secondary | | | | | | | | | |
| | | Particle Size | | | | | | | | | |
| | | of Fine | | | | Re | Rth | Thickness | | | |
| Sample | | Particles | Ra | Re | Rth | Fluctuation | Fluctuation | Fluctuation | Die | Haze | Transmittance |
| No. | Group | (μm) | (nm) | (nm) | (nm) | (nm) | (nm) | (μm) | Streaks | (%) | (%) |
| 1-1 | control | — | 5 | 0.6 | 28 | 0.5 | 2.9 | 2.1 | B | 0.1 | 93.9 |
| 1-2 | comparison | — | 0.5 | 0.8 | 31 | 0.5 | 2.7 | 2.2 | A | 0.2 | 93.7 |
| 1-3 | comparison | 0.12 | 26 | 0.5 | 27 | 0.6 | 2.1 | 2.3 | A | 0.2 | 93 |
| 1-4 | the invention | 0.13 | 23 | 0.5 | 28 | 0.4 | 2.1 | 2.4 | A | 0.2 | 93.2 |
| 1-5 | the invention | 0.12 | 24 | 0.4 | 32 | 0.4 | 2.8 | 1.9 | A | 0.3 | 92.9 |
| 1-6 | the invention | 0.19 | 28 | 0.4 | 31 | 0.6 | 2.4 | 2.1 | A | 0.4 | 92.8 |
| 1-7 | the invention | 0.1 | 25 | 4.3 | 38 | 0.9 | 2.4 | 2.2 | A | 0.3 | 93 |
| 1-8 | the invention | 0.12 | 27 | 0.7 | 27 | 0.5 | 2 | 2.1 | A | 0.4 | 92.7 |
| 1-9 | the invention | 0.36 | 35 | 0.9 | 31 | 0.5 | 2.3 | 2.1 | A | 0.4 | 92.3 |
| 1-10 | comparison | 0.15 | 65 | 0.8 | 32 | 0.7 | 2.1 | 2 | A | 0.2 | 93.2 |
| 1-11 | comparison | 0.19 | 152 | 0.7 | 33 | 0.5 | 2.4 | 3.7 | B | 2.3 | 89.1 |
| 1-12 | comparison | 0.21 | 32 | 0.2 | 27 | 2.5 | 2 | 2.1 | A | 2 | 92.6 |
| 1-13 | comparison | 0.38 | 92 | 5.9 | 45 | 3.8 | 6.9 | 3.5 | B | 1.5 | 90.2 |
| 1-14 | comparison | 0.12 | 520 | 0.8 | 32 | 2.8 | 10.5 | 8.2 | D | 5.2 | 87 |
| 1-15 | comparison | 0.13 | 65 | 0.6 | 25 | 0.8 | 3.8 | 2.8 | C | 3.5 | 91.3 |
| 1-16 | comparison | 9.4 | 41 | 0.9 | 34 | 0.7 | 3.1 | 3.8 | B | 1.3 | 84.2 |
| 2-1 | the invention | 0.13 | 54 | 0.9 | 33 | 0.5 | 2.1 | 2 | A | 0.3 | 92.9 |
| 2-2 | the invention | 0.12 | 34 | 1.5 | 38 | 0.6 | 2 | 2.1 | A | 0.3 | 92.8 |
| 9-1 | comparison | 11.8 | 25 | 0.7 | 31 | 0.9 | 2.2 | 2.4 | B | 3.8 | 88.2 |

| Sample | | Film Evaluation | Particles | | Surface | Light | |
|---|---|---|---|---|---|---|---|
| No. | Group | Scratch | Dropping | Adhesiveness | Condition | Resistance | Remarks |
| 1-1 | control | D | A | D | A | 0.09 | |
| 1-2 | comparison | D | A | D | C | 0.03 | |
| 1-3 | comparison | A | C | B | A | 0.08 | |
| 1-4 | the invention | A | A | A | A | 0.02 | |
| 1-5 | the invention | A | A | A | A | 0.02 | |
| 1-6 | the invention | A | A | A | A | 0.02 | |
| 1-7 | the invention | A | B | A | A | 0.02 | MD 1.2 times |
| | | | | | | | TD 1.4 times |
| 1-8 | the invention | A | A | A | A | 0.02 | |
| 1-9 | the invention | A | B | A | A | 0.02 | |
| 1-10 | comparison | C | A | C | B | 0.03 | |
| 1-11 | comparison | C | C | A | C | 0.02 | |
| 1-12 | comparison | B | B | C | A | 0.05 | |
| 1-13 | comparison | B | C | C | C | 0.01 | |
| 1-14 | comparison | C | C | A | D | 0.03 | |
| 1-15 | comparison | C | A | C | C | 0.03 | yellowed |
| 1-16 | comparison | C | D | A | B | 0.02 | |
| 2-1 | the invention | A | A | A | A | 0.02 | |
| 2-2 | the invention | A | A | A | A | 0.02 | |
| 9-1 | comparison | D | D | C | B | 0.03 | |

The contents of fine particles is relative to the solid content of cellulose mixed ester.
UV-1: 2-(2′-hydroxy-3′,5′-di-t-amyl)-benzotriazole (TINUVIN 238)
UV-2: 2-[2′-hydroxy-3′,5′-bis(a-dimethylbenzyl)phenyl]-benzotriazole (TINUVIN 234)
UV-3: 2-hydroxy-4-n-dodecyloxy-benzophenone (Seesorb 103)
UV-4: 4-t-butyl-phenyl salicylate (Seesorb 201)
UV-5: 2-ethylhexyl-2-cyano-3,3(-diphenyl acrylate (UVNUL N-539)
UV-6: 2-ethoxy-2′-ethyl-oxalyl bisanilide (TINUVIN 315)
UV-7: 2,4-bis(n-octylthio)-6-(4-hydroxy-3,5-di-tert-butylanilino)-1,3,5-triazine
UV-8: 2(2′-hydroxy-3′,5′-di-tert-butylphenyl)-5-chlorobenzotriazole
UV-9: 2(2′-hydroxy-3′,5′-di-tert-amylphenyl)-5-chlorobenzotriazole

### Example 1′

### (1-1) Formation of Unstretched Cellulose Mixed Ester Film

### (1) Preparation of Cellulose Mixed Ester Pellets:

According to the same method as in Example 1, a cellulose mixed ester A was obtained. The obtained cellulose mixed ester A was dried at 105° C. for 5 hours to have a water content of 0.07% by mass, and then fine particles were added thereto according to Table 2. In addition, triphenyl phosphate was added to the cellulose mixed ester in an amount of 5% by weight of the ester; and further, 0.5 parts by mass of a UV agent a {2,4-bis-(n-octylthio)-6-(4-hydroxy-3,5-di-tert-butylanilino)-1,3,5-triazine}, 0.2 parts by mass of a UV agent b {2(2′-hydroxy-3′,5′-di-tert-butylphenyl)-5-chlorobenzotriazole) and a UV agent c {2(2′-hydroxy-3′,5′-di-tert-amylphenyl)-5-chlorobenzotriazole} were added thereto. These were mixed, put into the hopper of a twin-screw kneading extruder, and kneaded and melted therein at 200° C. at a screw revolution of 200 rpm for a residence time of 20 seconds. Then, this was extruded out in a water bath as strands having a diameter of 3 mm, then dipped for 1 minute (strand solidification), led to pass through water at 10° C. for 30 seconds to cool them, and thereafter pelletized into pellets having a length of 5 mm. Thus obtained, the pellets of cellulose mixed ester A were dried at 105° C. for 120 minutes, and then packed in a moisture-proof bag of an aluminium-having laminate film, and stored.

### (2) Filtration:

The above cellulose mixed ester was pelletized into columnar pellets having a diameter of 3 mm and a length of 5 mm, and dried in a vacuum drier at 110° C. for 3 hours. These were put into a hopper, melted at 205° C., and then filtered through a sintered metal filer having a pore size of 5 μm, under a pressure of 10 MPa and at a speed of 0.1 m/min. The resulting filtrate was confirmed to have a transparent and homogeneous composition.

### (3) Melt Casting Film Formation:

This was put into a hopper kept at 109° C. The upstream side melting temperature was 190° C., the intermediate melting temperature was 205° C., the downstream side melting temperature was 220° C., the compression ratio was 14, the T-die temperature was Tg−7° C., the distance between the T-die and the casting drum was 8 cm, the solidification speed was 30° C./sec, the casting drum temperature profile was as follows: The first roll (upstream) was at (Tg−10)° C., the second roll (upstream) was at (Tg−11)° C., and the third roll (upstream) was at (Tg−12)° C., and the cooling speed was −15° C./sec. This was melt-extruded, taking 10 minutes. In this step, employed was an individual-level electrostatic application method (a 10 kV wire was disposed at 10 cm spaced from the melt-landing point on the casting drum). The solidified melt was peeled off, and via nip rolls, this was wound up under a winding tension of 6 kg/cm². Just before wound up, both edges (about 3% of the overall width) of the film were trimmed away, then the film was knurled at both edges to a width of 10 mm and a height of 50 μm, and then wound up. On every level, the film was wound up to a length of 500 m having a width of 1.5 m, at a speed of 30 m/min. The thickness of the film is as in Table 2.

The physical properties of the thus-obtained, unstretched cellulose mixed ester film were measured according to the methods mentioned in the above, and shown in Table 2. The control sample 1-1′ not containing fine particles had a large friction value and was readily scratched; and in addition, its handlability during winding was poor and the wound-up film roll had wrinkles.

As opposed to this, in the cellulose mixed ester films 1-2′ to 1-7′ of the invention, in which the fine particles were controlled to have a predetermined size, the mean secondary particle size of the fine particles was small, and the friction value of the films were small; and in addition, the films were excellent in all other points that their Ra was small, they had few die streaks and had good optical characteristics (haze, transmittance, Re, Rth, Re fluctuation, Rth fluctuation), and had little thickness fluctuation and good scratching resistance. The cellulose mixed ester films of the invention had no problem in their handlability in the transport step during the melt casting film formation process, and the wound up films and also the appearance of the wound up films were both on a high level. When the rolls of the wound up films were unrolled, no scratch was found on the film surfaces, and this confirmed that the films were excellent. After stretched, it was confirmed that the sample 1-5′ of the invention was excellent in all points.

On the other hand, the comparative sample 1-8′, in which the content of fine particles was small and was outside the scope of the invention, was not good, as it had a large friction value and was readily scratched. Further, the comparative sample 1-9′, in which the content of fine particles was too much and was outside the scope of the invention, was not good in point of haze and transmittance, and was on a problematic level. The comparative sample 1-12′, in which the fine particles had a large mean primary particle size, showed a large friction value when the content of the fine particles therein was small. On the other hand, in the comparative sample 1-13′, the mean secondary particle size of the fine particles was large, and therefore the friction value of the film increased and the scratch resistance thereof could not be improved. The comparative sample 1-10′, which was outside the scope of the production method of the invention in point of the downstream side melting temperature, was problematic as they had many die streaks. The comparative sample 1-11′, for which the downstream side melting temperature was high (as described in Examples in JP-A-2000-352620), had a large friction value; and its Ra was small and its scratch resistance was poor. Further, the film was problematic as yellowed.

As in the above, according to the production method of the invention in which fine particles were suitably added to a cellulose mixed ester, excellent optical films were produced. The samples 1-2′ to 1-7′ of the invention had a remaining acetic acid content of less than 0.01% by mass, a Ca content of less than 0.05% by mass, and an Mg content of 0.01% by mass. The MD/TD mean thermal shrinkage (80° C./relative humidity 90%/48 hours) of the films was −0.04%, and the films thus obtained hardly undergo thermal shrinkage.

The sample 1-3′, one typical film sample of the invention, was as follows: The tilt width was 19.1 nm, the threshold wavelength was 389.0 nm, the absorption edge was 376.4 nm, the absorption at 380 nm was 1.6%, the axial shifting (molecular alignment axis) was 0.20, the elasticity was 2.89 GPa in the machine direction and 2.86 GPa in the transverse direction, the tensile strength was 110 MPa in the machine direction and 105 MPa in the transverse direction, the elongation was 59% in the machine direction and 58% in the transverse direction, the alkali hydrolyzability was A, the curl value was −0.1 at a relative humidity of 25% and 1.0 in wet. Its water content was 1.7% by mass, its thermal shrinkage was −0.09% in the machine direction and −0.11% in the transverse direction. The number of the impurities (lint) was less than 5/m. Regarding the number of the brightening points, those of 0.02 mm or less was in an amount of less than 10 points/3 m; those of from 0.02 to 0.05 mm was in an amount of less than 4 points/3 m; and those of 0.05 mm or more were not found. These properties are excellent for its use in optical applications. After coated, the sample was not sticky (O), and its moisture permeability was good (O). The characteristic values of the other samples of the invention were almost on the same level as that of the sample 1-3′.

TABLE 2

| | | Fine Particles | | | | | | | | Film Evaluation | | | |
|---|---|---|---|---|---|---|---|---|---|---|---|---|---|
| | | | Primary | | Downstream | Thickness (μm) | | | | Secondary | | | |
| | | | Particle | Content | Side Melting | Un- | | Friction Value | | Particle Size of | | | |
| Sample | | | Size | (mas. | Temperature | stretched | Stretched | Static | Dynamic | Fine Particles | Ra | Die | Haze |
| No. | Group | Type | (nm) | %) | (° C.) | Film | Film | Friction | Friction | (μm) | (nm) | Streaks | (%) |
| 1-1′ | control | no | — | 0 | 220 | 80 | — | 5.6 | 4.2 | — | 0.5 | B | 0.1 |
| 1-2′ | the invention | SiO₂ | 15 | 0.03 | 220 | 80 | — | 0.55 | 0.46 | 0.12 | 25 | A | 0.2 |
| 1-3′ | the invention | SiO₂ | 20 | 0.05 | 220 | 80 | — | 0.49 | 0.44 | 0.15 | 18 | A | 0.3 |
| 1-4′ | the invention | SiO₂ | 120 | 0.05 | 220 | 80 | — | 0.68 | 0.53 | 0.31 | 13 | A | 0.3 |
| 1-5′ | the invention | SiO₂ | 20 | 0.08 | 220 | 134 | 80 | 0.85 | 0.79 | 0.09 | 28 | A | 0.3 |
| 1-6′ | the invention | TiO₂ | 20 | 0.05 | 220 | 80 | — | 0.62 | 0.59 | 0.08 | 23 | A | 0.4 |
| 1-7′ | the invention | SnO₂ | 18 | 0.09 | 220 | 80 | — | 0.72 | 0.64 | 0.58 | 28 | A | 0.4 |
| 1-8′ | comparison | SiO₂ | 20 | 0.003 | 220 | 80 | — | 3.5 | 3.2 | 0.12 | 2.5 | A | 0.2 |
| 1-9′ | comparison | SiO₂ | 20 | 1.5 | 220 | 80 | — | 0.27 | 0.21 | 0.21 | 560 | B | 3.8 |
| 1-10′ | comparison | SiO₂ | 20 | 0.05 | 175 | 80 | — | 0.38 | 0.36 | 0.22 | 890 | C | 2.4 |
| 1-11′ | comparison | SiO₂ | 20 | 0.05 | 245 | 80 | — | 3.2 | 2.9 | 0.18 | 720 | B | 0.3 |
| 1-12′ | comparison | SiO₂ | 3500 | 0.05 | 220 | 80 | — | 3 | 2.5 | 8.6 | 52 | B | 1 |
| 1-13′ | comparison | SiO₂ | 3500 | 1.2 | 220 | 80 | — | 0.42 | 0.36 | 12.4 | 1530 | C | 2.4 |
| 2-1′ | the invention | SiO₂ | 20 | 0.05 | 220 | 80 | — | 0.51 | 0.47 | 0.16 | 15 | A | 0.3 |
| 2-2′ | the invention | SiO₂ | 20 | 0.05 | 220 | 80 | — | 0.46 | 0.51 | 0.17 | 23 | A | 0.3 |
| 9-1′ | comparison | SiO₂ | 20 | 0.05 | 220 | 80 | — | 0.56 | 0.76 | 12.3 | 820 | B | 4.8 |

| | | Film Evaluation | | | | | | | |
|---|---|---|---|---|---|---|---|---|---|
| | | | | | Re | Rth | Thickness | | |
| Sample | | Transmittance | Re | Rth | Fluctuation | Fluctuation | Fluctuation | | |
| No. | Group | (%) | (nm) | (nm) | (nm) | (nm) | (μm) | Scratch | Remarks |
| 1-1′ | control | 93.9 | 0.6 | 28 | 0.5 | 2.9 | 2.1 | D | |
| 1-2′ | the invention | 93.1 | 0.4 | 26 | 0.5 | 2.2 | 2.5 | A | |
| 1-3′ | the invention | 92.8 | 0.5 | 30 | 0.4 | 2.8 | 1.9 | A | |
| 1-4′ | the invention | 92.7 | 0.4 | 31 | 0.5 | 2.5 | 2.5 | A | |
| 1-5′ | the invention | 92.6 | 5.3 | 29 | 1.2 | 3.2 | 2.5 | A | MD 1.2 times |
| | | | | | | | | | TD 1.4 times |
| 1-6′ | the invention | 92.8 | 0.8 | 27 | 0.4 | 2.5 | 2.4 | A | |
| 1-7′ | the invention | 92.5 | 0.6 | 28 | 0.4 | 2.8 | 2 | A | |
| 1-8′ | comparison | 93.5 | 0.6 | 30 | 0.4 | 2.8 | 2.6 | C | |
| 1-9′ | comparison | 87.1 | 0.6 | 31 | 0.4 | 2.7 | 2.8 | A | |
| 1-10′ | comparison | 89.1 | 0.8 | 29 | 2.5 | 5.9 | 6.1 | B | |
| 1-11′ | comparison | 90.2 | 0.5 | 20 | 0.7 | 2.2 | 1.9 | C | yellowed |
| 1-12′ | comparison | 92.1 | 0.6 | 29 | 0.6 | 2.9 | 2.6 | C | |
| 1-13′ | comparison | 89.4 | 0.7 | 27 | 0.7 | 3.2 | 3 | C | |
| 2-1′ | the invention | 92.9 | 2.1 | 34 | 0.8 | 2.7 | 2.1 | A | |
| 2-2′ | the invention | 92.7 | 3.4 | 39 | 0.7 | 2.8 | 2.4 | A | Dispersion Failure, |
| | | | | | | | | | surface roughened |
| 9-1′ | comparison | 88.2 | 0.6 | 16 | 1.8 | 3.5 | 2.6 | D | |

The contents of fine particles is relative to the solid content of cellulose mixed ester.

### Example 2

A sample 2-1 of the invention was produced in the same manner as that for the sample 1-4 in Example 1, for which, however, the cellulose mixed ester A in the sample 1-4 of the invention of Example 1 was changed to a cellulose mixed ester B (powder having an acetyl substitution degree of 1.40, a propionyl substitution degree of 1.50, a total substitution degree of 2.90, a viscosity-average degree of polymerization of 130, a water content of 0.1% by mass, a viscosity in 6 mas. % dichloromethane solution of 52 mPa·s, a mean particle size of 1.5 mm, and a standard deviation of 0.5 mm). Further, a sample 2-1 of the invention was produced in the same manner as that for the sample 1-4 in Example 1, for which, however, the cellulose mixed ester A was changed to a cellulose mixed ester C (powder having an acetyl substitution degree of 1.80, a propionyl substitution degree of 1.05, a total substitution degree of 2.85, a viscosity-average degree of polymerization of 250, a water content of 0.2% by mass, a viscosity in 6 mas. % dichloromethane solution of 125 mPa·s, a mean particle size of 1.4 mm, and a standard deviation of 0.5 mm). The results are shown in Table 1.

The sample 2-1 of the invention had a relatively small degree of polymerization, but the mean secondary particle size of the fine particles in the film was small, the friction value of the film was small, Ra thereof was small, the film had few die streaks, the film was scratched little, and the film was excellent in all other optical characteristics (Re fluctuation, Rth fluctuation), die streaks, haze, transmittance, particles dropping resistance, adhesiveness, surface condition and light resistance. From the above, it was confirmed that the latitude in the degree of polymerization of the cellulose mixed ester in the invention is broad.

### Example 2′

A sample 2-1′ of the invention was produced in the same manner as that for the sample 1-3′ in Example 1′, for which, however, the cellulose mixed ester A in the sample 1-3′ of the invention of Example 1′ was changed to a cellulose mixed ester B′ (powder having an acetyl substitution degree of 1.40, a propionyl substitution degree of 1.40, a total substitution degree of 1.80, a viscosity-average degree of polymerization of 130, a water content of 0.1% by mass, a viscosity in 6 mas. % dichloromethane solution of 60 mPa·s, a mean particle size of 1.5 mm, and a standard deviation of 0.5 mm). Further, a sample 2-2′ of the invention was produced in the same manner as that for the sample 1-3′ in Example 1′, for which, however, the cellulose mixed ester A was changed to a cellulose mixed ester C′ (powder having an acetyl substitution degree of 1.70, a propionyl substitution degree of 1.20, a total substitution degree of 2.90, a viscosity-average degree of polymerization of 270, a water content of 0.2% by mass, a viscosity in 6 mas. % dichloromethane solution of 135 mPa·s, a mean particle size of 1.4 mm, and a standard deviation of 0.5 mm). The results are shown in Table 2.

The sample 2-1′ of the invention had a relatively small degree of polymerization, but the mean secondary particle size of the fine particles in the film was small, the friction value of the film was small, Ra thereof was small, the film had few die streaks, and the film was excellent in all other optical characteristics (haze, transmittance, Re, Rth, Re fluctuation, Rth fluctuation), thickness fluctuation and scratch resistance.

In the sample 2-2′ of the invention, for which the cellulose mixed ester was the cellulose mixed ester C′, or that is, cellulose acetyl propionate having a relatively high degree of polymerization, the mean secondary particle size of the fine particles was small, and the friction value of the film was small, Ra thereof was small, the film had few die streaks, and the film was excellent in all other optical characteristics (haze, transmittance, Re, Rth, Re fluctuation, Rth fluctuation), thickness fluctuation and scratch resistance. From the above, it was confirmed that the latitude in the degree of polymerization of the cellulose mixed ester in the invention is broad.

### Example 3

In Example 1, the sample 1-4 of the invention was alkali-saponified under the following condition: The film was dipped in an aqueous NaOH solution (3 mol/L) heated at 60° C. for 2 minutes, then washed with water at 25° C. for 30 seconds, and then processed with aqueous sulfuric acid solution (0.5 mol/L, 25° C.) for 1 minute, and again washed with water at 25° C. The contact angle (to pure water) of the resulting alkali-saponified film was measured, and was 29°. The film had good wettability. Before alkali-saponified, the contact angle of the film was 62°, from which it is understood that the sample of the invention has excellent surface processability. an aqueous PVA/glutaraldehyde (5 mas. %/0.2 mas. %) solution was applied to the film in an amount of 10 ml/m², and a commercially-available polarizer (HLC2-5618, by Sanritz) was stuck to it, processed at 70° C. for 1 hour, and then left at 30° C. for 6 days. Thus obtained, the cellulose mixed ester film-stuck film was cut with a cutter knife. Concretely, the cellulose mixed ester film surface was cut at an angle of 45° to a depth of 200 μm, thereby having cross cuts of 11 lines vertically crossing in two directions. Nichiban's Cellotape, No. 405 (Cellotape, registered trade name) was stuck to the cut surface of the film, and Nitto Tape (PET tape) was firmly pressed against the entire surface thereof and left as such for 30 minutes. Then, its edge was forcedly peeled up at a right angle. As a result, the non-saponified cellulose mixed ester film peeled away in all cross cuts; but in the polarizer to which the saponified cellulose mixed ester film had been stuck, the cross-cut ester film did not peeled away at all. From the above, it is understood that the cellulose mixed ester film of the invention has excellent polarizer characteristics.

### Example 3′

The sample 1-3′ of the invention of Example 1′ was processed in the same manner as in Example 3, and the same result as in Example 3 was obtained.

### Example 4

Next described are Examples of demonstrating the application of cellulose mixed ester film to polarizing plates.

### (4-1) Production of Polarizing Plate:

### (1) Saponification of Cellulose Mixed Ester Film:

The cellulose mixed ester film sample 1-4 of the invention, and a cellulose triacetate (Re was 60 nm, Rth was 200 nm, thickness was 80 μm) separately produced according to a solution casting film formation method, to which N,N′,N″-tri-m-toluoyl-1,3,5-triazine-2,4,6-triamine had been added in an amount of 4% by mass of he cellulose ester and which had been stretched by 1.32 times in the transverse direction while the remaining solvent was evaporated away by drying, were saponified as follows: Concretely, KOH was dissolved to have a concentration of 1.5 mol/L, and then conditioned at 60° C., and this was used as a saponification solution. This was applied onto the cellulose mixed ester film at 60° C. in an amount of 10 g/m², by which the film was saponified. Next, hot water at 50° C. was sprayed onto it at a rate of 10 L/m² min for 1 minute and the film was thus washed. Next, dry air at 110° C. was applied to it at a wind velocity of 15 m/sec, and this was thus dried for 5 minutes. For the saponification, a roll of the film was moved at a rate of 45 m/sec. Thus saponified, the cellulose mixed ester film 1-4 of the invention is the film sample 4-1.

### (2) Formation of Polarizing Layer:

According to Example 1 in JP-A-2001-141926, the film was stretched in the machine direction through two pairs of nip rolls each having a different peripheral speed, thereby forming a polarizing layer having a thickness of 20 μm.

### (3) Lamination:

Thus obtained, the polarizing layer and the saponified, cellulose mixed ester film sample 4-1, and the stretched cellulose triacetate film were laminated in such a manner that the polarizing layer could be sandwiched between the two using an aqueous 3% PVA (Kuraray's PVA-117H) solution as an adhesive, in which the polarization axis and the machine direction of the cellulose mixed ester film sample 4-1 crossed at 90°. Of those, the cellulose mixed ester film 4-1 of the invention, and the stretched cellulose mixed ester film were fitted to a 20-inch liquid crystal display device described in FIGS. 2 to 9 in JP-A-2000-154261, at 25° C. and a relative humidity of 60%, and then, this was carried in an atmosphere at 25° C. and a relative humidity of 10%, and its color change was visually checked and evaluated in 10 ranks (the sample having a larger point has a larger color change). With that, the region having display unevenness is visually investigated, and the proportion (%) of the display unevenness occurrence was obtained. The point of the color change in the cellulose mixed ester film of the invention was 1, and the film was extremely excellent. In addition, according to Example 1 in JP-A-2002-86554, the polarizing plate comprising the cellulose mixed ester film of the invention was stretched at an angle of 45° of the stretching axis to the absorption axis, using a tenter, and this was tested in the same manner as above. Similarly, this gave a good result.

### (4-2) Formation of Optical Compensatory Film:

The saponified, cellulose mixed ester film 4-1 of the invention was used in place of the cellulose acetate film in Example 1 in JP-A-11-316378, and a liquid crystal layer was applied onto it. This was fitted to the bent alignment-mode liquid crystal cell described in Example 9 in JP-A-2002-62431, at 25° C. and a relative humidity of 60%, and this was carried in an atmosphere at 25° C. and a relative humidity of 10%, and its contrast change was visually checked and evaluated in 10 ranks (the sample having a larger point has a larger color change). As a result, the point of this sample has a point of 2. Applying the invention to the prior art produced a good result.

### (4-3) Formation of Low-Refractivity Film:

The cellulose mixed ester film of the invention was applied to Example 47 in the Hatsumei Kyokai Disclosure Bulletin (No. 2001-1745, published by the Hatsumei Kyokai on Mar. 15, 2001). Briefly, the stretched or unstretched cellulose mixed ester film sample 1-3 was used to produce a low-refractivity film. This has good optical properties.

### Example 4′

The cellulose mixed ester sample 1-3′ of the invention was processed in the same manner as in Example 4, and the same result as in Example 4 was obtained.

### Example 5

The cellulose mixed ester film 1-4 of the invention produced in Example 1 was used in place of the cellulose triacetate film sample 1301 in Example 13 in JP-A-2002-265636; and in the same manner as in Example 13 in JP-A-2002-265636, an optically anisotropic layer and a polarizing plate sample were produced, and a bent alignment-mode liquid crystal cell was produced. Thus obtained, the liquid crystal cell had excellent viewing angle characteristics.

### Example 5′

The cellulose mixed ester sample 3-1′ of the invention produced in Example 3′ was processed in the same manner as in Example 5, and the same result as in Example 5 was obtained.

### Example 6

The cellulose mixed ester film 1-8 of the invention produced in Example 1 was used in place of the cellulose triacetate film sample 1401 in Example 14 in JP-A-2002-265636. In the same manner as in Example 14 in JP-A-2002-265636, an optically anisotropic layer and a polarizing plate sample were produced, and a TN-mode liquid crystal cell was produced. Thus obtained, the liquid crystal cell had excellent viewing angle characteristics.

### Example 6′

The cellulose mixed ester sample 1-6′ of the invention produced in Example 1′ was processed in the same manner as in Example 6, and the same result as in Example 6 was obtained.

### Example 7

### (1) Mounting on VA Panel

The polarizing plate produced in Example 4 of the invention was blanked into rectangular plates, of which one is a 26″-wide size viewing side polarizing plate where the absorption axis of the polarizer runs along the major side thereof and the other is a backlight side polarizing plate where the absorption axis of the polarizer rung along the minor side thereof. The polarizing plates and the retardation plates were peeled off from both, back and front surfaces of a VA-mode liquid crystal TV (Sony's KDL-L26RX2), and the polarizing plate produced in Example 4 was, as combined, stuck to the two, back and front surfaces of the device to construct a liquid crystal display device. After the polarizing plates were stuck thereto, this was kept at 50° C. under 5 kg/cm² for 20 minutes, and they were adhered together. In this step, the polarizing plates were so disposed that the absorption axis of the polarizing plate on the viewing side could be parallel to the panel plane, the absorption axis of the polarizing plate on the backlight side could be perpendicular to the panel plane, and the adhesive surface is on the side of the liquid crystal cell.

The protect film was peeled off, and then using a tester (ELDIM's EZ-Contrast 160D), the brightness at the time of black level of display and at the time of white level of display, and from the data, the viewing angle (range within which the contrast ratio is at least 10) of the device was computed. In every case of using different polarizing plates, the polar angle of the devices was at least 80° in all directions, and the device therefore had good viewing angle characteristics. Further, the devices were tested for light leakage and polarizing plate peeling in an endurance test, which confirmed that the devices have no problem. The endurance test condition is mentioned below.

1) The liquid crystal display device is kept in an environment at 60° C. and a relative humidity of 90% for 200 hours, then taken out into an environment at 25° C. and a relative humidity of 60%, and after 24 hours, the device is driven for black display and checked for the intensity of light leakage and the presence or absence of peeling of the polarizing plate from the liquid crystal panel.

2) The liquid crystal display device is kept in a dry environment at 80° C. for 200 hours, then taken out in an environment at 25° C. and a relative humidity of 60%, and after 1 hour, the device is driven for black display and checked for the intensity of light leakage and the presence or absence of peeling of the polarizing plate from the liquid crystal panel.

### Example 7′

The polarizing plate produced in Example 4′ was processed in the same manner as in Example 7, and the same result as in Example 7 was obtained.

### Example 8

A sample of the invention was formed into an optically anisotropic film having desired optical characteristics. The retardation film was peeled off from the following commercial monitor or television of different liquid crystal modes, and the retardation film of the invention was stuck to them, and they were checked for the viewing angle characteristics thereof. As a result, the devices had excellent and broad viewing angle characteristics and presented good color, which confirmed the usefulness of the cellulose mixed ester of the invention.

### (TN Mode)

For both a viewing side polarizing plate and a backlight side polarizing plate, 17″-size rectangular polarizing plates were blanked out, in which the absorption axis is at 45° to the major side of the plate. The polarizing plates and the retardation plates were peeled off from both, back and front surfaces of a TN-mode liquid crystal monitor (Samsung's SyncMaster 172X), and the polarizing plate formed of the cellulose mixed ester film of the invention was, as combined, stuck to the two, back and front surfaces of the device to construct a liquid crystal display device. After the polarizing plates were stuck thereto, this was kept at 50° C. under 5 kg/cm² for 20 minutes, and they were adhered together. In this step, the polarizing plates were so disposed that the optically anisotropic layer of the polarizing plate could face the cell substrate and the rubbing direction of the liquid crystal cell could be antiparallel to the rubbing direction of the optically anisotropic layer facing to the cell.

### (IPS Panel)

The polarizing plate of the invention was blanked into rectangular plates, of which one is a 32″-wide size viewing side polarizing plate where the absorption axis of the polarizer runs along the major side thereof and the other is a backlight side polarizing plate where the absorption axis of the polarizer rung along the minor side thereof. The polarizing plates and the retardation plates were peeled off from both, back and front surfaces of an IPS-mode liquid crystal TV (Hitachi's W32-L5000), and the polarizing plate formed of the cellulose mixed ester film of the invention was, as combined, stuck to the two, back and front surfaces of the device to construct a liquid crystal display device. After the polarizing plates were stuck thereto, this was kept at 50° C. under 5 kg/cm² for 20 minutes, and they were adhered together. In this step, the polarizing plates were so disposed that the absorption axis of the polarizing plate on the viewing side could be parallel to the panel plane, the absorption axis of the polarizing plate on the backlight side could be perpendicular to the panel, and the adhesive layer surface is on the side of the liquid crystal cell.

### Comparative Example 1

A comparative sample 9-1 was produced in the same manner as that for the cellulose mixed ester film 1-4 of the invention, for which, however, fine particles were not previously added in preparation of (1) cellulose mixed ester pellets in (1-1) formation of cellulose mixed ester film for the sample 1-4 of the invention in Example 1, but fine particles were put into the hopper along with the cellulose mixed ester in (3) melt casting film formation step. The mean secondary particle size of the fine particles was extremely large, and the film was poor in point of the friction value, the scratching, the haze, the transmittance, the particles dropping, the adhesiveness and the surface condition. Accordingly in the invention, it is important that the mean secondary particle size of the fine particles is uniformly small.

### Comparative Example 1′

A comparative sample 9-1′ was produced in the same manner as that for the cellulose mixed ester film 1-3′ of the invention, for which, however, fine particles were not added in preparation of (1) cellulose mixed ester pellets in (1-1) formation of unstretched cellulose mixed ester film for the sample 1-3′ of the invention in Example 1′, but fine particles were put into the hopper along with the cellulose mixed ester in (3) melt casting film formation step. The results are shown in Table 2. The mean secondary particle size of the fine particles was extremely large, and the film was extremely poor in point of the haze and the transmittance, and the film was readily scratched.

### Example 9

A sample 10-1 of the invention was produced in the same manner as the sample 1-4 of the invention in Example 1, for which, however, a lubricant, PF-1 was added to the cellulose mixed ester A in an amount of 0.2% by mass of the ester in (1) preparation of cellulose mixed ester pellets in (1-1) formation of unstretched cellulose mixed ester film for the sample 1-4 of the invention in Example 1. The mean secondary particle size of the fine particles in the film was small, the friction value of the film was small, Ra thereof was small, and the film had few die streaks, and further the film was excellent in all point of optical characteristics (haze, transmittance, Re, Rth, Re fluctuation, Rth fluctuation), thickness fluctuation, scratching, particles dropping, adhesiveness, surface condition and light resistance. In particular, the load in peeling was about ½ that to the sample 1-4, to which PF-1 had not been added, and the transferability of the film was improved and the film had few die streaks. Accordingly, it was confirmed that adding a fluorine compound, especially a fluorine polymer as a lubricant to the film is effective.

### Example 9′

The sample 1-3′ of the invention in Example 1′ was processed in the same manner as in Example 9, and the same result as in Example 9 was obtained. The load in peeling was about ½ that to the sample 1-4′, to which PF-1 had not been added, and the transferability of the film was improved and the film had few die streaks.

### Example 10

### (10-1) Pelletization of Cellulose Mixed Ester

The synthetic cellulose mixed ester shown in Table 3 was dried with air at 120° C. for 3 hours to have a water content of 0.1% by mass. To this, added were the plasticizer shown in Table 3, and 0.05% by mass of SiO₂ particles (aerosil R972V), 0.20% by mass of a phosphite stabilizer (P-1), 0.8% by mass of a UV absorbent, 2,4-bis(n-octylthio)-6-(4-hydroxy-3,5-di-tert-butylanilino)-1,3,5-triazine and 0.25% by mass of another UV absorbent 2(2′-hydroxy-3′,5′-di-tert-butylphenyl)-5-chlorobenzotriazole, and the mixture was melt-kneaded in a twin-screw kneading extruder at 190° C. The twin-screw kneading extruder has a vacuum vent, through which the extruder was degassed in vacuum (set at 0.3 atmospheres). In a water bath, the mixture was extruded out as strands having a diameter of 3 mm, and these were cut into pellets having a length of 5 mm.

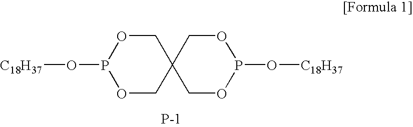

### (10-2) Melt Casting Film Formation

The cellulose mixed ester pellets prepared according to the above method were dried in a vacuum drier at 100° C. for 3 hours. These were put into a hopper conditioned at (Tg−10)° C., and using a single-screw extruder having a screw at a compression ratio of 3.0, the cellulose mixed ester was melt-extruded at a temperature profile mentioned below.

### Screw Temperature Profile

Upstream feed zone (195° C.)
Intermediate compression zone (210° C.)
Downstream metering zone (230° C.)

Next, the cellulose mixed ester melt was led to pass through a gear pump, thereby to remove the pulsation of the extruder. Then, this was filtered through a 3-μm filter, and led to pass through a die at 230° C., and then cast onto a casting drum. In this step, a 3-KV electrode was set, as spaced by 5 cm from the melt, and 5 cm width at both edges of the film was subjected to electrostatic application treatment. This was solidified on three casting drums having a diameter of 60 cm, set at (Tg−5)° C., Tg and (Tg−10)° C., thereby obtaining a cellulose mixed ester film having a thickness as in Table 3. Both edges of the film were trimmed off by 5 cm, and then the film was knurled at both edges to a width of 10 mm and a height of 50 μm, and then wound up. On every level, the film was wound up to a length of 2000 m having a width of 1.5 m, at a speed of 30 m/min. The friction value of the film was small and the film was not scratched, and the film was excellent in all points of die streaks, haze, transmittance, particles dropping, adhesiveness, surface condition and light resistance.

### (10-3) Production of Polarizing Plate

### (10-3-1) Saponification of Cellulose Mixed Ester Film:

The cellulose mixed ester film was saponified according to the following saponification method. Concretely, an aqueous NaOH solution (2.5 mol/L) was used as a saponification solution. This was conditioned a 60° C., and the cellulose mixed ester film was dipped therein for 2 minutes. Next, the film was dipped in an aqueous sulfuric acid solution (0.05 mol/L) for 30 seconds, and then washed with water.

### (10-3-2) Formation of Polarizing Layer

According to Example 1 in JP-A-2001-141926, the film was stretched in the machine direction through two pairs of nip rolls each having a different peripheral speed, thereby forming a polarizing layer having a thickness of 20 μm.

### (10-4) Lamination

Thus obtained, the polarizing layer and the saponified, cellulose mixed ester film, and a saponified cellulose triacetate film (FUJIFILM's FUJITAC) were laminated as the combination mentioned below, using an aqueous 3% PVA (Kuraray's PVA-117H) solution as an adhesive, in which the stretching direction of the polarizer is the machine direction (longitudinal direction) of the cellulose mixed ester film.

Polarizing plate A: Cellulose mixed ester film/polarizing layer/FUJITAC TD80UF.
Polarizing plate B: Cellulose mixed ester film/polarizing layer/cellulose mixed ester film.

### (10-5) Mounting Test Evaluation

Of the two pairs of polarizing plates installed to hold a liquid crystal layer as sandwiched therebetween in a 26-inch and 40-inch liquid crystal display devices (by Sharp) comprising a VA-mode liquid crystal cell, one polarizing plate on the viewer's side was peeled off. In place of it, the above polarizing plate A or B was stuck to the device, using an adhesive. The plates were so disposed that the transmission axis of the polarizing plate on the viewer's side could cross the transmission axis of the polarizing plate on the backlight side, perpendicularly to each other, thereby reconstructing a liquid crystal display device. Thus obtained, the liquid crystal display device was driven and checked for the light leakage to occur at the time of black level of display and for the color unevenness and the in-plane uniformity of the panel. The cellulose mixed ester film of the invention was free from a problem of color change and was extremely excellent.

### (10-6) Production of Low-Refractivity Film

The cellulose mixed ester film of the invention was formed into a low-refractivity film according to Example 47 in the Hatsumei Kyokai Disclosure Bulletin (No. 2001-1745, published by the Hatsumei Kyokai on Mar. 15, 2001, and it had good optical properties.

### (10⁻⁷) Production of Optical Compensatory Film

A liquid crystal layer was formed on the cellulose mixed ester film of the invention, according to Example 1 in JP-A-11-316378, and a good optical compensatory film was thereby obtained.

TABLE 3

| | Cellulose Acylate | | | | | | | | | | | |
|---|---|---|---|---|---|---|---|---|---|---|---|---|
| | X | Y | | X + Y | | | | | | | | Color |
| | acetyl | substitution | substituent | total | | | | Formed Film | | | Layer | Change* |
| | substi- | degree with any | except | substi- | Degree of | | | Thick- | | | Constitution | in |
| | tution | other than | acetyl | tution | Polymeri- | Plasticizer | | ness | Re | Rth | of Polarizing | Polarizing |
| | degree | acetyl group | group | degree | zation | Type | Amount* | (μm) | (nm) | (nm) | plate | plate |
| Example | 0.11 | 2.81 | propionyl | 2.92 | 190 | plasticizer 4 | 6.0 | 110 | 3 | 20 | polarizing | 1 |
| 11-1 | | | | | | | | | | | plate A | |
| Example | 0.20 | 2.60 | propionyl | 2.80 | 200 | plasticizer 4 | 8.0 | 80 | 0 | 8 | polarizing | 0 |
| 11-2 | | | | | | | | | | | plate A | |
| Example | 0.25 | 2.53 | propionyl | 2.78 | 210 | plasticizer 4 | 10.0 | 90 | 1 | 16 | polarizing | 0 |
| 11-3 | | | | | | | | | | | plate B | |
| Example | 0.40 | 2.30 | propionyl | 2.70 | 170 | plasticizer 3 | 6.0 | 110 | 5 | 30 | polarizing | 1 |
| 11-4 | | | | | | | | | | | plate B | |
| Example | 0.70 | 1.90 | propionyl | 2.60 | 185 | plasticizer 3 | 9.0 | 95 | 8 | 42 | polarizing | 2 |
| 11-5 | | | | | | | | | | | plate A | |
| Example | 1.10 | 1.40 | propionyl | 2.50 | 195 | plasticizer 3 | 12.0 | 125 | 8 | 58 | polarizing | 2 |
| 11-6 | | | | | | | | | | | plate A | |
| Example | 1.80 | 1.05 | propionyl | 2.85 | 160 | plasticizer 1 | 6.0 | 85 | 10 | 60 | polarizing | 6 |
| 11-7 | | | | | | | | | | | plate A | |
| Example | 0.05 | 2.90 | propionyl | 2.95 | 170 | no | 0.0 | 75 | 6 | 28 | polarizing | 2 |
| 11-8 | | | | | | | | | | | plate A | |
| Example | 0.20 | 2.00 | propionyl | 2.20 | 140 | plasticizer 2 | 15.0 | 75 | 3 | 41 | polarizing | 1 |
| 11-9 | | | | | | | | | | | plate B | |
| Example | 0.10 | 1.95 | propionyl | 2.05 | 150 | plasticizer 4 | 20.0 | 140 | 2 | 18 | polarizing | 3 |
| 11-10 | | | | | | | | | | | plate B | |
| Example | 0.20 | 2.60 | butyryl | 2.80 | 200 | plasticizer 4 | 8.0 | 80 | 9 | 59 | polarizing | 4 |
| 11-11 | | | | | | | | | | | plate A | |
| Example | 1.10 | 1.72 | butyryl | 2.82 | 180 | plasticizer 4 | 6.0 | 85 | 8 | 55 | polarizing | 5 |
| 11-12 | | | | | | | | | | | plate A | |

Plasticizer 1: biphenyldiphenyl phosphate.
Plasticizer 2: dioctyl adipate.
Plasticizer 3: glycerin diacetate monooleate.
Plasticizer 4: polyethylene glycol (molecular weight 600).
Amount of plasticizer*: % by mass relative to cellulose acylate.
Color change in polarizing plate*: The color change is expressed in 10 ranks. (The sample having a larger point had larger color change.)

### INDUSTRIAL APPLICABILITY

According to the production method of the invention, there is provided a cellulose mixed ester film of which the die streaks, the thickness fluctuation and the optical characteristic fluctuation are greatly reduced. In addition, during handling, scratching of the film surfaces to be caused by their rubbing may be greatly reduced, and the film is excellent in all points of haze, transmittance, particles dropping, adhesiveness, surface condition and light resistance. Further, when the cellulose mixed ester film of the invention is built in a liquid crystal display device, then the display fluctuation and the moisture-dependent visibility change, which are heretofore problematic, may be significantly suppressed. Accordingly, the cellulose mixed ester film of the invention has good industrial applicability.

1. A method for producing a cellulose mixed ester film having a thickness of from 20 μm to 200 μm through melt casting film formation of a cellulose mixed ester, wherein:
the cellulose mixed ester satisfies the formulae (S-1) to (S-3) below, and contains fine particles having a mean primary particle size of from 0.005 μm to 2 μm in an amount of from 0.005 to 1.0% by mass relative to the cellulose mixed ester, and contains a UV absorbent in an amount of from 0.2 to 3% by mass relative to the cellulose mixed ester,
and the method comprises melting the cellulose mixed ester at 180 to 230° C., extruding it through a die and forming a cellulose mixed ester film through melt casting film formation:
2.5≦A+B≦3.0, (S-1)
0≦A≦2.2, (S-2)
0.8≦B≦3.0, (S-3)
wherein A means a substitution degree of the hydroxyl group of cellulose with an acetyl group, and B means a substitution degree of the hydroxyl group of cellulose with an acyl group having from 3 to 22 carbon atoms.

2. The method for producing a cellulose mixed ester film according to claim 1, wherein the acyl groups having from 3 to 22 carbon atoms that substitutes for the hydroxyl group of cellulose in the cellulose mixed ester are at least two acyl groups selected from the group consisting of an acetyl group, a propionyl group and a butyryl group.

3. The method for producing a cellulose mixed ester film according to claim 1, wherein the UV absorbent is at least one UV absorbent selected from benzotriazole compounds, benzophenone compounds, oxalic acid anilide compounds, formamidine compounds and compounds having triazine ring.

4. The method for producing a cellulose mixed ester film according to claim 1, wherein the fine particles are selected from at least one of SiO₂, ZnO, TiO₂, SnO₂, Al₂O₃, ZrO₂, In₂O₃, MgO, BaO, MoO₂ and V₂O₅.

5. The method for producing a cellulose mixed ester film according to claim 1, which further comprises stretching the film formed through melt casting film formation by from −10% to 50% in at least one direction.

6. A cellulose mixed ester film formed through melt casting film formation of a cellulose mixed ester and having a thickness of from 20 μm to 200 μm, wherein:
the cellulose mixed ester satisfies the formulae (S-1) to (S-3) below, and contains fine particles having a mean primary particle size of from 0.005 μm to 2 μm in an amount of from 0.005 to 1.0% by mass relative to the cellulose mixed ester,
the cellulose mixed ester film is formed by melting the cellulose mixed ester at 180 to 230° C., extruding it through a die and forming the film through melt casting film formation, and its dynamic and static friction value is both from 0.2 to 1.5, and the mean secondary particle size of the fine particles in the film is from 0.01 μm to 5 μm,
and the cellulose mixed ester contains a UV absorbent in an amount of from 0.2 to 3% by mass relative to the cellulose mixed ester, or the arithmetical mean roughness (Ra) of the surface of the cellulose mixed ester film is from 3 nm to 200 nm:
2.5≦A+B≦3.0, (S-1)
0≦A≦2.2, (S-2)
0.8≦B≦3.0, (S-3)
wherein A means a substitution degree of the hydroxyl group of cellulose with an acetyl group, and B means a substitution degree of the hydroxyl group of cellulose with an acyl group having from 3 to 22 carbon atoms.

7. The cellulose mixed ester film according to claim 6, wherein the cellulose mixed ester contains a UV absorbent in an amount of from 0.2 to 3% by mass relative to the cellulose mixed ester.

8. The cellulose mixed ester film according to claim 6, wherein the surface of the cellulose mixed ester film has an arithmetic mean roughness (Ra) of from 3 nm to 200 nm.

9. The cellulose mixed ester film according to claim 6, which has an in-plane retardation (Re) of from 0 to 10 nm, and an absolute value of a thickness-direction retardation (Rth) of from 0 to 60 nm.

10. The cellulose mixed ester film according to claim 6, which has a haze of from 0.1 to 1.2% and a visible light transmittance of at least 91%, and has, at a wavelength of 590 nm in an environment at 25° C. and a relative humidity of 60%, an intrinsic birefringence in the in-plane direction of from 0 to 0.001 and an absolute value of an intrinsic birefringence in the thickness direction of from 0 to 0.003.

11. The cellulose mixed ester film according to claim 6, wherein the in-plane retardation (Re) and the thickness-direction retardation (Rth) of the film at a wavelength of 400 nm and 700 nm satisfy the following formulae (A-1) and (A-2):
0≦Re(700)−Re(400)≦15 nm, (A-1)
0≦Rth(700)−Rth(400)≦35 nm. (A-2)
wherein Re(400) and Re(700) mean the in-plane retardation (Re) at a wavelength of 400 nm and 700 nm, respectively; Rth(400) and Rth(700) mean the thickness-direction retardation (Rth) at a wavelength of 400 nm and 700 nm, respectively.

12. The cellulose mixed ester film according to claim 6, wherein the film surface has a contact angle with water at 25° C. and a relative humidity of 60% of at most 45°.

13-16. (canceled)
